(19) United States
(12) Patent Application Publication
(10) Pub. No.: US 2026/0063875 A1
(43) Pub. Date: Mar. 5, 2026

(54) PHOTOGRAPHY LENS ASSEMBLY, IMAGE CAPTURING UNIT AND ELECTRONIC DEVICE

(71) Applicant: LARGAN PRECISION CO., LTD., Taichung City (TW)

(72) Inventors: Kuan-Ting YEH, Taichung City (TW); Guan-Jr LIAO, Taichung City (TW)

(73) Assignee: LARGAN PRECISION CO., LTD., Taichung City (TW)

(21) Appl. No.: 19/384,721

(22) Filed: Nov. 10, 2025

(30) Foreign Application Priority Data
Aug. 25, 2025 (TW) 114132279

(51) Int. Cl. G02B 13/00; G02B 9/62; H04N 23/55

(52) U.S. Cl. CPC G02B 13/0045; G02B 9/62; H04N 23/55

(57) ABSTRACT

A photography lens assembly includes six lens elements which are, in order from an object side to an image side along an optical path: a first lens element, a second lens element, a third lens element, a fourth lens element, a fifth lens element, and a sixth lens element. Each of an object-side surface and an image-side surface of the first lens element includes a central area and a peripheral area. The peripheral area of the object-side surface of the first lens element has a first refractive surface. The peripheral area of the image-side surface of the first lens element has a first reflective surface. The central area of the object-side surface of the first lens element has a second reflective surface. The central area of the image-side surface of the first lens element has a second refractive surface. The sixth lens element has positive refractive power.

### RELATED APPLICATIONS

This application claims priority to Taiwan Application 114132279, filed on Aug. 25, 2025, which is incorporated by reference herein in its entirety.

### BACKGROUND

### Technical Field

The present disclosure relates to a photography lens assembly, an image capturing unit, and an electronic device, more particularly to a photography lens assembly and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization, and a desirable field of view.

### SUMMARY

According to one aspect of the present disclosure, a photography lens assembly includes six lens elements. The six lens elements are, in order from an object side to an image side along an optical path, a first lens element, a second lens element, a third lens element, a fourth lens element, a fifth lens element, and a sixth lens element. Each of the six lens elements has an object-side surface facing toward the object side and an image-side surface facing toward the image side.

Preferably, each of the object-side surface and the image-side surface of the first lens element includes a central area and a peripheral area. Preferably, the peripheral area of the object-side surface of the first lens element has a first refractive surface. Preferably, the peripheral area of the image-side surface of the first lens element has a first reflective surface. Preferably, the central area of the object-side surface of the first lens element has a second reflective surface. Preferably, the central area of the image-side surface of the first lens element has a second refractive surface.

Preferably, the sixth lens element has positive refractive power.

According to another aspect of the present disclosure, a photography lens assembly includes six lens elements. The six lens elements are, in order from an object side to an image side along an optical path, a first lens element, a second lens element, a third lens element, a fourth lens element, a fifth lens element, and a sixth lens element. Each of the six lens elements has an object-side surface facing toward the object side and an image-side surface facing toward the image side.

Preferably, each of the object-side surface and the image-side surface of the first lens element includes a central area and a peripheral area. Preferably, the peripheral area of the object-side surface of the first lens element has a first refractive surface. Preferably, the peripheral area of the image-side surface of the first lens element has a first reflective surface. Preferably, the central area of the object-side surface of the first lens element has a second reflective surface. Preferably, the central area of the image-side surface of the first lens element has a second refractive surface.

Preferably, the second lens element has negative refractive power. Preferably, the image-side surface of the second lens element is concave in a paraxial region thereof.

When a focal length of the fifth lens element is f5, a focal length of the sixth lens element is f6, a curvature radius of the image-side surface of the first lens element is R2, and a curvature radius of the image-side surface of the sixth lens element is R12, the following conditions are preferably satisfied:

$$0. < \vert f 5 / f 6 \vert < 7. ; and$$

$$0. < \vert R 2 / R 12 \vert < 1.6 .$$

According to another aspect of the present disclosure, a photography lens assembly includes six lens elements. The six lens elements are, in order from an object side to an image side along an optical path, a first lens element, a second lens element, a third lens element, a fourth lens element, a fifth lens element, and a sixth lens element. Each of the six lens elements has an object-side surface facing toward the object side and an image-side surface facing toward the image side.

Preferably, each of the object-side surface and the image-side surface of the first lens element includes a central area and a peripheral area. Preferably, the peripheral area of the object-side surface of the first lens element has a first refractive surface. Preferably, the peripheral area of the image-side surface of the first lens element has a first reflective surface. Preferably, the central area of the object-side surface of the first lens element has a second reflective surface. Preferably, the central area of the image-side surface of the first lens element has a second refractive surface.

When an Abbe number of the second lens element is V2, and an Abbe number of the fifth lens element is V5, the following condition is preferably satisfied:

$$10. < V 5 - V 2 < 35. .$$

According to another aspect of the present disclosure, an image capturing unit includes the aforementioned photography lens assembly and an image sensor, wherein the image sensor is disposed on an image surface of the photography lens assembly.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit according to the 1st embodiment of the present disclosure;

FIG. 2 shows spherical aberration curves, astigmatic field curves, and a distortion curve of the image capturing unit according to the 1st embodiment;

FIG. 3 is a schematic view of an image capturing unit according to the 2nd embodiment of the present disclosure;

FIG. 4 shows spherical aberration curves, astigmatic field curves, and a distortion curve of the image capturing unit according to the 2nd embodiment;

FIG. 5 is a schematic view of an image capturing unit according to the 3rd embodiment of the present disclosure;

FIG. 6 shows spherical aberration curves, astigmatic field curves, and a distortion curve of the image capturing unit according to the 3rd embodiment;

FIG. 7 is a schematic view of an image capturing unit according to the 4th embodiment of the present disclosure;

FIG. 8 shows spherical aberration curves, astigmatic field curves, and a distortion curve of the image capturing unit according to the 4th embodiment;

FIG. 9 is a schematic view of an image capturing unit according to the 5th embodiment of the present disclosure;

FIG. 10 shows spherical aberration curves, astigmatic field curves, and a distortion curve of the image capturing unit according to the 5th embodiment;

FIG. 11 is a schematic view of an image capturing unit according to the 6th embodiment of the present disclosure;

FIG. 12 shows spherical aberration curves, astigmatic field curves, and a distortion curve of the image capturing unit according to the 6th embodiment;

FIG. 13 is a schematic view of an image capturing unit according to the 7th embodiment of the present disclosure;

FIG. 14 shows spherical aberration curves, astigmatic field curves, and a distortion curve of the image capturing unit according to the 7th embodiment;

FIG. 15 is a schematic view of an image capturing unit according to the 8th embodiment of the present disclosure;

FIG. 16 shows spherical aberration curves, astigmatic field curves, and a distortion curve of the image capturing unit according to the 8th embodiment;

FIG. 17 is a schematic view of an image capturing unit according to the 9th embodiment of the present disclosure;

FIG. 18 shows spherical aberration curves, astigmatic field curves, and a distortion curve of the image capturing unit according to the 9th embodiment;

FIG. 19 is a schematic view of an image capturing unit according to the 10th embodiment of the present disclosure;

FIG. 20 shows spherical aberration curves, astigmatic field curves, and a distortion curve of the image capturing unit according to the 10th embodiment;

FIG. 21 is a perspective view of an image capturing unit according to the 11th embodiment of the present disclosure;

FIG. 22 is one perspective view of an electronic device according to the 12th embodiment of the present disclosure;

FIG. 23 is another perspective view of the electronic device in FIG. 22;

FIG. 24 is a block diagram of the electronic device in FIG. 22;

FIG. 25 is one schematic view of an electronic device according to the 13th embodiment of the present disclosure;

FIG. 26 is another schematic view of the electronic device in FIG. 25;

FIG. 27 is a perspective view of an electronic device according to the 14th embodiment of the present disclosure;

FIG. 28 is a perspective view of an electronic device according to the 15th embodiment of the present disclosure;

FIG. 29 shows a schematic view of inflection points and critical points on lens surfaces according to the 1st embodiment of the present disclosure;

FIG. 30 shows a schematic view of DM2R2, DM2R12, DM2I, and YF1o according to the 1st embodiment of the present disclosure;

FIG. 31 shows a schematic view of the light-blocking area, the central areas, the peripheral areas, the first refractive surface, the first reflective surface, the second reflective surface, and the second refractive surface of the first lens element, and YM1i, YM1o, YM2, YT1i, YT1o, and YT2 according to the 1st embodiment of the present disclosure;

FIG. 32 shows a schematic view of the light-blocking areas, the central areas, the peripheral areas, the first refractive surface, the first reflective surface, the second reflective surface, and the second refractive surface of the first lens element, and YM1i, YM1o, YM2, YT1i, YT1o, and YT2 according to the 2nd embodiment of the present disclosure; and

FIG. 33 shows a schematic view of CRA according to the present disclosure.

### DETAILED DESCRIPTION

A photography lens assembly includes six lens elements. The six lens elements are, in order from an object side to an image side along an optical path, a first lens element, a second lens element, a third lens element, a fourth lens element, a fifth lens element, and a sixth lens element. Each of the six lens elements of the photography lens assembly has an object-side surface facing toward the object side and an image-side surface facing toward the image side.

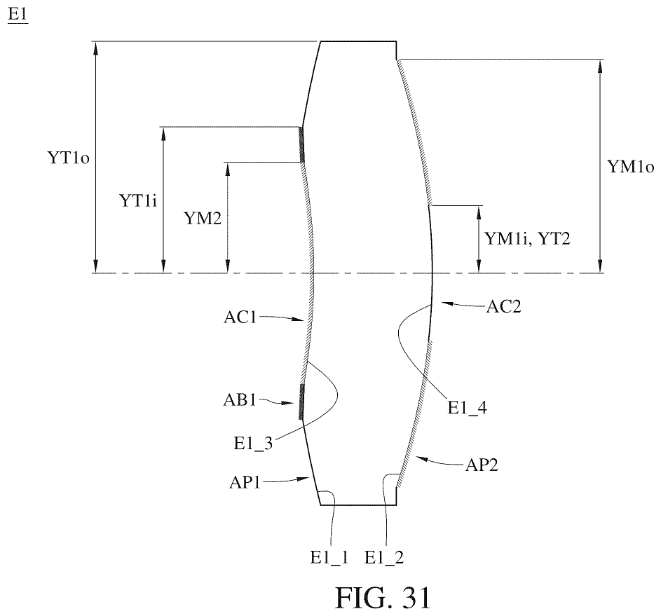

Each of the object-side surface and the image-side surface of the first lens element includes a central area and a peripheral area. Therefore, it is favorable for enhancing the spatial utilization of the photography lens assembly by employing a zonal design corresponding to different positions within the effective radius of the lens element. Please refer to FIG. 31, which shows a schematic view of the central area AC1 and the peripheral area AP1 of the object-side surface of the first lens element E1, and the central area AC2 and the peripheral area AP2 of the image-side surface of the first lens element E1 according to the 1st embodiment of the present disclosure.

The peripheral area of the object-side surface of the first lens element has a first refractive surface, the peripheral area of the image-side surface of the first lens element has a first reflective surface, the central area of the object-side surface of the first lens element has a second reflective surface, and the central area of the image-side surface of the first lens element has a second refractive surface. Therefore, it is favorable for omitting an additional reflecting element, thereby reducing the number of components and lowering costs, while configuring the reflective surface on the lens element so as to enhance the design flexibility of the reflective region and reduce assembly errors. Please refer to FIG. 31, which shows a schematic view of the first refractive surface E1_1, the first reflective surface E1_2, the second reflective surface E1_3, and the second refractive surface E1_4 according to the 1st embodiment of the present disclosure. In addition, the first reflective surface E1_2 faces towards the object side, and the second reflective surface E1_3 faces towards the image side.

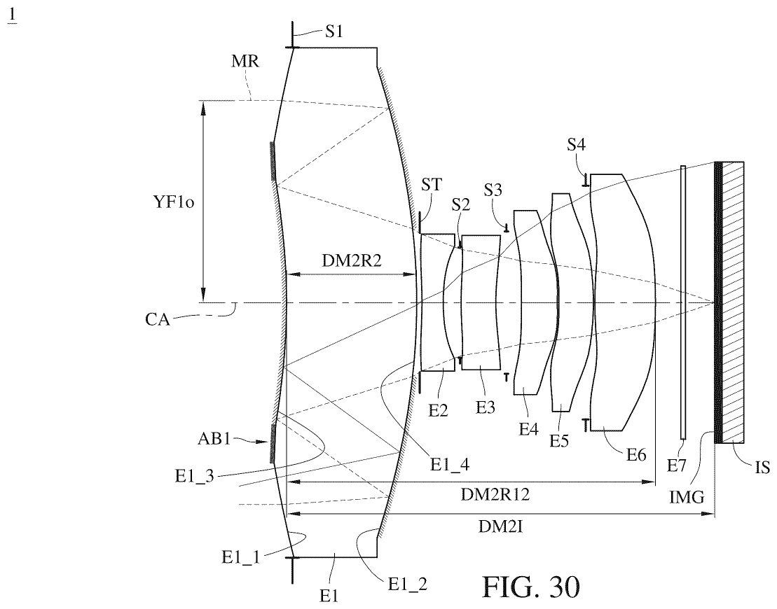

Along a travelling sequence of the optical path, incident light enters the first lens element through the first refractive surface, is subsequently reflected by the first reflective surface, further reflected by the second reflective surface, and finally exits the first lens element through the second refractive surface. Moreover, the second refractive surface is convex in a paraxial region thereof. Therefore, it is favorable for effectively balancing and adjusting the travelling direction of light after reflection, and correcting the incident angle of the light entering the second lens element, thereby reducing the occurrence of distortion. Please refer to FIG. 30, which shows a schematic view of the central axis CA according to the 1st embodiment of the present disclosure.

The second lens element has negative refractive power. Therefore, it is favorable for adjusting the refractive power of the second lens element so as to control the travelling direction of peripheral light to maintain relative illuminance at the periphery. The image-side surface of the second lens element is concave in a paraxial region thereof. Therefore, it is favorable for controlling the surface profile of the image-side surface of the second lens element so as to enlarge the image surface and improve image quality.

The third lens element has positive refractive power. Therefore, it is favorable for balancing the negative refractive power of the second lens element to reduce the spherical aberration of the photography lens assembly.

The fifth lens element has positive refractive power. Therefore, it is favorable for sharing the positive refractive power of the sixth lens element to correct aberrations of the photography lens assembly. The image-side surface of the fifth lens element is convex in a paraxial region thereof. Therefore, it is favorable for adjusting the refraction direction of light so as to reduce the generation of stray light.

The sixth lens element has positive refractive power. Therefore, it is favorable for providing sufficient light-converging capability at the image-side end of the photography lens assembly so as to reduce the size at the image-side end of the photography lens assembly.

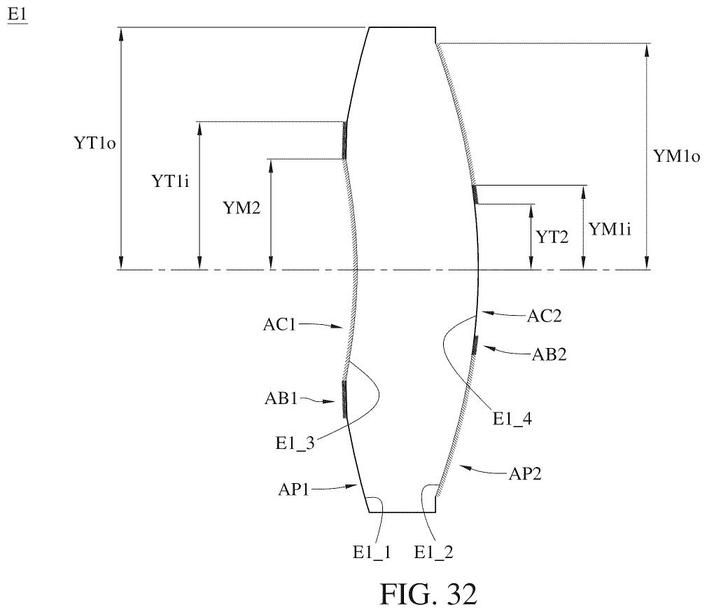

According to the present disclosure, the object-side surface of the first lens element can further have a light-blocking area located between the central area and the peripheral area thereof. Therefore, it is favorable for preventing light from generating stray light in non-effective optical path regions after multiple reflections, thereby reducing the formation of unnecessary light spots and improving image quality. Moreover, the image-side surface of the first lens element can further have a light-blocking area located between the central area and the peripheral area thereof. Please refer to FIG. 31, which shows a schematic view of the light-blocking area AB1 of the object-side surface of the first lens element E1 according to the 1st embodiment of the present disclosure. Furthermore, please refer to FIG. 32, which shows a schematic view of the light-blocking area AB1 of the object-side surface and the light-blocking area AB2 of the image-side surface of the first lens element E1 according to the 2nd embodiment of the present disclosure. Noted that the light-blocking area can include a matte film or an optical spraying layer. The matte film may be a membrane layer design composed of a metal-membrane layer and an oxide-membrane layer. The optical spraying layer may be a dark coating layer with a light-absorbing function, such as a black ink spraying layer formed by epoxy or quick-drying ink in which polyacrylate as a base is contained, a blackened coating layer through chemical vapor deposition, or a photoresistive coating layer. The optical spraying layer is easy to be applied on and adhered to a component surface and is suitable for mass production.

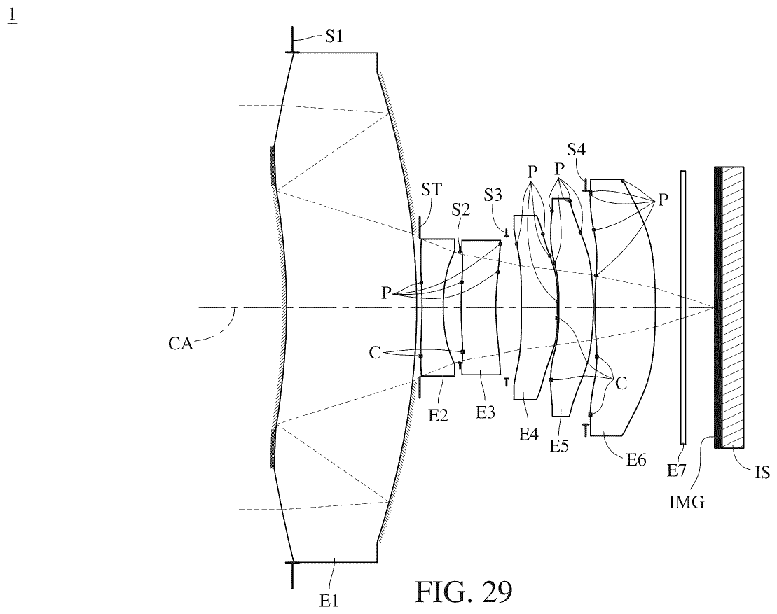

According to the present disclosure, at least one of the object-side surface and the image-side surface of at least one of the second lens element, the third lens element, the fourth lens element, the fifth lens element, and the sixth lens element can have at least one inflection point. Therefore, it is favorable for increasing the flexibility of optical design, thereby facilitating the correction of astigmatism. Please refer to FIG. 29, which shows a schematic view of inflection points P on the object-side surface of the second lens element E2, the object-side surface and the image-side surface of the third lens element E3, the object-side surface and the image-side surface of the fourth lens element E4, the object-side surface and the image-side surface of the fifth lens element E5, and the object-side surface and the image-side surface of the sixth lens element E6 according to the 1st embodiment of the present disclosure. The abovementioned inflection points P on the object-side surface of the second lens element E2, the object-side surface and the image-side surface of the third lens element E3, the object-side surface and the image-side surface of the fourth lens element E4, the object-side surface and the image-side surface of the fifth lens element E5, and the object-side surface and the image-side surface of the sixth lens element E6 in FIG. 29 are exemplary. Each of lens surfaces in various embodiments of the present disclosure may also have one or more inflection points.

According to the present disclosure, at least one of the object-side surface and the image-side surface of at least one of the second lens element, the third lens element, the fourth lens element, the fifth lens element, and the sixth lens element can have at least one critical point in an off-axis region thereof. Therefore, it is favorable for increasing the flexibility of optical design to correct and compensate for peripheral image aberrations. Please refer to FIG. 29, which shows a schematic view of critical points C on the object-side surface of the second lens element E2, the object-side surface of the third lens element E3, the image-side surface of the fourth lens element E4, the object-side surface of the fifth lens element E5, and the object-side surface of the sixth lens element E6 according to the 1st embodiment of the present disclosure. The abovementioned critical points C on the object-side surface of the second lens element E2, the object-side surface of the third lens element E3, the image-side surface of the fourth lens element E4, the object-side surface of the fifth lens element E5, and the object-side surface of the sixth lens element E6 in FIG. 29 are exemplary. Each of lens surfaces in various embodiments of the present disclosure may also have one or more critical points in an off-axis region thereof.

When a focal length of the fifth lens element is f5, and a focal length of the sixth lens element is f6, the following condition can be satisfied: 0.00<|f5/f6|<7.00. Therefore, it is favorable for balancing the refractive power configuration at the image-side end of the photography lens assembly, thereby enhancing light-converging quality. Moreover, the following condition can also be satisfied: 0.10<|f5/f6|<6.50. Moreover, the following condition can also be satisfied: 0.23≤|f5/f6|≤ 6.02.

When a curvature radius of the image-side surface of the first lens element is R2, and a curvature radius of the image-side surface of the sixth lens element is R12, the following condition can be satisfied: 0.00<|R2/R12|<1.60. Therefore, it is favorable for controlling the travelling direction of light within the photography lens assembly, thereby enhancing the light-converging quality of both paraxial and off-axis rays. Moreover, the following condition can also be satisfied: 0.10<|R2/R12|<1.40. Moreover, the following condition can also be satisfied: 0.23≤|R2/R12|≤1.34.

When an Abbe number of the second lens element is V2, and an Abbe number of the fifth lens element is V5, the following condition can be satisfied: 10.0<V5−V2<35.0. Therefore, it is favorable for adjusting the distribution of lens materials can be adjusted, thereby facilitating the correction of chromatic aberration in the photography lens assembly. Moreover, the following condition can also be satisfied: 15.0<V5−V2<30.0. Moreover, the following condition can also be satisfied: 16.5≤V5−V2≤27.9.

When an axial distance between the second reflective surface and an image surface is DM2I, and a focal length of the photography lens assembly is f, the following condition can be satisfied: 0.50<DM2I/f<0.80. Therefore, it is favorable for balancing the total track length and the field of view of the photography lens assembly, thereby ensuring improved telephoto capability. Moreover, the following condition can also be satisfied: 0.55<DM2I/f<0.75. Please refer to FIG. 30, which shows a schematic view of DM2I, the second reflective surface E1_3, and the image surface IMG according to the 1st embodiment of the present disclosure.

When a maximum image height of the photography lens assembly is ImgH, and the focal length of the photography lens assembly is f, the following condition can be satisfied: 0.18<ImgH/f<0.28. Therefore, it is favorable for controlling the shooting range of the photography lens assembly so as to enhance the resolution within localized regions of the image. Moreover, the following condition can also be satisfied: 0.20≤ImgH/f<0.25.

When an axial distance between the second reflective surface and the image-side surface of the sixth lens element is DM2R12, and an axial distance between the object-side surface of the fourth lens element and the image-side surface of the sixth lens element is Dr7r12, the following condition can be satisfied: 2.00<DM2R12/Dr7r12<3.50. Therefore, it is favorable for reducing the size at the image-side end of the photography lens assembly. Moreover, the following condition can also be satisfied: 2.30<DM2R12/Dr7r12<3.20. Please refer to FIG. 30, which shows a schematic view of DM2R12 according to the 1st embodiment of the present disclosure.

When a curvature radius of the object-side surface of the second lens element is R3, and a curvature radius of the image-side surface of the second lens element is R4, the following condition can be satisfied: 0.00< (R3+R4)/(R3−R4). Therefore, it is favorable for enhancing the light control capability of the image-side surface of the second lens element so as to enlarge the image surface and correct aberrations. Moreover, the following condition can also be satisfied: 0.00< (R3+R4)/(R3−R4)<2.00. Moreover, the following condition can also be satisfied: 0.10< (R3+R4)/(R3−R4)<1.70. Moreover, the following condition can also be satisfied: 0.20< (R3+R4)/(R3−R4)<1.50.

When the focal length of the photography lens assembly is f, a focal length of the third lens element is f3, a focal length of the fourth lens element is f4, and the focal length of the fifth lens element is f5, the following condition can be satisfied: 0.30<|f/f3|+|f/f4|+|f/f5|<3.00. Therefore, it is favorable for balancing the refractive power configuration of the photography lens assembly so as to correct aberrations. Moreover, the following condition can also be satisfied: 0.40<|f/f3|+|f/f4|+|f/f5|<2.70.

When a central thickness of the fourth lens element is CT4, and a central thickness of the fifth lens element is CT5, the following condition can be satisfied: 0.70<CT4/CT5<2.50. Therefore, it is favorable for adjusting the ratio of the central thickness of the fourth lens element to the central thickness of the fifth lens element so as to control of the thickness of the fourth lens element. Moreover, the following condition can also be satisfied: 0.8<CT4/CT5<2.20. Moreover, the following condition can also be satisfied: 0.9<CT4/CT5<1.90.

When the focal length of the photography lens assembly is f, and a sum of central thicknesses of all lens elements of the photography lens assembly is ECT, the following condition can be satisfied: 1.50<f/ΣCT<2.50. Therefore, it is favorable for reducing the size of the photography lens assembly. Moreover, the following condition can also be satisfied: 1.70<f/ΣCT<2.30. Specifically, ΣCT is a sum of central thicknesses of the first lens element, the second lens element, the third lens element, the fourth lens element, the fifth lens element, and the sixth lens element. Additionally, a central thickness of the first lens element can be an axial distance between the second reflective surface and the second refractive surface.

When an axial distance between the fifth lens element and the sixth lens element is T56, and a central thickness of the sixth lens element is CT6, the following condition can be satisfied: 0.00<T56/CT6<0.40. Therefore, it is favorable for adjusting the ratio of the axial distance between the fifth lens element and the sixth lens element to the central thickness of the sixth lens element so as to correct aberrations in the photography lens assembly. Moreover, the following condition can also be satisfied: 0.01<T56/CT6<0.30.

When the focal length of the photography lens assembly is f, a vertical distance between a central axis and an intersection point of a marginal ray of a center field of view of the photography lens assembly with the first refractive surface is YF1o, and a minimum effective radius of the first refractive surface is YT1i, the following condition can be satisfied: 1.80<0.5×f/(\sqrt{YF1o²−YT1i²})<2.90. Therefore, it is favorable for adjusting the aperture size so as to ensure sufficient amount of incident light into the photography lens assembly, thereby maintaining the brightness of the image. Moreover, the following condition can also be satisfied: 1.90<0.5×f/(\sqrt{YF1o²−YT1i²})<2.80. Moreover, the following condition can also be satisfied: 2.00<0.5×f/(\sqrt{YF1o²−YT1i²})<2.70. Please refer to FIG. 30 and FIG. 31, which respectively show schematic views of YF1o and YT1i according to the 1st embodiment of the present disclosure. Additionally, as shown in FIG. 30, YF1o is the vertical distance between the central axis CA and the intersection point of the marginal ray MR of the center field of view with the first refractive surface E1_1.

When a curvature radius of the image-side surface of the fifth lens element is R10, and a curvature radius of the object-side surface of the sixth lens element is R11, the following condition can be satisfied: 0.00<|R10/R11|<1.50. Therefore, it is favorable for adjusting the travelling direction of light so as to improve the light-converging quality at the peripheral field of view. Moreover, the following condition can also be satisfied: 0.10<|R10/R11|<1.40.

When a maximum effective radius of the first refractive surface is YT1o, and the axial distance between the second reflective surface and the second refractive surface is DM2R2, the following condition can be satisfied: 1.50<YT1o/DM2R2<2.50. Therefore, it is favorable for establishing an appropriate ratio between the aperture size and the thickness of lens element to ensure that the incident light has sufficient space for reflection, while also achieving sufficient amount of incident light. Moreover, the following condition can also be satisfied: 1.75<YT1o/DM2R2<2.25. Moreover, the following condition can also be satisfied: 1.90<YT1o/DM2R2<2.10. Please refer to FIG. 30 and FIG. 31, where FIG. 30 shows a schematic view of the second reflective surface E1_3, the second refractive surface E1_4, and DM2R2 according to the 1st embodiment of the present disclosure, and FIG. 31 shows a schematic view of the first refractive surface E1_1 and YT10 according to the 1st embodiment of the present disclosure.

When an axial distance between the second lens element and the third lens element is T23, and an axial distance between the fourth lens element and the fifth lens element is T45, the following condition can be satisfied: 6.50<T23/T45<14.00. Therefore, it is favorable for adjusting the ratio of the axial distance between the second lens element and the third lens element to the axial distance between the fourth lens element and the fifth lens element, thereby facilitating the reduction of the size at the image-side end of the photography lens assembly. Moreover, the following condition can also be satisfied: 7.00<T23/T45<13.00.

When the central thickness of the first lens element is CT1, and a sum of axial distances between each of all adjacent lens elements of the photography lens assembly is EAT, the following condition can be satisfied: 1.80<CT1/ΣAT<3.50. Therefore, it is favorable for adjusting the lens element configuration and controlling the thickness of the first lens element to maintain an appropriate size. Moreover, the following condition can also be satisfied: 2.00<CT1/ΣAT<3.30. Moreover, the following condition can also be satisfied: 2.20<CT1/ΣAT<3.10. Specifically, ΣAT is a sum of axial distances between each of all adjacent lens elements among the first lens element, the second lens element, the third lens element, the fourth lens element, the fifth lens element, and the sixth lens element.

When the curvature radius of the image-side surface of the second lens element is R4, and a curvature radius of the object-side surface of the third lens element is R5, the following condition can be satisfied: 0.00<|R4/R5|<0.90. Therefore, it is favorable for the surface profile of the image-side surface of the second lens element to be configured to correspond with the surface profile of the object-side surface of the third lens element, thereby reducing the generation of stray light. Moreover, the following condition can also be satisfied: 0.10<|R4/R5|<0.80.

When a focal length of the second lens element is f2, and the focal length of the fourth lens element is f4, the following condition can be satisfied: 0.00<|f2/f4|<0.50. Therefore, it is favorable for enhancing the light control capability of the second lens element, thereby enlarging the image surface so as to improve image quality. Moreover, the following condition can also be satisfied: 0.00<|f2/f4|<0.40.

When the curvature radius of the object-side surface of the sixth lens element is R11, and the curvature radius of the image-side surface of the sixth lens element is R12, the following condition can be satisfied: 0.00<|R11/R12|<2.00. Therefore, it is favorable for adjusting the surface profile and refractive power of the sixth lens element, thereby providing sufficient light-converging capability at the image-side end of the photography lens assembly. Moreover, the following condition can also be satisfied: 0.00<|R11/R12|<1.80.

When a maximum effective radius of the second reflective surface is YM2, and a maximum effective radius of the second refractive surface is YT2, the following condition can be satisfied: 1.55<YM2/YT2<1.80. Therefore, it is favorable for balancing the proportional relationship between the effective radii of the second reflective surface and the second refractive surface so as to adjust the aperture size of light entering the second lens element and preventing the generation of stray light at the periphery. Moreover, the following condition can also be satisfied: 1.60<YM2/YT2<1.75. Please refer to FIG. 31 and FIG. 32, which respectively show schematic views of the second reflective surface E1_3, the second refractive surface E1_4, and YM2 and YT2 according to the 1st and 2nd embodiments of the present disclosure.

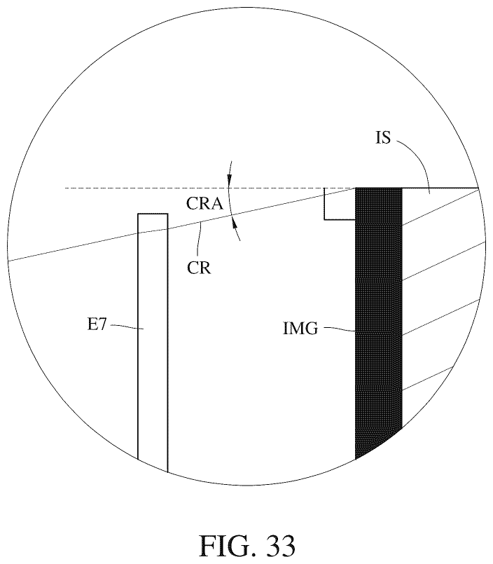

When an incident angle of a chief ray of a maximum field of view of the photography lens assembly on an image surface is CRA, and half of the maximum field of view of the photography lens assembly is HFOV, the following condition can be satisfied: 0.80<CRA/HFOV<1.80. Therefore, it is favorable for adjusting the ratio of the incident angle of the chief ray corresponding to the maximum field of view on the image surface to half of the maximum field of view of the photography lens assembly, thereby enhancing image quality. Moreover, the following condition can also be satisfied: 0.90<CRA/HFOV<1.70. Please refer to FIG. 33, shows a schematic view of CRA according to the present disclosure. In FIG. 33, the chief ray CR of the maximum field of view is incident on the image surface IMG at the image position, and the angle between a normal line of the image surface IMG and the chief ray CR of the maximum field of view is the incident angle CRA of the chief ray of the maximum field of view on the image surface IMG.

According to the present disclosure, the aforementioned features and conditions can be utilized in numerous combinations so as to achieve corresponding effects.

According to the present disclosure, the lens elements of the photography lens assembly can be made of either glass or plastic material. When the lens elements are made of glass material, the refractive power distribution of the photography lens assembly may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the photography lens assembly can therefore be effectively shortened. Additionally, the aspheric surfaces may be formed by plastic injection molding or glass molding.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, when a lens surface is aspheric, it means that the lens surface has an aspheric shape throughout its optically effective area, or a portion(s) thereof.

According to the present disclosure, each of an object-side surface and an image-side surface has a paraxial region and an off-axis region. The paraxial region refers to the region of the surface where light rays travel close to the central axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power, curvature radius, or focus of a lens element is not defined, it indicates that the region of refractive power, curvature radius, or focus of the lens element is in the paraxial region thereof. The focal length of a single lens element is calculated using the lensmaker's formula, assuming air as the medium on both the object side and the image side of the lens element; the composite focal length of multiple lens elements is calculated by assuming air as the medium on both the object side and the image side of the lens elements.

According to the present disclosure, an inflection point is a point on the surface of the lens element at which the surface changes from concave to convex, or vice versa. A critical point is a non-axial point of the lens surface where its tangent is perpendicular to the central axis.

According to the present disclosure, the axial distance between two adjacent lens elements is a distance in a paraxial region between two adjacent lens surfaces of the two adjacent lens elements.

According to the present disclosure, the maximum image height (ImgH) can be half of a diagonal length of an effective photosensitive area of an image sensor.

According to the present disclosure, the image surface of the photography lens assembly, based on the corresponding image sensor, can be flat or curved, especially a curved surface being concave facing towards the object side of the photography lens assembly.

According to the present disclosure, an image correction unit, such as a field flattener, can optionally be disposed between the lens element closest to the image side of the photography lens assembly along the optical path and the image surface for correction of aberrations such as field curvature. The optical properties of the image correction unit, such as curvature, thickness, index of refraction, position, and surface shape (convex or concave surface with spherical, aspheric, diffractive, or Fresnel types), can be adjusted according to the design of the image capturing unit. In general, a preferable image correction unit is, for example, a thin transparent element having a concave object-side surface and a planar image-side surface, and the thin transparent element is disposed near the image surface.

According to the present disclosure, the photography lens assembly can include at least one stop, such as an aperture stop, a glare stop, or a field stop. Said glare stop or said field stop can be disposed between an imaged object and the first lens element, between adjacent lens elements, or between the last lens element and the image surface, and is set for eliminating the stray light and thereby improving image quality thereof.

According to the present disclosure, an aperture stop can be configured as a front stop or a middle stop. A front stop disposed between an imaged object and the first lens element can provide a longer distance between an exit pupil of the photography lens assembly and the image surface to produce a telecentric effect, and thereby improves the image-sensing efficiency of an image sensor (for example, CCD or CMOS). A middle stop disposed between the first lens element and the image surface is favorable for enlarging the viewing angle of the photography lens assembly and thereby provides a wider field of view for the same.

According to the present disclosure, the photography lens assembly can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material, or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the photography lens assembly can include one or more optical elements for limiting the form of light passing through the photography lens assembly. Each optical element can be, but not limited to, a filter, a polarizer, etc., and each optical element can be, but not limited to, a single-piece element, a composite component, a thin film, etc. The optical element can be located at the object side or the image side of the photography lens assembly or between any two adjacent lens elements so as to allow light in a specific form to pass through, thereby meeting application requirements.

According to the present disclosure, the photography lens assembly can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, a light path reflecting element, a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the photography lens assembly can further include a light-blocking element. The light-blocking element can have a non-circular opening, and the non-circular opening can have different effective radii in different directions which are perpendicular to the central axis. Therefore, it is favorable for the light-blocking element to coordinate with the shape of non-circular lens elements or aperture stop so as to reduce the size of the photography lens assembly and make full use of the light passing through said non-circular lens elements or aperture stop, thereby reducing stray light. Moreover, the light-blocking element can be provided with a wavy structure or a jagged structure at a periphery of an inner hole portion thereof.

According to the above description of the present disclosure, the following specific embodiments are provided for further explanation.

### 1st Embodiment

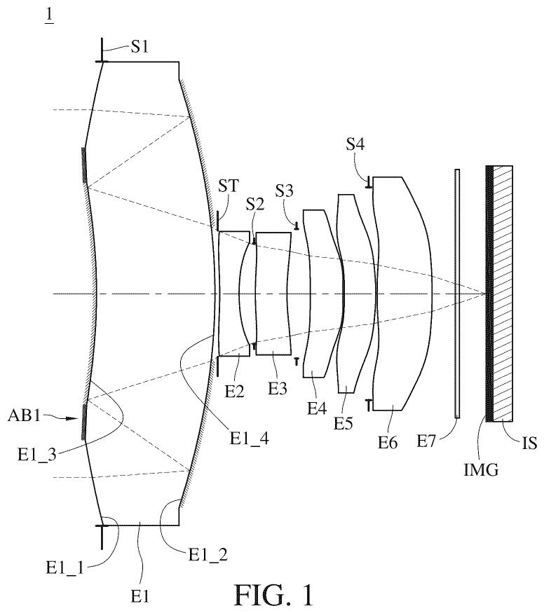

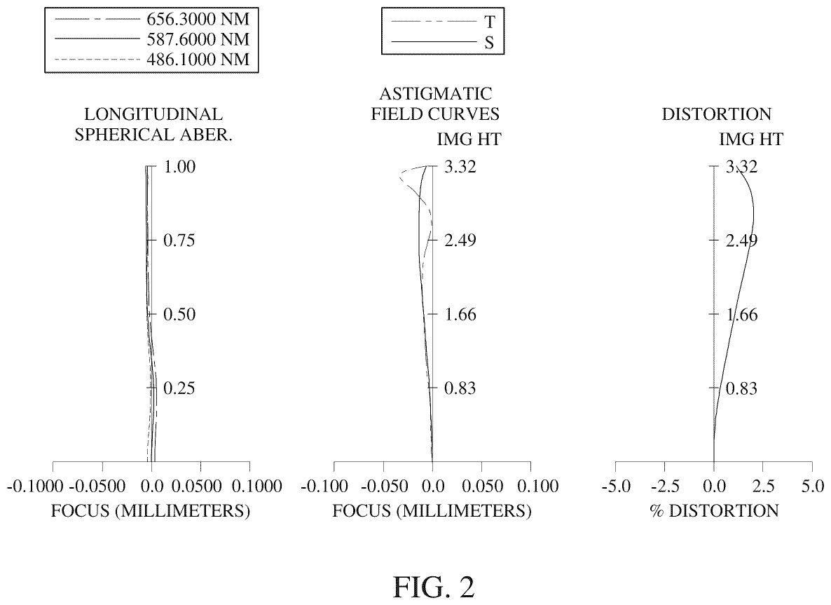

FIG. 1 is a schematic view of an image capturing unit according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit 1 includes the photography lens assembly (its reference numeral is omitted) of the present disclosure and an image sensor IS. The photography lens assembly includes, in order from an object side to an image side along an optical path, a stop S1, a first lens element E1, an aperture stop ST, a second lens element E2, a stop S2, a third lens element E3, a stop S3, a fourth lens element E4, a fifth lens element E5, a stop S4, a sixth lens element E6, a filter E7, and an image surface IMG. The photography lens assembly includes six lens elements (E1, E2, E3, E4, E5, and E6) with no additional lens element disposed between each of the adjacent six lens elements.

The first lens element E1 has a first refractive surface E1_1 facing toward the object side and being located in a peripheral area of an object-side surface (its reference numeral is omitted) of the first lens element E1, a first reflective surface E1_2 facing toward the object side and being located in a peripheral area of an image-side surface (its reference numeral is omitted) of the first lens element E1, a second reflective surface E1_3 facing toward the image side and being located in a central area of the object-side surface of the first lens element E1, and a second refractive surface E1_4 facing toward the image side and being located in a central area of the image-side surface of the first lens element E1. The second refractive surface E1_4 is convex in a paraxial region thereof. The first lens element E1 is made of plastic material and has the first refractive surface E1_1, the first reflective surface E1_2, the second reflective surface E1_3, and the second refractive surface E1_4 being all aspheric. Along a travelling sequence of the optical path, incident light enters the first lens element E1 through the first refractive surface E1_1, is subsequently reflected by the first reflective surface E1_2, further reflected by the second reflective surface E1_3, and finally exits the first lens element E1 through the second refractive surface E1_4. In this embodiment, the object-side surface of the first lens element E1 further has a light-blocking area AB1 located between the central area and the peripheral area thereof.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has two inflection points. The object-side surface of the third lens element E3 has one critical point in an off-axis region thereof.

The fourth lens element E4 with negative refractive power has an object-side surface being concave in a paraxial region thereof and an image-side surface being concave in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has three inflection points. The image-side surface of the fourth lens element E4 has one critical point in an off-axis region thereof.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has three inflection points. The object-side surface of the fifth lens element E5 has one critical point in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has four inflection points. The image-side surface of the sixth lens element E6 has one inflection point.

The object-side surface of the sixth lens element E6 has two critical points in an off-axis region thereof.

The filter E7 is made of glass material and located between the sixth lens element E6 and the image surface IMG, and will not affect the focal length of the photography lens assembly. The image sensor IS is disposed on or near the image surface IMG of the photography lens assembly.

The equation of the aspheric surface profiles of the aforementioned lens elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times ( {Y}^{i} ) ,$$

where,
X is the displacement in parallel with a central axis from an axial vertex on the aspheric surface to a point at a distance of Y from the central axis on the aspheric surface;
Y is the vertical distance from the point on the aspheric surface to the central axis;
R is the curvature radius;
k is the conic coefficient; and
Ai is the i-th aspheric coefficient, and in the embodiments, i may be, but is not limited to, 4, 6, 8, 10, 12, 14, 16, 18, 20, 22, 24, and 26.

In the photography lens assembly of the image capturing unit 1 according to the 1st embodiment, when a focal length of the photography lens assembly is f, an f-number of the photography lens assembly is Fno, and half of a maximum field of view of the photography lens assembly is HFOV, these parameters have the following values: f=14.89 millimeters (mm), Fno=2.64, and HFOV=12.4 degrees (deg.). Noted that said Fno in the present disclosure can refer to an equivalent f-number which is calculated by the following formula: 0.5×f/(\sqrt{YF1o²−YT1i²}).

When an axial distance between the second reflective surface E1_3 and the image surface IMG is DM2I, and the focal length of the photography lens assembly is f, the following condition is satisfied: DM2I/f=0.68.

When a maximum image height of the photography lens assembly is ImgH, and the focal length of the photography lens assembly is f, the following condition is satisfied: ImgH/f=0.22.

When an incident angle of a chief ray of the maximum field of view of the photography lens assembly on the image surface IMG is CRA, and half of the maximum field of view of the photography lens assembly is HFOV, the following condition is satisfied: CRA/HFOV=0.98.

When the focal length of the photography lens assembly is f, and a sum of central thicknesses of all lens elements of the photography lens assembly is ΣCT, the following condition is satisfied: f/ΣCT=1.99.

When an axial distance between the second reflective surface E1_3 and the image-side surface of the sixth lens element E6 is DM2R12, and an axial distance between the object-side surface of the fourth lens element E4 and the image-side surface of the sixth lens element E6 is Dr7r12, the following condition is satisfied: DM2R12/Dr7r12=2.75.

When the focal length of the photography lens assembly is f, a focal length of the third lens element E3 is f3, a focal length of the fourth lens element E4 is f4, and a focal length of the fifth lens element E5 is f5, the following condition is satisfied: |f/f3|+|f/f4|+|f/f5|=2.49.

When a focal length of the second lens element E2 is f2, and the focal length of the fourth lens element E4 is f4, the following condition is satisfied: |f2/f4|=0.18.

When the focal length of the fifth lens element E5 is f5, and a focal length of the sixth lens element E6 is f6, the following condition is satisfied: |f5/f6|=0.79.

When a curvature radius of the image-side surface of the first lens element E1 is R2, and a curvature radius of the image-side surface of the sixth lens element E6 is R12, the following condition is satisfied: |R2/R12|=1.12.

When a curvature radius of the object-side surface of the second lens element E2 is R3, and a curvature radius of the image-side surface of the second lens element E2 is R4, the following condition is satisfied: (R3+R4)/(R3−R4)=0.34.

When the curvature radius of the image-side surface of the second lens element E2 is R4, and a curvature radius of the object-side surface of the third lens element E3 is R5, the following condition is satisfied: |R4/R5|=0.58.

When a curvature radius of the image-side surface of the fifth lens element E5 is R10, and a curvature radius of the object-side surface of the sixth lens element E6 is R11, the following condition is satisfied: |R10/R11|=0.42.

When the curvature radius of the object-side surface of the sixth lens element E6 is R11, and the curvature radius of the image-side surface of the sixth lens element E6 is R12, the following condition is satisfied: |R11/R12|=0.87.

When a central thickness of the first lens element E1 is CT1, and a sum of axial distances between each of all adjacent lens elements of the photography lens assembly is ΣAT, the following condition is satisfied: CT1/ΣAT=2.52.

When an axial distance between the second lens element E2 and the third lens element E3 is T23, and an axial distance between the fourth lens element E4 and the fifth lens element E5 is T45, the following condition is satisfied: T23/T45=12.06.

When a central thickness of the fourth lens element E4 is CT4, and a central thickness of the fifth lens element E5 is CT5, the following condition is satisfied: CT4/CT5=1.04.

When an axial distance between the fifth lens element E5 and the sixth lens element E6 is T56, and a central thickness of the sixth lens element E6 is CT6, the following condition is satisfied: T56/CT6=0.02.

When an Abbe number of the second lens element E2 is V2, and an Abbe number of the fifth lens element E5 is V5, the following condition is satisfied: V5−V2=18.7.

When the focal length of the photography lens assembly is f, a vertical distance between the central axis and an intersection point of a marginal ray of a center field of view of the photography lens assembly with the first refractive surface E1_1 is YF1o, and a minimum effective radius of the first refractive surface E1_1 is YT1i, the following condition is satisfied: 0.5×f/(\sqrt{YF1o²−YT1i²})=2.64.

When the vertical distance between the central axis and the intersection point of the marginal ray of the center field of view of the photography lens assembly with the first refractive surface E1_1 is YF1o, the following condition is satisfied: YF10=4.77 mm.

When a maximum effective radius of the first refractive surface E1_1 is YT1o, the following condition is satisfied: YT1o=6.02 mm.

When the minimum effective radius of the first refractive surface E1_1 is YT1i, the following condition is satisfied: YT1i=3.85 mm.

When a maximum effective radius of the first reflective surface E1_2 is YM10, the following condition is satisfied: YM1o=5.56 mm. Please refer to FIG. 31, which shows a schematic view of YM10 according to the 1st embodiment of the present disclosure.

When a minimum effective radius of the first reflective surface E1_2 is YM1i, the following condition is satisfied: YM1i=1.76 mm. Please refer to FIG. 31, which shows a schematic view of YM1i according to the 1st embodiment of the present disclosure.

When a maximum effective radius of the second reflective surface E1_3 is YM2, the following condition is satisfied: YM2=2.88 mm.

When a maximum effective radius of the second refractive surface E1_4 is YT2, the following condition is satisfied: YT2=1.76 mm.

When the maximum effective radius of the first refractive surface E1_1 is YT1o, and an axial distance between the second reflective surface E1_3 and the second refractive surface E1_4 is DM2R2, the following condition is satisfied: YT1o/DM2R2=1.96.

When the maximum effective radius of the second reflective surface E1_3 is YM2, and the maximum effective radius of the second refractive surface E1_4 is YT2, the following condition is satisfied: YM2/YT2=1.64.

The detailed optical data of the 1st embodiment are shown in Table 1A and the aspheric surface data are shown in Table 1B below.

TABLE 1A
1st Embodiment
f = 14.89 mm, Fno = 2.64, HFOV = 12.4 deg.

| Surface | | Curvature | | | | | Abbe | Refractive/ | Focal |
|---|---|---|---|---|---|---|---|---|---|
| # | | Radius | | Thickness | Material | Index | # | Reflective | Length |
| 0 | Object | Infinity | | Infinity | | | | Refract | |
| 1 | Stop | Plano | | −0.760 | | | | Refract | |
| 2 | Lens 1 | 21.6694 | (ASP) | 3.694 | Plastic | 1.535 | 55.9 | Refract | — |
| | peripheral area | | | | | | | | |
| 3 | | −15.7181 | (ASP) | −3.072 | Plastic | 1.535 | 55.9 | Reflect | — |
| 4 | Lens 1 | −14.2638 | (ASP) | 3.072 | Plastic | 1.535 | 55.9 | Reflect | — |
| | central area | | | | | | | | |
| 5 | | −15.7181 | (ASP) | 0.071 | | | | Refract | |
| 6 | Ape. Stop | Plano | | 0.054 | | | | Refract | |
| 7 | Lens 2 | −9.5751 | (ASP) | 0.502 | Plastic | 1.567 | 37.4 | Refract | −5.49 |
| 8 | | 4.6918 | (ASP) | 0.393 | | | | Refract | |
| 9 | Stop | Plano | | 0.029 | | | | Refract | |
| 10 | Lens 3 | 8.0315 | (ASP) | 0.820 | Plastic | 1.650 | 21.8 | Refract | −31.40 |
| 11 | | 5.5307 | (ASP) | 0.250 | | | | Refract | |
| 12 | Stop | Plano | | 0.354 | | | | Refract | |
| 13 | Lens 4 | −111.9955 | (ASP) | 0.848 | Plastic | 1.535 | 55.9 | Refract | −29.87 |
| 14 | | 18.6687 | (ASP) | 0.035 | | | | Refract | |
| 15 | Lens 5 | −141.1384 | (ASP) | 0.817 | Plastic | 1.545 | 56.1 | Refract | 9.82 |
| 16 | | −5.1686 | (ASP) | −0.185 | | | | Refract | |
| 17 | Stop | Plano | | 0.220 | | | | Refract | |
| 18 | Lens 6 | 12.2668 | (ASP) | 1.428 | Plastic | 1.535 | 55.9 | Refract | 12.49 |
| 19 | | −14.0527 | (ASP) | 0.600 | | | | Refract | |

| | | | | | | | | |
|---|---|---|---|---|---|---|---|---|
| 20 | Filter | Plano | 0.110 | Glass | 1.517 | 64.2 | Refract | — |
| 21 | | Plano | 0.693 | | | | Refract | |
| 22 | Image | Plano | — | | | | Refract | |

Note:
Reference wavelength is 587.6 nm (d-line).
An effective radius of the stop S1 (Surface 1) is 6.028 mm.
An effective radius of the stop S2 (Surface 9) is 1.308 mm.
An effective radius of the stop S3 (Surface 12) is 1.680 mm.
An effective radius of the stop S4 (Surface 17) is 2.762 mm.

TABLE 1B
Aspheric Coefficients

| Surface # | 2 | 3 | 4 | 5 |
|---|---|---|---|---|
| k= | −2.11187E+00 | −1.02859E+00 | −8.03266E+00 | −1.02859E+00 |
| A4= | 7.1087233E−06 | 5.6750902E−05 | 4.0300122E−04 | 5.6750902E−05 |
| A6= | 2.4797810E−07 | −2.2157677E−07 | −2.8695692E−05 | −2.2157677E−07 |
| A8= | −1.0632493E−07 | −2.7188144E−08 | 1.5962185E−06 | −2.7188144E−08 |
| A10= | 3.9260724E−09 | 1.1705183E−09 | −2.1012919E−08 | 1.1705183E−09 |
| A12= | −8.5294870E−11 | −1.3602788E−11 | — | −1.3602788E−11 |
| A14= | 1.0648325E−12 | −4.3818772E−14 | — | −4.3818772E−14 |
| A16= | — | 4.8612714E−15 | — | 4.8612714E−15 |

| Surface # | 7 | 8 | 10 | 11 |
|---|---|---|---|---|
| k= | 0.00000E+00 | 0.00000E+00 | 0.00000E+00 | 0.00000E+00 |
| A4= | 3.1255013E−02 | 3.0797693E−02 | −3.0956562E−02 | −2.7856089E−02 |
| A6= | −7.0764419E−03 | −9.6902674E−03 | 2.6328210E−03 | 8.3016763E−03 |
| A8= | −9.0485429E−04 | 1.2020711E−02 | −1.3605993E−04 | −1.2092673E−02 |
| A10= | 3.0060556E−03 | −1.2097888E−02 | −3.4489187E−03 | 1.4547011E−02 |
| A12= | −2.2946091E−03 | 4.8759105E−03 | 4.6833237E−03 | −1.1389608E−02 |
| A14= | 1.0220851E−03 | 2.5212999E−03 | −2.4661337E−03 | 5.9394364E−03 |
| A16= | −2.8171480E−04 | −3.6768676E−03 | 2.6885303E−04 | −1.9384907E−03 |
| A18= | 4.4441541E−05 | 1.5281223E−03 | 2.1461029E−04 | 3.5373817E−04 |
| A20= | −3.0722810E−06 | −2.3192702E−04 | −6.3668513E−05 | −2.7410525E−05 |

| Surface # | 13 | 14 | 15 | 16 |
|---|---|---|---|---|
| k= | 0.00000E+00 | 0.00000E+00 | 0.00000E+00 | 0.00000E+00 |
| A4= | −3.2033131E−02 | −2.3020066E−01 | −1.8173780E−01 | 4.8976058E−02 |
| A6= | 1.2478625E−02 | 1.3710504E−01 | 1.3567566E−01 | −2.6227039E−02 |
| A8= | −1.0043698E−02 | −5.5751516E−02 | −6.1302540E−02 | −1.5586856E−02 |
| A10= | 2.8139015E−03 | 3.9609123E−02 | 2.9445132E−02 | 2.2475776E−02 |
| A12= | 2.3184122E−03 | −3.7114829E−02 | −1.4221572E−02 | −1.1956818E−02 |
| A14= | −2.0093484E−03 | 2.5607212E−02 | 5.1734076E−03 | 3.8113301E−03 |
| A16= | 6.5164165E−04 | −1.1913283E−02 | −1.2789520E−03 | −7.8753942E−04 |
| A18= | −1.0272114E−04 | 3.7273510E−03 | 2.0954258E−04 | 1.0514117E−04 |
| A20= | 6.5609243E−06 | −7.7466225E−04 | −2.2150497E−05 | −8.6315816E−06 |
| A22= | — | 1.0268877E−04 | 1.4306392E−06 | 3.8811931E−07 |
| A24= | — | −7.8700144E−06 | −5.0682081E−08 | −7.0599836E−09 |
| A26= | — | 2.6573139E−07 | 7.6405686E−10 | — |

| Surface # | 18 | 19 |
|---|---|---|
| k= | 0.00000E+00 | 0.00000E+00 |
| A4= | 3.4179917E−02 | −7.1688743E−03 |
| A6= | −5.0462215E−02 | 1.1728096E−03 |
| A8= | 2.1281049E−02 | −1.4363985E−03 |
| A10= | −5.2483251E−03 | 1.6643808E−04 |
| A12= | 9.4243763E−04 | 2.6904402E−04 |
| A14= | −1.2728949E−04 | −1.5908941E−04 |
| A16= | 1.0369986E−05 | 4.5700876E−05 |
| A18= | −1.8999612E−08 | −8.0714421E−06 |
| A20= | −8.8365602E−08 | 9.1425645E−07 |
| A22= | 7.6981747E−09 | −6.4791680E−08 |
| A24= | −2.1474994E−10 | 2.6138216E−09 |
| A26= | — | −4.5723827E−11 |

In Table 1A, the curvature radius, the thickness and the focal length are shown in millimeters (mm). Surface numbers 0-22 represent the surfaces sequentially arranged from the object side to the image side along the central axis. In Table 1B, k represents the conic coefficient of the equation of the aspheric surface profiles. A4-A26 represent the aspheric coefficients ranging from the 4th order to the 26th order. The tables presented below for each embodiment are the corresponding schematic parameter and aberration curves, and the definitions of the tables are the same as Table 1A and Table 1B of the 1st embodiment. Therefore, an explanation in this regard will not be provided again.

### 2nd Embodiment

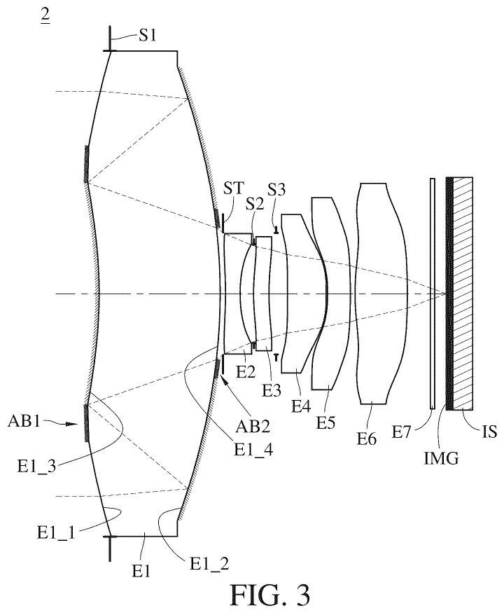

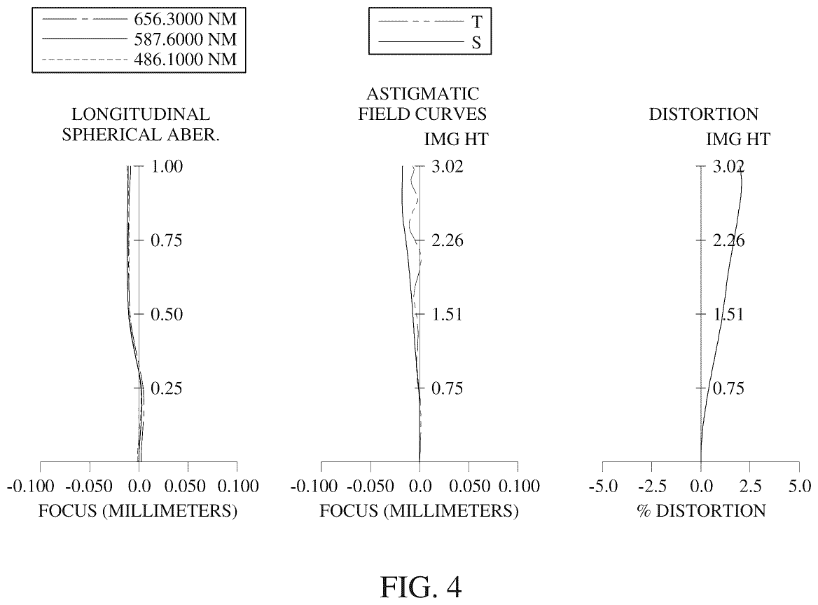

FIG. 3 is a schematic view of an image capturing unit according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit 2 includes the photography lens assembly (its reference numeral is omitted) of the present disclosure and an image sensor IS. The photography lens assembly includes, in order from an object side to an image side along an optical path, a stop S1, a first lens element E1, an aperture stop ST, a second lens element E2, a stop S2, a third lens element E3, a stop S3, a fourth lens element E4, a fifth lens element E5, a sixth lens element E6, a filter E7, and an image surface IMG. The photography lens assembly includes six lens elements (E1, E2, E3, E4, E5, and E6) with no additional lens element disposed between each of the adjacent six lens elements.

The first lens element E1 has a first refractive surface E1_1 facing toward the object side and being located in a peripheral area of an object-side surface (its reference numeral is omitted) of the first lens element E1, a first reflective surface E1_2 facing toward the object side and being located in a peripheral area of an image-side surface (its reference numeral is omitted) of the first lens element E1, a second reflective surface E1_3 facing toward the image side and being located in a central area of the object-side surface of the first lens element E1, and a second refractive surface E1_4 facing toward the image side and being located in a central area of the image-side surface of the first lens element E1. The second refractive surface E1_4 is convex in a paraxial region thereof. The first lens element E1 is made of plastic material and has the first refractive surface E1_1, the first reflective surface E1_2, the second reflective surface E1_3, and the second refractive surface E1_4 being all aspheric. Along a travelling sequence of the optical path, incident light enters the first lens element E1 through the first refractive surface E1_1, is subsequently reflected by the first reflective surface E1_2, further reflected by the second reflective surface E1_3, and finally exits the first lens element E1 through the second refractive surface E1_4. In this embodiment, the object-side surface of the first lens element E1 further has a light-blocking area AB1 located between the central area and the peripheral area thereof, and the image-side surface of the first lens element E1 further has a light-blocking area AB2 located between the central area and the peripheral area thereof.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one critical point in an off-axis region thereof. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has two inflection points. The object-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has three inflection points. The object-side surface of the fifth lens element E5 has one critical point in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has two critical points in an off-axis region thereof.

The filter E7 is made of glass material and located between the sixth lens element E6 and the image surface IMG, and will not affect the focal length of the photography lens assembly. The image sensor IS is disposed on or near the image surface IMG of the photography lens assembly.

The detailed optical data of the 2nd embodiment are shown in Table 2A and the aspheric surface data are shown in Table 2B below.

TABLE 2A
2nd Embodiment
f = 14.62 mm, Fno = 2.04, HFOV = 11.5 deg.

| Surface | | Curvature | | | | | Abbe | Refractive/ | Focal |
|---|---|---|---|---|---|---|---|---|---|
| # | | Radius | | Thickness | Material | Index | # | Reflective | Length |
| 0 | Object | Infinity | | Infinity | | | | Refract | |
| 1 | Stop | Plano | | −0.900 | | | | Refract | |
| 2 | Lens 1 | 20.5212 | (ASP) | 3.767 | Plastic | 1.534 | 56.0 | Refract | — |
| | peripheral area | | | | | | | | |
| 3 | | −14.8512 | (ASP) | −3.145 | Plastic | 1.534 | 56.0 | Reflect | — |
| 4 | Lens 1 | −12.0963 | (ASP) | 3.145 | Plastic | 1.534 | 56.0 | Reflect | — |
| | central area | | | | | | | | |
| 5 | | −14.8512 | (ASP) | 0.072 | | | | Refract | |
| 6 | Ape. Stop | Plano | | 0.068 | | | | Refract | |
| 7 | Lens 2 | −8.9702 | (ASP) | 0.380 | Plastic | 1.584 | 28.2 | Refract | −4.61 |
| 8 | | 3.9055 | (ASP) | 0.358 | | | | Refract | |
| 9 | Stop | Plano | | −0.009 | | | | Refract | |
| 10 | Lens 3 | 5.7405 | (ASP) | 0.400 | Plastic | 1.650 | 21.8 | Refract | 75.07 |
| 11 | | 6.3278 | (ASP) | 0.188 | | | | Refract | |
| 12 | Stop | Plano | | 0.294 | | | | Refract | |
| 13 | Lens 4 | 167.7840 | (ASP) | 1.006 | Plastic | 1.551 | 44.8 | Refract | 19.12 |
| 14 | | −11.2112 | (ASP) | 0.035 | | | | Refract | |
| 15 | Lens 5 | −5.8622 | (ASP) | 0.594 | Plastic | 1.544 | 56.0 | Refract | −29.34 |
| 16 | | −9.5948 | (ASP) | 0.121 | | | | Refract | |
| 17 | Lens 6 | 7.1530 | (ASP) | 1.358 | Plastic | 1.545 | 56.1 | Refract | 9.63 |
| 18 | | −18.3959 | (ASP) | 0.600 | | | | Refract | |

| | | | | | | | | |
|---|---|---|---|---|---|---|---|---|
| 19 | Filter | Plano | 0.110 | Glass | 1.517 | 64.2 | Refract | — |
| 20 | | Plano | 0.303 | | | | Refract | |
| 21 | Image | Plano | — | | | | Refract | |

Note:
Reference wavelength is 587.6 nm (d-line).
An effective radius of the stop S1 (Surface 1) is 6.307 mm.
An effective radius of the stop S2 (Surface 9) is 1.282 mm.
An effective radius of the stop S3 (Surface 12) is 1.579 mm.

TABLE 2B
Aspheric Coefficients

| Surface # | 2 | 3 | 4 | 5 |
|---|---|---|---|---|
| k= | −1.88386E+00 | −9.77697E−01 | −7.99791E+00 | −9.77697E−01 |
| A4= | −2.4770891E−05 | 4.6978923E−05 | 4.1102436E−04 | 4.6978923E−05 |
| A6= | 1.4168824E−06 | 3.7801578E−07 | −2.7600277E−05 | 3.7801578E−07 |
| A8= | −9.1513020E−08 | −3.9339647E−08 | 1.1713285E−06 | −3.9339647E−08 |
| A10= | 2.9810324E−09 | 1.6481649E−09 | −2.1187423E−08 | 1.6481649E−09 |
| A12= | −5.1867474E−11 | −3.7303007E−11 | — | −3.7303007E−11 |
| A14= | 4.6880548E−13 | 4.8686405E−13 | — | 4.8686405E−13 |
| A16= | — | −2.2045790E−15 | — | −2.2045790E−15 |

| Surface # | 7 | 8 | 10 | 11 |
|---|---|---|---|---|
| k= | 0.00000E+00 | 0.00000E+00 | 0.00000E+00 | 0.00000E+00 |
| A4= | 3.1719971E−02 | 3.2924367E−02 | −3.2662491E−02 | −2.6318829E−02 |
| A6= | −9.1685404E−03 | −2.0477622E−02 | 2.2164920E−02 | 1.7895302E−02 |
| A8= | 9.2989718E−04 | 4.7792724E−02 | −4.6382937E−02 | −3.1261689E−02 |
| A10= | 1.0051934E−03 | −7.7048881E−02 | 6.4775974E−02 | 3.4697916E−02 |
| A12= | 5.7174237E−05 | 7.5176576E−02 | −6.8370291E−02 | −2.7827889E−02 |
| A14= | −6.6866188E−04 | −4.2578323E−02 | 5.1806561E−02 | 1.5512569E−02 |
| A16= | 4.0159694E−04 | 1.2639303E−02 | −2.6122096E−02 | −5.5782072E−03 |
| A18= | −1.0047731E−04 | −1.3089338E−03 | 7.7412757E−03 | 1.1681878E−03 |
| A20= | 9.5397066E−06 | −9.5460922E−05 | −1.0141042E−03 | −1.0879356E−04 |

| Surface # | 13 | 14 | 15 | 16 |
|---|---|---|---|---|
| k= | 0.00000E+00 | 0.00000E+00 | 0.00000E+00 | 0.00000E+00 |
| A4= | −3.1568471E−02 | −2.1871399E−01 | −1.6832379E−01 | 4.9000111E−02 |
| A6= | 1.8859903E−02 | 6.0964388E−02 | 6.2409109E−02 | −3.3229862E−02 |
| A8= | −2.4412835E−02 | 1.6778215E−01 | 1.3802966E−01 | −9.5285422E−03 |
| A10= | 2.3192447E−02 | −2.6258738E−01 | −2.2467688E−01 | 2.0036329E−02 |
| A12= | −1.7160448E−02 | 2.0505450E−01 | 1.7273465E−01 | −1.1831889E−02 |
| A14= | 8.7794433E−03 | −1.0410620E−01 | −8.2636759E−02 | 4.0538429E−03 |
| A16= | −2.7144081E−03 | 3.7085486E−02 | 2.6410796E−02 | −8.8596741E−04 |
| A18= | 4.5501645E−04 | −9.4787677E−03 | −5.7591458E−03 | 1.2465091E−04 |
| A20= | −3.1926571E−05 | 1.7152438E−03 | 8.4925413E−04 | −1.0944910E−05 |
| A22= | — | −2.0904718E−04 | −8.1201497E−05 | 5.4853259E−07 |
| A24= | — | 1.5382212E−05 | 4.5506379E−06 | −1.2081116E−08 |
| A26= | — | −5.1566604E−07 | −1.1358521E−07 | — |

| Surface # | 17 | 18 |
|---|---|---|
| k= | 0.00000E+00 | 0.00000E+00 |
| A4= | 2.2273673E−02 | −3.8134229E−03 |
| A6= | −4.2214075E−02 | −1.8242627E−03 |
| A8= | 2.1940109E−02 | −2.4320793E−04 |
| A10= | −8.1207480E−03 | 2.5805784E−04 |
| A12= | 2.3341933E−03 | −2.2552058E−04 |
| A14= | −4.7491889E−04 | 1.5123899E−04 |
| A16= | 6.4321966E−05 | −5.6959768E−05 |
| A18= | −5.5996758E−06 | 1.2727436E−05 |
| A20= | 2.9843011E−07 | −1.7446629E−06 |
| A22= | −8.7511592E−09 | 1.4436539E−07 |
| A24= | 1.0545957E−10 | −6.6252299E−09 |
| A26= | — | 1.2955311E−10 |

In the 2nd embodiment, the equation of the aspheric surface profiles of the aforementioned lens elements is the same as the equation of the 1st embodiment. Also, the definitions of these parameters shown in Table 2C below are the same as those stated in the 1st embodiment, with corresponding values for the 2nd embodiment; therefore, an explanation in this regard will not be provided again.

Moreover, these parameters can be calculated from Table 2A and Table 2B 5 as the following values and satisfy the following conditions:

TABLE 2C
Values of Optical and Physical Parameters/Definitions

| | | | |
|---|---|---|---|
| f [mm] | 14.62 | CT1/ΣAT | 2.79 |
| Fno | 2.04 | T23/T45 | 9.97 |
| HFOV [deg.] | 11.5 | CT4/CT5 | 1.69 |
| DM2I/f | 0.62 | T56/CT6 | 0.09 |
| ImgH/f | 0.21 | V5 − V2 | 27.8 |
| CRA/HFOV | 1.36 | 0.5 × f/ | 2.04 |
| | | (\sqrt{YF1o² − YT1i²}) | |
| f/ΣCT | 2.12 | YF1o [mm] | 5.26 |
| DM2R12/Dr7r12 | 2.57 | YT1o [mm] | 6.30 |
| \|f/f3\| + \|f/f4\| + | 1.46 | YT1i [mm] | 3.85 |
| \|f/f5\| | | | |
| \|f2/f4\| | 0.24 | YM1o [mm] | 5.89 |
| \|f5/f6\| | 3.05 | YM1i [mm] | 2.20 |
| \|R2/R12\| | 0.81 | YM2 [mm] | 2.88 |
| (R3 + R4)/(R3 − R4) | 0.39 | YT2 [mm] | 1.71 |
| \|R4/R5\| | 0.68 | YT1o/DM2R2 | 2.00 |
| \|R10/R11\| | 1.34 | YM2/YT2 | 1.68 |
| \|R11/R12\| | 0.39 | — | — |

### 3rd Embodiment

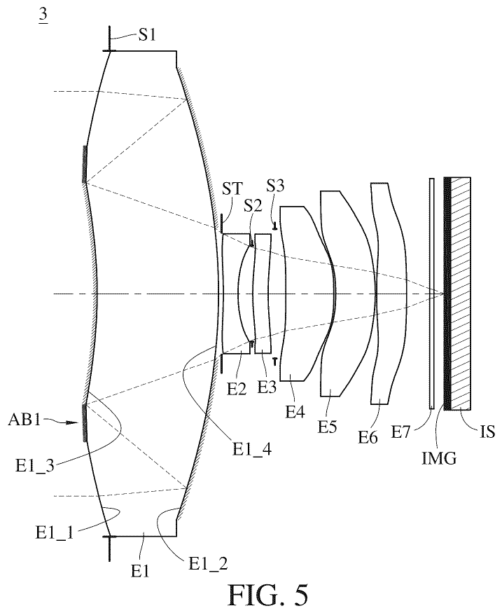

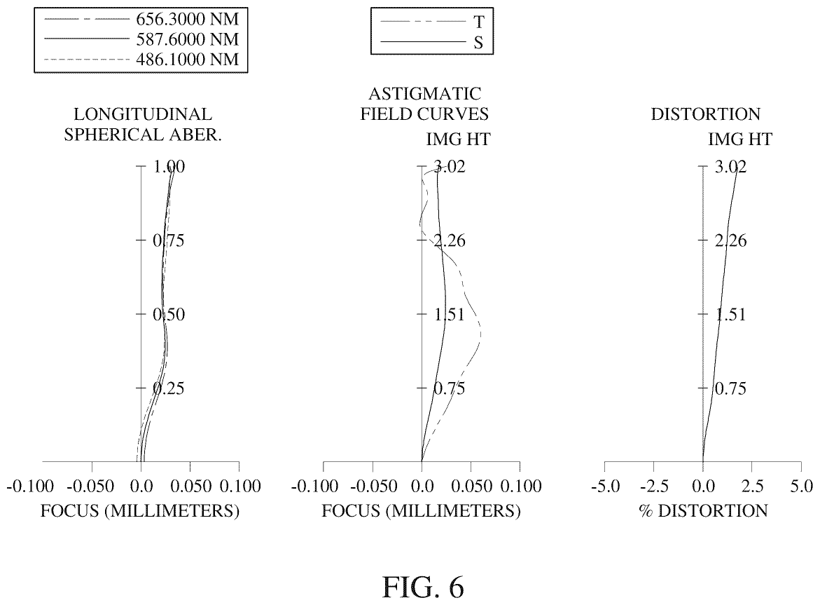

FIG. 5 is a schematic view of an image capturing unit according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit 3 includes the photography lens assembly (its reference numeral is omitted) of the present disclosure and an image sensor IS. The photography lens assembly includes, in order from an object side to an image side along an optical path, a stop S1, a first lens element E1, an aperture stop ST, a second lens element E2, a stop S2, a third lens element E3, a stop S3, a fourth lens element E4, a fifth lens element E5, a sixth lens element E6, a filter E7, and an image surface IMG. The photography lens assembly includes six lens elements (E1, E2, E3, E4, E5, and E6) with no additional lens element disposed between each of the adjacent six lens elements.

The first lens element E1 has a first refractive surface E1_1 facing toward the object side and being located in a peripheral area of an object-side surface (its reference numeral is omitted) of the first lens element E1, a first reflective surface E1_2 facing toward the object side and being located in a peripheral area of an image-side surface (its reference numeral is omitted) of the first lens element E1, a second reflective surface E1_3 facing toward the image side and being located in a central area of the object-side surface of the first lens element E1, and a second refractive surface E1_4 facing toward the image side and being located in a central area of the image-side surface of the first lens element E1. The second refractive surface E1_4 is convex in a paraxial region thereof. The first lens element E1 is made of plastic material and has the first refractive surface E1_1, the first reflective surface E1_2, the second reflective surface E1_3, and the second refractive surface E1_4 being all aspheric. Along a travelling sequence of the optical path, incident light enters the first lens element E1 through the first refractive surface E1_1, is subsequently reflected by the first reflective surface E1_2, further reflected by the second reflective surface E1_3, and finally exits the first lens element E1 through the second refractive surface E1_4. In this embodiment, the object-side surface of the first lens element E1 further has a light-blocking area AB1 located between the central area and the peripheral area thereof.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one critical point in an off-axis region thereof. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has two inflection points. The object-side surface of the fourth lens element E4 has one critical point in an off-axis region thereof.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has two inflection points. The object-side surface of the fifth lens element E5 has two critical points in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has three inflection points. The image-side surface of the sixth lens element E6 has two inflection points. The object-side surface of the sixth lens element E6 has one critical point in an off-axis region thereof.

The filter E7 is made of glass material and located between the sixth lens element E6 and the image surface IMG, and will not affect the focal length of the photography lens assembly. The image sensor IS is disposed on or near the image surface IMG of the photography lens assembly.

The detailed optical data of the 3rd embodiment are shown in Table 3A and 5 the aspheric surface data are shown in Table 3B below.

TABLE 3A
3rd Embodiment
f = 14.56 mm, Fno = 2.04, HFOV = 11.5 deg.

| Surface | | Curvature | | | | | Abbe | Refractive/ | Focal |
|---|---|---|---|---|---|---|---|---|---|
| # | | Radius | | Thickness | Material | Index | # | Reflective | Length |
| 0 | Object | Infinity | | Infinity | | | | Refract | |
| 1 | Stop | Plano | | −0.940 | | | | Refract | |
| 2 | Lens 1 | 19.8372 | (ASP) | 3.775 | Plastic | 1.545 | 56.1 | Reflect | — |
| | peripheral area | | | | | | | | |
| 3 | | −14.9462 | (ASP) | −3.153 | Plastic | 1.545 | 56.1 | Reflect | — |
| 4 | Lens 1 | −12.2510 | (ASP) | 3.153 | Plastic | 1.545 | 56.1 | Refract | — |
| | central area | | | | | | | | |
| 5 | | −14.9462 | (ASP) | 0.080 | | | | Refract | |
| 6 | Ape. Stop | Plano | | 0.047 | | | | Refract | |
| 7 | Lens 2 | −9.6859 | (ASP) | 0.380 | Plastic | 1.587 | 28.3 | Refract | −4.32 |
| 8 | | 3.4872 | (ASP) | 0.363 | | | | Refract | |
| 9 | Stop | Plano | | 0.020 | | | | Refract | |
| 10 | Lens 3 | 5.5732 | (ASP) | 0.400 | Plastic | 1.669 | 19.5 | Refract | 41.21 |
| 11 | | 6.7841 | (ASP) | 0.177 | | | | Refract | |
| 12 | Stop | Plano | | 0.281 | | | | Refract | |
| 13 | Lens 4 | 149.6781 | (ASP) | 1.246 | Plastic | 1.544 | 56.0 | Refract | 36.03 |
| 14 | | −22.4918 | (ASP) | 0.051 | | | | Refract | |
| 15 | Lens 5 | −6.5288 | (ASP) | 1.029 | Plastic | 1.544 | 56.0 | Refract | 21.18 |
| 16 | | −4.3986 | (ASP) | 0.035 | | | | Refract | |
| 17 | Lens 6 | 13.0582 | (ASP) | 0.779 | Plastic | 1.587 | 28.3 | Refract | 14.06 |
| 18 | | −21.9375 | (ASP) | 0.600 | | | | Refract | |

| | | | | | | | | |
|---|---|---|---|---|---|---|---|---|
| 19 | Filter | Plano | 0.110 | Glass | 1.517 | 64.2 | Refract | — |
| 20 | | Plano | 0.266 | | | | Refract | |
| 21 | Image | Plano | — | | | | | |

Note:
Reference wavelength is 587.6 nm (d-line).
An effective radius of the stop S1 (Surface 1) is 6.307 mm.
An effective radius of the stop S2 (Surface 9) is 1.250 mm.
An effective radius of the stop S3 (Surface 12) is 1.680 mm.

TABLE 3B
Aspheric Coefficients

| Surface # | 2 | 3 | 4 | 5 |
|---|---|---|---|---|
| k= | −2.09712E+00 | −9.99342E−01 | −8.39028E+00 | −9.99342E−01 |
| A4= | −4.0085781E−05 | 4.4899501E−05 | 4.2985670E−04 | 4.4899501E−05 |
| A6= | −1.2177989E−06 | −5.3618452E−07 | −2.6346180E−05 | −5.3618452E−07 |
| A8= | 1.0804237E−07 | 4.7597331E−08 | 9.8097541E−07 | 4.7597331E−08 |
| A10= | −2.7699768E−09 | −1.6625980E−09 | −2.9631757E−08 | −1.6625980E−09 |
| A12= | 4.5613628E−11 | 3.8232727E−11 | — | 3.8232727E−11 |
| A14= | −2.2576973E−13 | −4.2775160E−13 | — | −4.2775160E−13 |
| A16= | — | 1.8893180E−15 | — | 1.8893180E−15 |

| Surface # | 7 | 8 | 10 | 11 |
|---|---|---|---|---|
| k= | 0.00000E+00 | 0.00000E+00 | 0.00000E+00 | 0.00000E+00 |
| A4= | 2.4561250E−02 | 1.4538439E−02 | −4.4505232E−02 | −3.2678577E−02 |
| A6= | −1.4661513E−03 | 2.7069884E−02 | 3.2455404E−02 | 9.7982420E−03 |
| A8= | 5.3053148E−03 | −5.8994005E−02 | −2.9373750E−02 | 9.3123953E−03 |
| A10= | −1.5920610E−02 | 1.2424493E−01 | −1.7922144E−03 | −2.3400770E−02 |
| A12= | 1.8831991E−02 | −1.8810987E−01 | 3.6123503E−02 | 2.4129107E−02 |
| A14= | −1.1923378E−02 | 1.8157080E−01 | −4.0547700E−02 | −1.4446315E−02 |
| A16= | 4.3077566E−03 | −1.0450832E−01 | 2.1179312E−02 | 5.0618663E−03 |
| A18= | −8.3974870E−04 | 3.2678466E−02 | −5.4865901E−03 | −9.6357438E−04 |
| A20= | 6.8779400E−05 | −4.2683584E−03 | 5.6052611E−04 | 7.6905317E−05 |

| Surface # | 13 | 14 | 15 | 16 |
|---|---|---|---|---|
| k= | 0.00000E+00 | 0.00000E+00 | 0.00000E+00 | 0.00000E+00 |
| A4= | −4.6934048E−02 | −2.6400533E−01 | −2.4468319E−01 | −2.4145680E−03 |
| A6= | 3.5692968E−02 | 3.0970668E−01 | 3.6775040E−01 | 5.7197865E−02 |
| A8= | −4.3280387E−02 | −3.2755987E−01 | −4.0914548E−01 | −7.1063088E−02 |
| A10= | 3.4462728E−02 | 2.5646054E−01 | 3.2649033E−01 | 4.0080462E−02 |
| A12= | −1.5761202E−02 | −1.3255072E−01 | −1.7619832E−01 | −1.3098762E−02 |
| A14= | 4.3955260E−03 | 4.4528869E−02 | 6.4972614E−02 | 2.5832880E−03 |
| A16= | −7.5358887E−04 | −9.4045517E−03 | −1.6621664E−02 | −2.7701808E−04 |
| A18= | 7.4032059E−05 | 1.0760887E−03 | 2.9545364E−03 | 6.7813156E−06 |
| A20= | −3.2261463E−06 | −1.3893466E−05 | −3.5845517E−04 | 1.8732277E−06 |
| A22= | — | −1.3230723E−05 | 2.8335276E−05 | −2.0668989E−07 |
| A24= | — | 1.6146057E−06 | −1.3162535E−06 | 6.7855455E−09 |
| A26= | — | −6.3691826E−08 | 2.7273525E−08 | — |

| Surface # | 17 | 18 |
|---|---|---|
| k= | 0.00000E+00 | 0.00000E+00 |
| A4= | 2.4154171E−03 | 7.5051391E−03 |
| A6= | 9.0662385E−03 | −3.0598561E−02 |
| A8= | −2.2657656E−02 | 3.3357177E−02 |
| A10= | 1.2845589E−02 | −2.4399620E−02 |
| A12= | −3.7901300E−03 | 1.1686453E−02 |
| A14= | 6.8001686E−04 | −3.7374473E−03 |
| A16= | −7.3395043E−05 | 8.1392371E−04 |
| A18= | 3.8231420E−06 | −1.2094743E−04 |
| A20= | 4.6922621E−08 | 1.2046284E−05 |
| A22= | −1.5860332E−08 | −7.6806483E−07 |
| A24= | 5.5543187E−10 | 2.8305157E−08 |
| A26= | — | −4.5825749E−10 |

In the 3rd embodiment, the equation of the aspheric surface profiles of the aforementioned lens elements is the same as the equation of the 1st embodiment. Also, the definitions of these parameters shown in Table 3C below are the same as those stated in the 1st embodiment, with corresponding values for the 3rd embodiment; therefore, an explanation in this regard will not be provided again.

Moreover, these parameters can be calculated from Table 3A and Table 3B as the following values and satisfy the following conditions:

TABLE 3C
Values of Optical and Physical Parameters/Definitions

| | | | |
|---|---|---|---|
| f [mm] | 14.56 | CT1/ΣAT | 2.99 |
| Fno | 2.04 | T23/T45 | 7.51 |
| HFOV [deg.] | 11.5 | CT4/CT5 | 1.21 |
| DM2I/f | 0.62 | T56/CT6 | 0.04 |
| ImgH/f | 0.21 | V5 − V2 | 27.7 |
| CRA/HFOV | 1.31 | 0.5 × f/(\sqrt{YF1o² − YT1i²}) | 2.04 |
| f/ΣCT | 2.08 | YF1o [mm] | 5.25 |
| DM2R12/Dr7r12 | 2.56 | YT1o [mm] | 6.30 |
| \|f/f3\| + \|f/f4\| + \|f/f5\| | 1.44 | YT1i [mm] | 3.85 |
| \|f2/f4\| | 0.12 | YM1o [mm] | 5.87 |
| \|f5/f6\| | 1.51 | YM1i [mm] | 1.71 |
| \|R2/R12\| | 0.68 | YM2 [mm] | 2.88 |
| (R3 + R4)/(R3 − R4) | 0.47 | YT2 [mm] | 1.71 |
| \|R4/R5\| | 0.63 | YT1o/DM2R2 | 2.00 |
| \|R10/R11\| | 0.34 | YM2/YT2 | 1.69 |
| \|R11/R12\| | 0.60 | — | — |

### 4th Embodiment

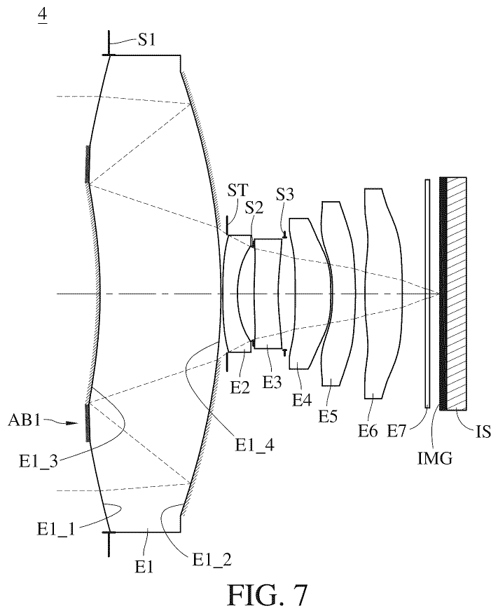

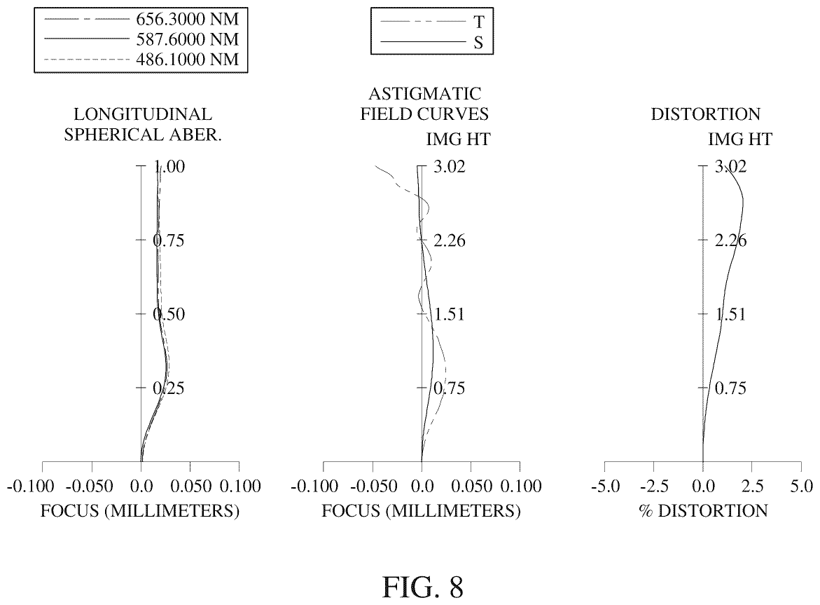

FIG. 7 is a schematic view of an image capturing unit according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit 4 includes the photography lens assembly (its reference numeral is omitted) of the present disclosure and an image sensor IS. The photography lens assembly includes, in order from an object side to an image side along an optical path, a stop S1, a first lens element E1, an aperture stop ST, a second lens element E2, a stop S2, a third lens element E3, a stop S3, a fourth lens element E4, a fifth lens element E5, a sixth lens element E6, a filter E7, and an image surface IMG. The photography lens assembly includes six lens elements (E1, E2, E3, E4, E5, and E6) with no additional lens element disposed between each of the adjacent six lens elements.

The first lens element E1 has a first refractive surface E1_1 facing toward the object side and being located in a peripheral area of an object-side surface (its reference numeral is omitted) of the first lens element E1, a first reflective surface E1_2 facing toward the object side and being located in a peripheral area of an image-side surface (its reference numeral is omitted) of the first lens element E1, a second reflective surface E1_3 facing toward the image side and being located in a central area of the object-side surface of the first lens element E1, and a second refractive surface E1_4 facing toward the image side and being located in a central area of the image-side surface of the first lens element E1. The second refractive surface E1_4 is convex in a paraxial region thereof. The first lens element E1 is made of plastic material and has the first refractive surface E1_1, the first reflective surface E1_2, the second reflective surface E1_3, and the second refractive surface E1_4 being all aspheric. Along a travelling sequence of the optical path, incident light enters the first lens element E1 through the first refractive surface E1_1, is subsequently reflected by the first reflective surface E1_2, further reflected by the second reflective surface E1_3, and finally exits the first lens element E1 through the second refractive surface E1_4. In this embodiment, the object-side surface of the first lens element E1 further has a light-blocking area AB1 located between the central area and the peripheral area thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The image-side surface of the second lens element E2 has one inflection point.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has four inflection points. The object-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has two inflection points.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has four inflection points. The object-side surface of the fifth lens element E5 has one critical point in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has two critical points in an off-axis region thereof.

The filter E7 is made of glass material and located between the sixth lens element E6 and the image surface IMG, and will not affect the focal length of the photography lens assembly. The image sensor IS is disposed on or near the image surface IMG of the photography lens assembly.

The detailed optical data of the 4th embodiment are shown in Table 4A and the aspheric surface data are shown in Table 4B below.

TABLE 4A
4th Embodiment
f = 14.54 mm, Fno = 2.15, HFOV = 11.6 deg.

| Surface | | Curvature | | | | | Abbe | Refractive/ | Focal |
|---|---|---|---|---|---|---|---|---|---|
| # | | Radius | | Thickness | Material | Index | # | Reflective | Length |
| 0 | Object | Infinity | | Infinity | | | | Refract | |
| 1 | Stop | Plano | | −0.850 | | | | Refract | |
| 2 | Lens 1 | 20.0758 | (ASP) | 3.760 | Plastic | 1.545 | 56.1 | Refract | — |
| | peripheral area | | | | | | | | |
| 3 | | −15.0027 | (ASP) | −3.138 | Plastic | 1.545 | 56.1 | Reflect | — |
| 4 | Lens 1 | −12.2732 | (ASP) | 3.138 | Plastic | 1.545 | 56.1 | Reflect | — |
| | central area | | | | | | | | |
| 5 | | −15.0027 | (ASP) | 0.160 | | | | Refract | |
| 6 | Ape. Stop | Plano | | −0.111 | | | | Refract | |
| 7 | Lens 2 | 18.8679 | (ASP) | 0.380 | Plastic | 1.587 | 28.3 | Refract | −5.96 |
| 8 | | 2.9308 | (ASP) | 0.411 | | | | Refract | |
| 9 | Stop | Plano | | 0.022 | | | | Refract | |
| 10 | Lens 3 | 8.9250 | (ASP) | 0.625 | Plastic | 1.669 | 19.5 | Refract | −23.34 |
| 11 | | 5.5198 | (ASP) | 0.170 | | | | Refract | |
| 12 | Stop | Plano | | 0.273 | | | | Refract | |
| 13 | Lens 4 | −73.1826 | (ASP) | 0.923 | Plastic | 1.551 | 44.8 | Refract | 62.53 |
| 14 | | −23.5234 | (ASP) | 0.046 | | | | Refract | |
| 15 | Lens 5 | −9.4683 | (ASP) | 0.596 | Plastic | 1.551 | 44.8 | Refract | 63.03 |
| 16 | | −7.6055 | (ASP) | 0.245 | | | | Refract | |
| 17 | Lens 6 | 8.5924 | (ASP) | 0.972 | Plastic | 1.584 | 28.2 | Refract | 10.47 |
| 18 | | −20.3159 | (ASP) | 0.600 | | | | Refract | |

| | | | | | | | | |
|---|---|---|---|---|---|---|---|---|
| 19 | Filter | Plano | 0.110 | Glass | 1.517 | 64.2 | Refract | — |
| 20 | | Plano | 0.270 | | | | Refract | |
| 21 | Image | Plano | — | | | | Refract | |

Note:
Reference wavelength is 587.6 nm (d-line).
An effective radius of the stop S1 (Surface 1) is 6.199 mm.
An effective radius of the stop S2 (Surface 9) is 1.228 mm.
An effective radius of the stop S3 (Surface 12) is 1.463 mm.

TABLE 4B
Aspheric Coefficients

| Surface # | 2 | 3 | 4 | 5 |
|---|---|---|---|---|
| k= | −2.62585E+00 | −1.02580E+00 | −8.00546E+00 | −1.02580E+00 |
| A4= | −3.4042361E−05 | 4.6430187E−05 | 3.8926899E−04 | 4.6430187E−05 |
| A6= | 3.3919936E−06 | 7.1645315E−07 | −2.3874183E−05 | 7.1645315E−07 |
| A8= | −2.7387383E−07 | −6.8389754E−08 | 9.8954495E−07 | −6.8389754E−08 |
| A10= | 1.0495652E−08 | 2.8289534E−09 | 1.6594107E−09 | 2.8289534E−09 |
| A12= | −2.2293869E−10 | −5.8855477E−11 | — | −5.8855477E−11 |
| A14= | 2.1056178E−12 | 5.0157559E−13 | — | 5.0157559E−13 |
| A16= | — | 2.4199551E−15 | — | 2.4199551E−15 |
| Surface # | 7 | 8 | 10 | 11 |
| k= | 0.00000E+00 | 0.00000E+00 | 0.00000E+00 | 0.00000E+00 |
| A4= | 2.3805432E−02 | 3.1914449E−02 | −3.5250119E−02 | −2.4808239E−02 |
| A6= | −1.0351526E−04 | 1.0364647E−02 | 3.0626960E−02 | −1.4585464E−02 |
| A8= | −1.0855223E−02 | −1.0079890E−01 | −1.0099196E−01 | 4.9456800E−02 |
| A10= | 1.4462591E−02 | 3.0979431E−01 | 2.0462216E−01 | −9.2246757E−02 |
| A12= | −1.0513432E−02 | −5.2711930E−01 | −2.7890460E−01 | 1.0578502E−01 |
| A14= | 4.8357270E−03 | 5.4270694E−01 | 2.5565886E−01 | −7.4982822E−02 |
| A16= | −1.4263250E−03 | −3.3507671E−01 | −1.5025275E−01 | 3.2451876E−02 |
| A18= | 2.4928642E−04 | 1.1445005E−01 | 5.1008637E−02 | −7.8630626E−03 |
| A20= | −1.9874390E−05 | −1.6711250E−02 | −7.6341391E−03 | 8.1439091E−04 |
| Surface # | 13 | 14 | 15 | 16 |
| k= | 0.00000E+00 | 0.00000E+00 | 0.00000E+00 | 0.00000E+00 |
| A4= | −4.0637866E−02 | −2.3281285E−01 | −1.7878733E−01 | 2.8952601E−02 |
| A6= | 4.3418978E−02 | 1.6022204E−01 | 1.4699860E−01 | 8.5615402E−03 |
| A8= | −7.8648950E−02 | −1.0064199E−01 | −8.1156903E−02 | −3.5333817E−02 |
| A10= | 9.3159594E−02 | 9.7335908E−02 | 4.3876505E−02 | 1.9729618E−02 |
| A12= | −7.4794635E−02 | −9.1483699E−02 | −1.8265584E−02 | −1.5265857E−03 |
| A14= | 3.9809840E−02 | 6.1914970E−02 | 4.2392238E−03 | −3.0489157E−03 |
| A16= | −1.3020365E−02 | −2.8800020E−02 | −4.9901089E−05 | 1.6417153E−03 |
| A18= | 2.3538170E−03 | 9.1547852E−03 | −2.8216460E−04 | −4.1343617E−04 |
| A20= | −1.8063882E−04 | −1.9546769E−03 | 8.7505277E−05 | 5.7929289E−05 |
| A22= | — | 2.6725520E−04 | −1.3013102E−05 | −4.3441148E−06 |
| A24= | — | −2.0985504E−05 | 1.0008820E−06 | 1.3619813E−07 |
| A26= | — | 7.1010119E−07 | −3.1935902E−08 | — |

| Surface # | 17 | 18 |
|---|---|---|
| k= | 0.00000E+00 | 0.00000E+00 |
| A4= | 6.1374362E−03 | −7.9400544E−03 |
| A6= | −8.0720142E−03 | −1.4422218E−03 |
| A8= | 6.4582051E−04 | 2.6707773E−03 |
| A10= | −3.8134831E−03 | −1.9049698E−03 |
| A12= | 3.9336627E−03 | −4.8840913E−04 |
| A14= | −1.8097172E−03 | 1.0310203E−03 |
| A16= | 4.8576144E−04 | −5.0416381E−04 |
| A18= | −8.0968699E−05 | 1.3078946E−04 |
| A20= | 8.2388932E−06 | −2.0253171E−05 |
| A22= | −4.6782301E−07 | 1.8792918E−06 |
| A24= | 1.1342568E−08 | −9.6600312E−08 |
| A26= | — | 2.1180380E−09 |

In the 4th embodiment, the equation of the aspheric surface profiles of the aforementioned lens elements is the same as the equation of the 1st embodiment. Also, the definitions of these parameters shown in Table 4C below are the same as those stated in the 1st embodiment, with corresponding values for the 4th embodiment; therefore, an explanation in this regard will not be provided again.

Moreover, these parameters can be calculated from Table 4A and Table 4B as the following values and satisfy the following conditions:

TABLE 4C
Values of Optical and Physical Parameters/Definitions

| | | | |
|---|---|---|---|
| f [mm] | 14.54 | CT1/ΣAT | 2.58 |
| Fno | 2.15 | T23/T45 | 9.41 |
| HFOV [deg.] | 11.6 | CT4/CT5 | 1.55 |
| DM2I/f | 0.61 | T56/CT6 | 0.25 |
| ImgH/f | 0.21 | V5 − V2 | 16.5 |
| CRA/HFOV | 1.67 | 0.5 × f/(\sqrt{YF1o² − YT1i²}) | 2.15 |
| f/ΣCT | 2.19 | YF1o [mm] | 5.12 |
| DM2R12/Dr7r12 | 2.82 | YT1o [mm] | 6.19 |
| \|f/f3\| + \|f/f4\| + \|f/f5\| | 1.09 | YT1i [mm] | 3.85 |
| \|f2/f4\| | 0.10 | YM1o [mm] | 5.77 |
| \|f5/f6\| | 6.02 | YM1i [mm] | 1.72 |
| \|R2/R12\| | 0.74 | YM2 [mm] | 2.88 |
| (R3 + R4)/(R3 − R4) | 1.37 | YT2 [mm] | 1.72 |
| \|R4/R5\| | 0.33 | YT1o/DM2R2 | 1.97 |
| \|R10/R11\| | 0.89 | YM2/YT2 | 1.67 |
| \|R11/R12\| | 0.42 | — | — |

### 5th Embodiment

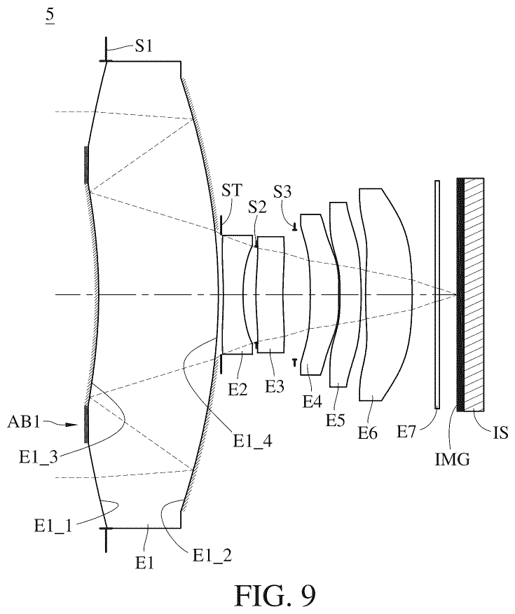

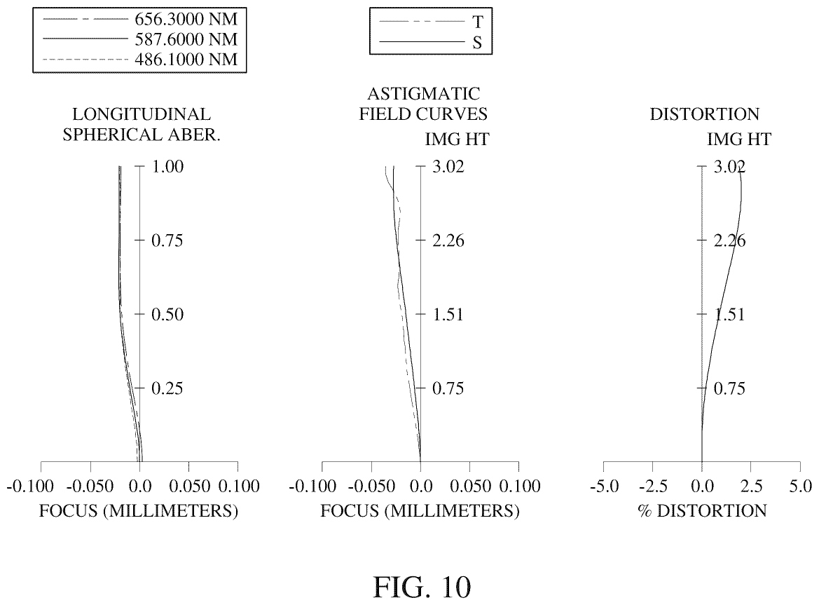

FIG. 9 is a schematic view of an image capturing unit according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit 5 includes the photography lens assembly (its reference numeral is omitted) of the present disclosure and an image sensor IS. The photography lens assembly includes, in order from an object side to an image side along an optical path, a stop S1, a first lens element E1, an aperture stop ST, a second lens element E2, a stop S2, a third lens element E3, a stop S3, a fourth lens element E4, a fifth lens element E5, a sixth lens element E6, a filter E7, and an image surface IMG. The photography lens assembly includes six lens elements (E1, E2, E3, E4, E5, and E6) with no additional lens element disposed between each of the adjacent six lens elements.

The first lens element E1 has a first refractive surface E1_1 facing toward the object side and being located in a peripheral area of an object-side surface (its reference numeral is omitted) of the first lens element E1, a first reflective surface E1_2 facing toward the object side and being located in a peripheral area of an image-side surface (its reference numeral is omitted) of the first lens element E1, a second reflective surface E1_3 facing toward the image side and being located in a central area of the object-side surface of the first lens element E1, and a second refractive surface E1_4 facing toward the image side and being located in a central area of the image-side surface of the first lens element E1. The second refractive surface E1_4 is convex in a paraxial region thereof. The first lens element E1 is made of plastic material and has the first refractive surface E1_1, the first reflective surface E1_2, the second reflective surface E1_3, and the second refractive surface E1_4 being all aspheric. Along a travelling sequence of the optical path, incident light enters the first lens element E1 through the first refractive surface E1_1, is subsequently reflected by the first reflective surface E1_2, further reflected by the second reflective surface E1_3, and finally exits the first lens element E1 through the second refractive surface E1_4. In this embodiment, the object-side surface of the first lens element E1 further has a light-blocking area AB1 located between the central area and the peripheral area thereof.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has two inflection points. The object-side surface of the third lens element E3 has one critical point in an off-axis region thereof. The image-side surface of the third lens element E3 has one critical point in an off-axis region thereof.

The fourth lens element E4 with negative refractive power has an object-side surface being concave in a paraxial region thereof and an image-side surface being concave in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has four inflection points. The image-side surface of the fourth lens element E4 has one critical point in an off-axis region thereof.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has three inflection points. The image-side surface of the fifth lens element E5 has one inflection point. The object-side surface of the fifth lens element E5 has one critical point in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has two inflection points. The object-side surface of the sixth lens element E6 has one critical point in an off-axis region thereof.

The filter E7 is made of glass material and located between the sixth lens element E6 and the image surface IMG, and will not affect the focal length of the photography lens assembly. The image sensor IS is disposed on or near the image surface IMG of the photography lens assembly.

The detailed optical data of the 5th embodiment are shown in Table 5A and the aspheric surface data are shown in Table 5B below.

TABLE 5A
5th Embodiment
f = 14.80 mm, Fno = 2.67, HFOV = 11.3 deg.

| Surface | | Curvature | | | | | Abbe | Refractive/ | Focal |
|---|---|---|---|---|---|---|---|---|---|
| # | | Radius | | Thickness | Material | Index | # | Reflective | Length |
| 0 | Object | Infinity | | Infinity | | | | Refract | |
| 1 | Stop | Plano | | −0.810 | | | | Refract | |
| 2 | Lens 1 | 20.7802 | (ASP) | 3.728 | Plastic | 1.534 | 56.0 | Refract | — |
| | peripheral area | | | | | | | | |
| 3 | | −15.4245 | (ASP) | −3.106 | Plastic | 1.534 | 56.0 | Reflect | — |
| 4 | Lens 1 | −13.2599 | (ASP) | 3.106 | Plastic | 1.534 | 56.0 | Reflect | — |
| | central area | | | | | | | | |
| 5 | | −15.4245 | (ASP) | 0.072 | | | | Refract | |
| 6 | Ape. Stop | Plano | | 0.059 | | | | Refract | |
| 7 | Lens 2 | −9.5167 | (ASP) | 0.511 | Plastic | 1.584 | 28.2 | Refract | −5.28 |
| 8 | | 4.6552 | (ASP) | 0.348 | | | | Refract | |
| 9 | Stop | Plano | | −0.014 | | | | Refract | |
| 10 | Lens 3 | 6.9063 | (ASP) | 0.702 | Plastic | 1.642 | 22.5 | Refract | 41.67 |
| 11 | | 8.9415 | (ASP) | 0.302 | | | | Refract | |
| 12 | Stop | Plano | | 0.406 | | | | Refract | |
| 13 | Lens 4 | −18.9285 | (ASP) | 0.738 | Plastic | 1.545 | 56.1 | Refract | −23.16 |
| 14 | | 38.4071 | (ASP) | 0.035 | | | | Refract | |
| 15 | Lens 5 | −20.3938 | (ASP) | 0.550 | Plastic | 1.545 | 56.1 | Refract | 18.12 |
| 16 | | −6.7167 | (ASP) | 0.115 | | | | Refract | |
| 17 | Lens 6 | 16.0814 | (ASP) | 1.208 | Plastic | 1.534 | 56.0 | Refract | 13.31 |
| 18 | | −12.4123 | (ASP) | 0.600 | | | | Refract | |

| | | | | | | | | |
|---|---|---|---|---|---|---|---|---|
| 19 | Filter | Plano | 0.110 | Glass | 1.517 | 64.2 | Refract | — |
| 20 | | Plano | 0.464 | | | | Refract | |
| 21 | Image | Plano | — | | | | Refract | |

Note:
Reference wavelength is 587.6 nm (d-line).
An effective radius of the stop S1 (Surface 1) is 6.065 mm.
An effective radius of the stop S2 (Surface 9) is 1.258 mm.
An effective radius of the stop S3 (Surface 12) is 1.680 mm.

TABLE 5B
Aspheric Coefficients

| Surface # | 2 | 3 | 4 | 5 |
|---|---|---|---|---|
| k= | −2.09417E+00 | −1.03699E+00 | −7.89862E+00 | −1.03699E+00 |
| A4= | −1.6470874E−06 | 5.5124924E−05 | 4.0678751E−04 | 5.5124924E−05 |
| A6= | 8.4469997E−07 | 1.6316528E−09 | −2.9476309E−05 | 1.6316528E−09 |
| A8= | −1.3953442E−07 | −4.0165281E−08 | 1.4585773E−06 | −4.0165281E−08 |
| A10= | 5.7677504E−09 | 1.9277736E−09 | −1.1467296E−08 | 1.9277736E−09 |
| A12= | −1.3301862E−10 | −4.1867633E−11 | — | −4.1867633E−11 |
| A14= | 1.4770525E−12 | 4.3136275E−13 | — | 4.3136275E−13 |
| A16= | — | 1.6522673E−15 | — | 1.6522673E−15 |
| Surface # | 7 | 8 | 10 | 11 |
| k= | 0.00000E+00 | 0.00000E+00 | 0.00000E+00 | 0.00000E+00 |
| A4= | 3.1397969E−02 | 2.6861607E−02 | −2.8586090E−02 | −2.5883132E−02 |
| A6= | −7.3427289E−03 | 2.5001261E−03 | −5.2384715E−03 | 6.7346933E−03 |
| A8= | −4.2762549E−04 | −1.9385840E−02 | 1.9663519E−02 | −1.5253952E−02 |
| A10= | 2.6717285E−03 | 4.2890202E−02 | −4.0664310E−02 | 1.9538466E−02 |
| A12= | −2.1598786E−03 | −5.9856905E−02 | 4.9594202E−02 | −1.5339141E−02 |
| A14= | 9.9703597E−04 | 5.2793049E−02 | −3.6750358E−02 | 7.8384646E−03 |
| A16= | −2.8509611E−04 | −2.8213304E−02 | 1.6493870E−02 | −2.3909251E−03 |
| A18= | 4.6887525E−05 | 8.3382417E−03 | −4.1052648E−03 | 3.8502076E−04 |
| A20= | −3.4057916E−06 | −1.0491616E−03 | 4.3118497E−04 | −2.4184210E−05 |
| Surface # | 13 | 14 | 15 | 16 |
| k= | 0.00000E+00 | 0.00000E+00 | 0.00000E+00 | 0.00000E+00 |
| A4= | −2.9425443E−02 | −2.2937807E−01 | −1.8064035E−01 | 4.6111829E−02 |
| A6= | 9.1949621E−03 | 1.3125032E−01 | 1.2558947E−01 | 1.1327205E−05 |
| A8= | −3.6853185E−03 | −2.4739414E−02 | −2.8594190E−02 | −6.7765134E−02 |
| A10= | −5.3649955E−03 | −4.3615819E−03 | −2.3648312E−02 | 7.5297564E−02 |
| A12= | 6.9697616E−03 | −7.5329831E−03 | 3.5017578E−02 | −4.4204150E−02 |
| A14= | −3.4241628E−03 | 1.6351044E−02 | −2.3383746E−02 | 1.6440978E−02 |
| A16= | 9.4173544E−04 | −1.2087583E−02 | 9.6391467E−03 | −4.0281391E−03 |
| A18= | −1.4849359E−04 | 4.9839444E−03 | −2.6022129E−03 | 6.4615644E−04 |
| A20= | 1.0466316E−05 | −1.2597009E−03 | 4.6234581E−04 | −6.5155805E−05 |
| A22= | — | 1.9493468E−04 | −5.2198990E−05 | 3.7409427E−06 |
| A24= | — | −1.7050546E−05 | 3.3974800E−06 | −9.3181221E−08 |
| A26= | — | 6.4869498E−07 | −9.7050692E−08 | — |

| Surface # | 17 | 18 |
|---|---|---|
| k= | 0.00000E+00 | 0.00000E+00 |
| A4= | 2.4900040E−02 | −1.0366074E−02 |
| A6= | −2.8548023E−02 | 3.1136900E−03 |
| A8= | −7.8926133E−03 | −5.9761997E−03 |
| A10= | 1.9349948E−02 | 5.0431572E−03 |
| A12= | −1.2372257E−02 | −2.7914315E−03 |
| A14= | 4.5632469E−03 | 1.0950339E−03 |
| A16= | −1.0740887E−03 | −3.0455475E−04 |
| A18= | 1.6318809E−04 | 5.9101617E−05 |
| A20= | −1.5486226E−05 | −7.7781698E−06 |
| A22= | 8.3494806E−07 | 6.5931145E−07 |
| A24= | −1.9530387E−08 | −3.2402602E−08 |
| A26= | — | 7.0060926E−10 |

In the 5th embodiment, the equation of the aspheric surface profiles of the aforementioned lens elements is the same as the equation of the 1st embodiment. Also, the definitions of these parameters shown in Table 5C below are the same as those stated in the 1st embodiment, with corresponding values for the 5th embodiment; therefore, an explanation in this regard will not be provided again.

Moreover, these parameters can be calculated from Table 5A and Table 5B as the following values and satisfy the following conditions:

TABLE 5C
Values of Optical and Physical Parameters/Definitions

| | | | |
|---|---|---|---|
| f [mm] | 14.80 | CT1/ΣAT | 2.35 |
| Fno | 2.67 | T23/T45 | 9.54 |
| HFOV [deg.] | 11.3 | CT4/CT5 | 1.34 |
| DM2I/f | 0.63 | T56/CT6 | 0.10 |
| ImgH/f | 0.20 | V5 − V2 | 27.9 |
| CRA/HFOV | 1.56 | 0.5 × f/(\sqrt{YF1o² − YT1i²}) | 2.67 |
| f/ΣCT | 2.17 | YF1o [mm] | 4.74 |
| DM2R12/Dr7r12 | 3.08 | YT1o [mm] | 6.06 |
| \|f/f3\| + \|f/f4\| + \|f/f5\| | 1.81 | YT1i [mm] | 3.85 |
| \|f2/f4\| | 0.23 | YM1o [mm] | 5.62 |
| \|f5/f6\| | 1.36 | YM1i [mm] | 1.69 |
| \|R2/R12\| | 1.24 | YM2 [mm] | 2.88 |
| (R3 + R4)/(R3 − R4) | 0.34 | YT2 [mm] | 1.69 |
| \|R4/R5\| | 0.67 | YT1o/DM2R2 | 1.95 |
| \|R10/R11\| | 0.42 | YM2/YT2 | 1.71 |
| \|R11/R12\| | 1.30 | — | — |

### 6th Embodiment

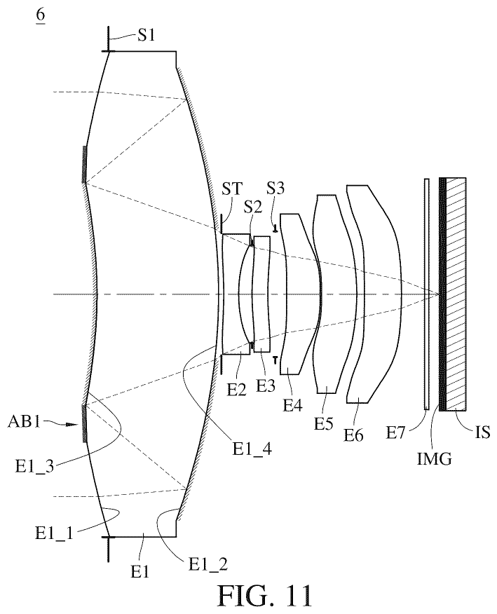

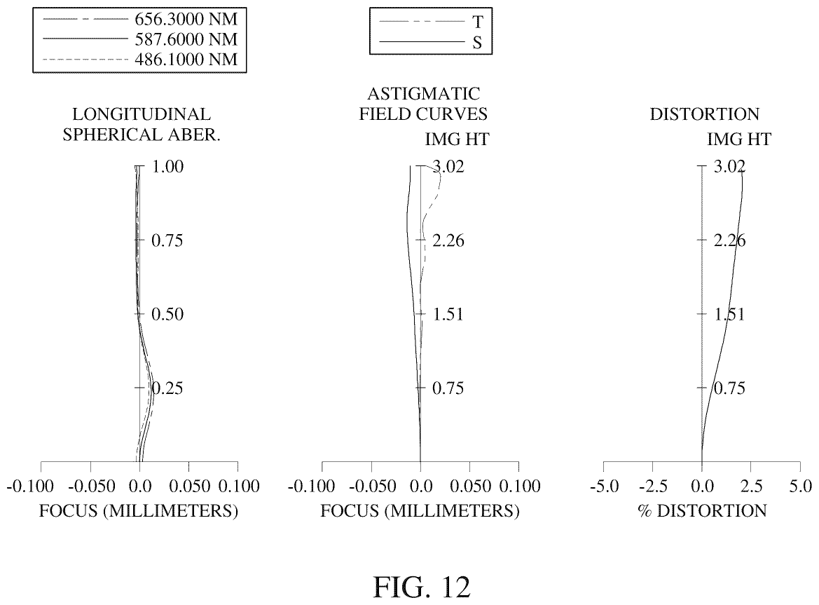

FIG. 11 is a schematic view of an image capturing unit according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit 6 includes the photography lens assembly (its reference numeral is omitted) of the present disclosure and an image sensor IS. The photography lens assembly includes, in order from an object side to an image side along an optical path, a stop S1, a first lens element E1, an aperture stop ST, a second lens element E2, a stop S2, a third lens element E3, a stop S3, a fourth lens element E4, a fifth lens element E5, a sixth lens element E6, a filter E7, and an image surface IMG. The photography lens assembly includes six lens elements (E1, E2, E3, E4, E5, and E6) with no additional lens element disposed between each of the adjacent six lens elements.

The first lens element E1 has a first refractive surface E1_1 facing toward the object side and being located in a peripheral area of an object-side surface (its reference numeral is omitted) of the first lens element E1, a first reflective surface E1_2 facing toward the object side and being located in a peripheral area of an image-side surface (its reference numeral is omitted) of the first lens element E1, a second reflective surface E1_3 facing toward the image side and being located in a central area of the object-side surface of the first lens element E1, and a second refractive surface E1_4 facing toward the image side and being located in a central area of the image-side surface of the first lens element E1. The second refractive surface E1_4 is convex in a paraxial region thereof. The first lens element E1 is made of plastic material and has the first refractive surface E1_1, the first reflective surface E1_2, the second reflective surface E1_3, and the second refractive surface E1_4 being all aspheric. Along a travelling sequence of the optical path, incident light enters the first lens element E1 through the first refractive surface E1_1, is subsequently reflected by the first reflective surface E1_2, further reflected by the second reflective surface E1_3, and finally exits the first lens element E1 through the second refractive surface E1_4. In this embodiment, the object-side surface of the first lens element E1 further has a light-blocking area AB1 located between the central area and the peripheral area thereof.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one critical point in an off-axis region thereof. The image-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of glass material and has the object-side surface and the image-side surface being both aspheric. The object-side surface of the fourth lens element E4 has one inflection point. The image-side surface of the fourth lens element E4 has two inflection points.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has three inflection points. The object-side surface of the fifth lens element E5 has one critical point in an off-axis region thereof.

The sixth lens element E6 with positive refractive power has an object-side surface being concave in a paraxial region thereof and an image-side surface being convex in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has two inflection points.

The filter E7 is made of glass material and located between the sixth lens element E6 and the image surface IMG, and will not affect the focal length of the photography lens assembly. The image sensor IS is disposed on or near the image surface IMG of the photography lens assembly.

The detailed optical data of the 6th embodiment are shown in Table 6A and the aspheric surface data are shown in Table 6B below.

TABLE 6A
6th Embodiment
f = 14.59 mm, Fno = 2.04, HFOV = 11.5 deg.

| Surface | | Curvature | | | | | Abbe | Refractive/ | Focal |
|---|---|---|---|---|---|---|---|---|---|
| # | | Radius | | Thickness | Material | Index | # | Reflective | Length |
| 0 | Object | Infinity | | Infinity | | | | Refract | |
| 1 | Stop | Plano | | −0.920 | | | | Refract | |
| 2 | Lens 1 | 20.1989 | (ASP) | 3.777 | Plastic | 1.534 | 56.0 | Refract | — |
| | peripheral area | | | | | | | | |
| 3 | | −14.9194 | (ASP) | −3.155 | Plastic | 1.534 | 56.0 | Reflect | — |
| 4 | Lens 1 | −12.1731 | (ASP) | 3.155 | Plastic | 1.534 | 56.0 | Reflect | — |
| | central area | | | | | | | | |
| 5 | | −14.9194 | (ASP) | 0.071 | | | | Refract | |
| 6 | Ape. Stop | Plano | | 0.064 | | | | Refract | |
| 7 | Lens 2 | −8.8952 | (ASP) | 0.388 | Plastic | 1.584 | 28.2 | Refract | −4.61 |
| 8 | | 3.9279 | (ASP) | 0.346 | | | | Refract | |
| 9 | Stop | Plano | | 0.000 | | | | Refract | |
| 10 | Lens 3 | 6.2067 | (ASP) | 0.409 | Plastic | 1.657 | 21.3 | Refract | 50.79 |
| 11 | | 7.4265 | (ASP) | 0.193 | | | | Refract | |
| 12 | Stop | Plano | | 0.297 | | | | Refract | |
| 13 | Lens 4 | −216.4306 | (ASP) | 0.868 | Glass | 1.548 | 45.8 | Refract | 58.32 |
| 14 | | −27.8920 | (ASP) | 0.035 | | | | Refract | |
| 15 | Lens 5 | −19.9734 | (ASP) | 0.916 | Plastic | 1.544 | 56.0 | Refract | 11.99 |
| 16 | | −4.9954 | (ASP) | 0.199 | | | | Refract | |
| 17 | Lens 6 | −17.5439 | (ASP) | 0.960 | Plastic | 1.562 | 44.6 | Refract | 51.40 |
| 18 | | −11.1286 | (ASP) | 0.600 | | | | Refract | |

| | | | | | | | | |
|---|---|---|---|---|---|---|---|---|
| 19 | Filter | Plano | 0.110 | Glass | 1.517 | 64.2 | Refract | — |
| 20 | | Plano | 0.275 | | | | Refract | |
| 21 | Image | Plano | — | | | | Refract | |

Note:
Reference wavelength is 587.6 nm (d-line).
An effective radius of the stop S1 (Surface 1) is 6.306 mm.
An effective radius of the stop S2 (Surface 9) is 1.269 mm.
An effective radius of the stop S3 (Surface 12) is 1.630 mm.

TABLE 6B
Aspheric Coefficients

| Surface # | 2 | 3 | 4 | 5 |
|---|---|---|---|---|
| k= | −2.00734E+00 | −9.81898E−01 | −8.23209E+00 | −9.81898E−01 |
| A4= | −3.7050405E−05 | 4.4031017E−05 | 4.2558436E−04 | 4.4031017E−05 |
| A6= | 1.5814391E−06 | 4.5420979E−07 | −2.8953915E−05 | 4.5420979E−07 |
| A8= | −8.5980873E−08 | −3.8518893E−08 | 1.3532830E−06 | −3.8518893E−08 |
| A10= | 2.5492424E−09 | 1.5574268E−09 | −3.4300449E−08 | 1.5574268E−09 |
| A12= | −3.2710886E−11 | −3.0908899E−11 | — | −3.0908899E−11 |
| A14= | 2.5562934E−13 | 3.7211419E−13 | — | 3.7211419E−13 |
| A16= | — | −1.8028374E−15 | — | −1.8028374E−15 |
| Surface # | 7 | 8 | 10 | 11 |
| k= | 0.00000E+00 | 0.00000E+00 | 0.00000E+00 | 0.00000E+00 |
| A4= | 2.7682902E−02 | 3.3270500E−02 | −3.3731035E−02 | −2.3535696E−02 |
| A6= | −2.4789846E−03 | −4.8290973E−02 | 2.0710651E−02 | 1.7833884E−02 |
| A8= | −5.6708144E−03 | 1.5183823E−01 | −3.2604678E−02 | −3.6388633E−02 |
| A10= | 6.1798129E−03 | −2.8583926E−01 | 2.1544475E−02 | 4.6426906E−02 |
| A12= | −2.7313348E−03 | 3.3697465E−01 | 2.3007398E−03 | −4.1090687E−02 |
| A14= | 2.9536733E−04 | −2.5131062E−01 | −1.5498566E−02 | 2.4649574E−02 |
| A16= | 2.0856236E−04 | 1.1573745E−01 | 1.1620416E−02 | −9.4433092E−03 |
| A18= | −8.2231517E−05 | −3.0140561E−02 | −3.9096835E−03 | 2.0724535E−03 |
| A20= | 9.1878225E−06 | 3.4116174E−03 | 5.2839118E−04 | −1.9690824E−04 |
| Surface # | 13 | 14 | 15 | 16 |
| k= | 0.00000E+00 | 0.00000E+00 | 0.00000E+00 | 0.00000E+00 |
| A4= | −3.2771525E−02 | −2.3816503E−01 | −2.0222596E−01 | 3.0166429E−02 |
| A6= | 1.4939888E−02 | 2.2918503E−01 | 2.1863516E−01 | 4.0012691E−03 |
| A8= | −1.5967923E−02 | −2.2167743E−01 | −1.9563675E−01 | −3.2797740E−02 |
| A10= | 6.9257945E−03 | 2.0506864E−01 | 1.5390055E−01 | 2.5654398E−02 |
| A12= | 2.5286436E−04 | −1.4778218E−01 | −8.6882663E−02 | −1.0153684E−02 |
| A14= | −7.0641657E−04 | 7.8694815E−02 | 3.3514506E−02 | 2.3089026E−03 |
| A16= | 5.2402262E−05 | −3.0418383E−02 | −8.8825445E−03 | −2.7202045E−04 |
| A18= | 3.5229616E−05 | 8.3416209E−03 | 1.6220106E−03 | 4.7309615E−06 |
| A20= | −5.5221264E−06 | −1.5682435E−03 | −2.0100947E−04 | 2.7625438E−06 |
| A22= | — | 1.9101562E−04 | 1.6174336E−05 | −3.1073164E−07 |
| A24= | — | −1.3511469E−05 | −7.6336363E−07 | 1.0787113E−08 |
| A26= | — | 4.1950232E−07 | 1.6054162E−08 | — |

| Surface # | 17 | 18 |
|---|---|---|
| k= | 0.00000E+00 | 0.00000E+00 |
| A4= | 2.4732447E−02 | 4.1980809E−04 |
| A6= | −1.0097664E−02 | −2.7810564E−03 |
| A8= | −1.4489550E−02 | −2.9921350E−03 |
| A10= | 1.1934729E−02 | 2.4107314E−03 |
| A12= | −4.1533973E−03 | −1.1604047E−03 |
| A14= | 7.3889330E−04 | 4.5586754E−04 |
| A16= | −3.5781181E−05 | −1.3603152E−04 |
| A18= | −1.1411111E−05 | 2.8220811E−05 |
| A20= | 2.4074551E−06 | −3.8593712E−06 |
| A22= | −1.8909709E−07 | 3.2983260E−07 |
| A24= | 5.5591275E−09 | −1.5934545E−08 |
| A26= | — | 3.3205177E−10 |

In the 6th embodiment, the equation of the aspheric surface profiles of the aforementioned lens elements is the same as the equation of the 1st embodiment. Also, the definitions of these parameters shown in Table 6C below are the same as those stated in the 1st embodiment, with corresponding values for the 6th embodiment; therefore, an explanation in this regard will not be provided again.

Moreover, these parameters can be calculated from Table 6A and Table 6B as the following values and satisfy the following conditions:

TABLE 6C
Values of Optical and Physical Parameters/Definitions

| | | | |
|---|---|---|---|
| f [mm] | 14.59 | CT1/ΣAT | 2.62 |
| Fno | 2.04 | T23/T45 | 9.89 |
| HFOV [deg.] | 11.5 | CT4/CT5 | 0.95 |
| DM2I/f | 0.61 | T56/CT6 | 0.21 |
| ImgH/f | 0.21 | V5 − V2 | 27.8 |
| CRA/HFOV | 1.46 | 0.5 × f/(\sqrt{YF1o² − YT1i²}) | 2.04 |
| f/ΣCT | 2.18 | YF1o [mm] | 5.25 |
| DM2R12/Dr7r12 | 2.65 | YT1o [mm] | 6.30 |
| \|f/f3\| + \|f/f4\| + \|f/f5\| | 1.75 | YT1i [mm] | 3.85 |
| \|f2/f4\| | 0.08 | YM1o [mm] | 5.88 |
| \|f5/f6\| | 0.23 | YM1i [mm] | 1.71 |
| \|R2/R12\| | 1.34 | YM2 [mm] | 2.88 |
| (R3 + R4)/(R3 − R4) | 0.39 | YT2 [mm] | 1.71 |
| \|R4/R5\| | 0.63 | YT1o/DM2R2 | 2.00 |
| \|R10/R11\| | 0.28 | YM2/YT2 | 1.69 |
| \|R11/R12\| | 1.58 | — | — |

### 7th Embodiment

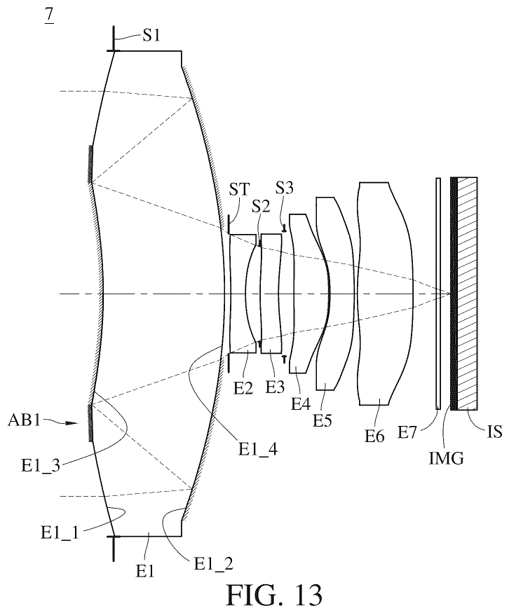

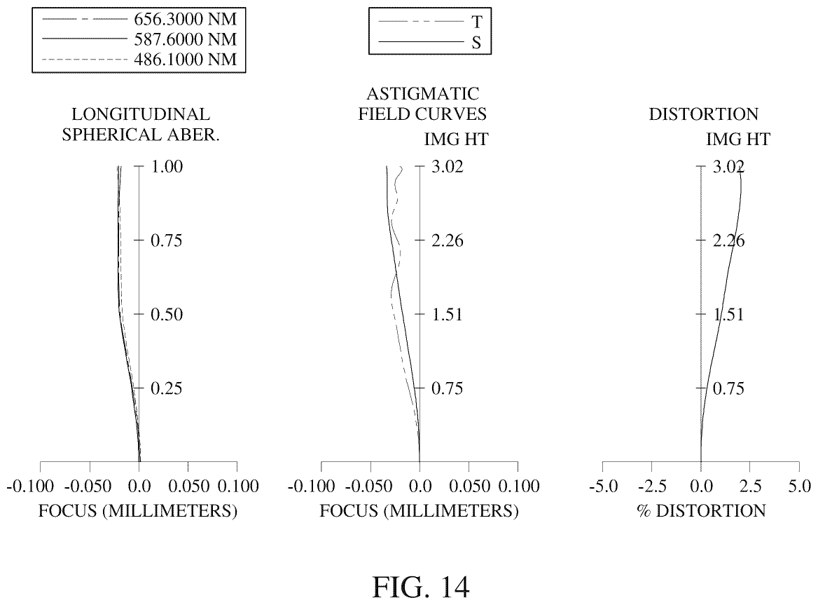

FIG. 13 is a schematic view of an image capturing unit according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit 7 includes the photography lens assembly (its reference numeral is omitted) of the present disclosure and an image sensor IS. The photography lens assembly includes, in order from an object side to an image side along an optical path, a stop S1, a first lens element E1, an aperture stop ST, a second lens element E2, a stop S2, a third lens element E3, a stop S3, a fourth lens element E4, a fifth lens element E5, a sixth lens element E6, a filter E7, and an image surface IMG. The photography lens assembly includes six lens elements (E1, E2, E3, E4, E5, and E6) with no additional lens element disposed between each of the adjacent six lens elements.

The first lens element E1 has a first refractive surface E1_1 facing toward the object side and being located in a peripheral area of an object-side surface (its reference numeral is omitted) of the first lens element E1, a first reflective surface E1_2 facing toward the object side and being located in a peripheral area of an image-side surface (its reference numeral is omitted) of the first lens element E1, a second reflective surface E1_3 facing toward the image side and being located in a central area of the object-side surface of the first lens element E1, and a second refractive surface E1_4 facing toward the image side and being located in a central area of the image-side surface of the first lens element E1. The second refractive surface E1_4 is convex in a paraxial region thereof. The first lens element E1 is made of plastic material and has the first refractive surface E1_1, the first reflective surface E1_2, the second reflective surface E1_3, and the second refractive surface E1_4 being all aspheric. Along a travelling sequence of the optical path, incident light enters the first lens element E1 through the first refractive surface E1_1, is subsequently reflected by the first reflective surface E1_2, further reflected by the second reflective surface E1_3, and finally exits the first lens element E1 through the second refractive surface E1_4. In this embodiment, the object-side surface of the first lens element E1 further has a light-blocking area AB1 located between the central area and the peripheral area thereof.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one critical point in an off-axis region thereof. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has four inflection points. The object-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has three inflection points. The image-side surface of the fifth lens element E5 has one inflection point. The object-side surface of the fifth lens element E5 has three critical points in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has two critical points in an off-axis region thereof.

The filter E7 is made of glass material and located between the sixth lens element E6 and the image surface IMG, and will not affect the focal length of the photography lens assembly. The image sensor IS is disposed on or near the image surface IMG of the photography lens assembly.

The detailed optical data of the 7th embodiment are shown in Table 7A and the aspheric surface data are shown in Table 7B below.

TABLE 7A
7th Embodiment
f = 14.67 mm, Fno = 2.05, HFOV = 11.4 deg.

| Surface | | Curvature | | | | | Abbe | Refractive/ | Focal |
|---|---|---|---|---|---|---|---|---|---|
| # | | Radius | | Thickness | Material | Index | # | Reflective | Length |
| 0 | Object | Infinity | | Infinity | | | | Refract | |
| 1 | Stop | Plano | | −0.890 | | | | Refract | |
| 2 | Lens 1 | 20.6578 | (ASP) | 3.770 | Plastic | 1.534 | 56.0 | Refract | — |
| | peripheral area | | | | | | | | |
| 3 | | −14.8154 | (ASP) | −3.148 | Plastic | 1.534 | 56.0 | Reflect | — |
| 4 | Lens 1 | −12.0067 | (ASP) | 3.148 | Plastic | 1.534 | 56.0 | Reflect | — |
| | central area | | | | | | | | |
| 5 | | −14.8154 | (ASP) | 0.106 | | | | Refract | |
| 6 | Ape. Stop | Plano | | 0.058 | | | | Refract | |
| 7 | Lens 2 | −9.9732 | (ASP) | 0.380 | Plastic | 1.584 | 28.2 | Refract | −4.97 |
| 8 | | 4.1595 | (ASP) | 0.373 | | | | Refract | |
| 9 | Stop | Plano | | 0.006 | | | | Refract | |
| 10 | Lens 3 | 7.8513 | (ASP) | 0.477 | Plastic | 1.616 | 25.3 | Refract | −41.04 |
| 11 | | 5.8511 | (ASP) | 0.148 | | | | Refract | |
| 12 | Stop | Plano | | 0.252 | | | | Refract | |
| 13 | Lens 4 | 21.4169 | (ASP) | 0.899 | Plastic | 1.566 | 37.4 | Refract | 16.69 |
| 14 | | −16.6531 | (ASP) | 0.035 | | | | Refract | |
| 15 | Lens 5 | −7.0110 | (ASP) | 0.633 | Plastic | 1.551 | 44.8 | Refract | −62.18 |
| 16 | | −9.0986 | (ASP) | 0.081 | | | | Refract | |
| 17 | Lens 6 | 7.8573 | (ASP) | 1.443 | Plastic | 1.544 | 56.0 | Refract | 10.56 |
| 18 | | −20.0120 | (ASP) | 0.600 | | | | Refract | |

| | | | | | | | | |
|---|---|---|---|---|---|---|---|---|
| 19 | Filter | Plano | 0.110 | Glass | 1.517 | 64.2 | Refract | — |
| 20 | | Plano | 0.269 | | | | Refract | |
| 21 | Image | Plano | — | | | | Refract | |

Note:
Reference wavelength is 587.6 nm (d-line).
An effective radius of the stop S1 (Surface 1) is 6.307 mm.
An effective radius of the stop S2 (Surface 9) is 1.251 mm.
An effective radius of the stop S3 (Surface 12) is 1.625 mm.

TABLE 7B
Aspheric Coefficients

| Surface # | 2 | 3 | 4 | 5 |
|---|---|---|---|---|
| k= | −1.93428E+00 | −9.78094E−01 | −7.96160E+00 | −9.78094E−01 |
| A4= | −2.6353050E−05 | 4.7268876E−05 | 3.9827655E−04 | 4.7268876E−05 |
| A6= | 1.8159292E−06 | 3.2778010E−07 | −2.5098258E−05 | 3.2778010E−07 |
| A8= | −1.0643380E−07 | −2.8892553E−08 | 1.0424635E−06 | −2.8892553E−08 |
| A10= | 3.1219325E−09 | 9.4226040E−10 | −1.8536264E−08 | 9.4226040E−10 |
| A12= | −5.0327662E−11 | −1.4647938E−11 | — | −1.4647938E−11 |
| A14= | 4.0383076E−13 | 1.0771215E−13 | — | 1.0771215E−13 |
| A16= | — | 2.1345393E−16 | — | 2.1345393E−16 |
| Surface # | 7 | 8 | 10 | 11 |
| k= | 0.00000E+00 | 0.00000E+00 | 0.00000E+00 | 0.00000E+00 |
| A4= | 3.1540741E−02 | 3.5449599E−02 | −2.5567310E−02 | −3.2831222E−02 |
| A6= | −2.8765820E−03 | −2.1552680E−03 | −2.0429200E−02 | 2.6429559E−02 |
| A8= | −1.5857858E−02 | −2.4655597E−02 | 7.9614459E−02 | −4.2148683E−02 |
| A10= | 2.2974330E−02 | 6.7009351E−02 | −1.6377981E−01 | 4.7868438E−02 |
| A12= | −1.7423298E−02 | −1.0253971E−01 | 1.9844308E−01 | −3.8307589E−02 |
| A14= | 8.0937920E−03 | 9.7258153E−02 | −1.4805084E−01 | 2.0437520E−02 |
| A16= | −2.3033961E−03 | −5.5991355E−02 | 6.6233482E−02 | −6.8666652E−03 |
| A18= | 3.6973752E−04 | 1.7889097E−02 | −1.6138988E−02 | 1.3173697E−03 |
| A20= | −2.5722185E−05 | −2.4463814E−03 | 1.6079638E−03 | −1.1009699E−04 |
| Surface # | 13 | 14 | 15 | 16 |
| k= | 0.00000E+00 | 0.00000E+00 | 0.00000E+00 | 0.00000E+00 |
| A4= | −3.3465409E−02 | −2.3727865E−01 | −1.9130941E−01 | 4.2271542E−02 |
| A6= | 1.9878051E−02 | 1.5777653E−01 | 1.6300761E−01 | −9.7328523E−03 |
| A8= | −2.0010227E−02 | −2.5032294E−02 | −4.5355050E−02 | −4.0071200E−02 |
| A10= | 1.5392045E−02 | −4.5406470E−02 | −3.7169103E−02 | 4.1901384E−02 |
| A12= | −1.0041698E−02 | 4.5411394E−02 | 5.1121498E−02 | −2.1795953E−02 |
| A14= | 4.7899357E−03 | −2.1951424E−02 | −2.9450070E−02 | 7.1381808E−03 |
| A16= | −1.4167613E−03 | 6.5580621E−03 | 1.0256712E−02 | −1.5508050E−03 |
| A18= | 2.3113065E−04 | −1.2778967E−03 | −2.3298091E−03 | 2.2364972E−04 |
| A20= | −1.5962161E−05 | 1.6239441E−04 | 3.4861007E−04 | −2.0669882E−05 |
| A22= | — | −1.3141876E−05 | −3.3236048E−05 | 1.1138176E−06 |
| A24= | — | 6.6316197E−07 | 1.8343041E−06 | −2.6726983E−08 |
| A26= | — | −1.9124232E−08 | −4.4691511E−08 | — |

| Surface # | 17 | 18 |
|---|---|---|
| k= | 0.00000E+00 | 0.00000E+00 |
| A4= | 1.9510134E−02 | −6.9450926E−03 |
| A6= | −3.2290378E−02 | −6.5087399E−04 |
| A8= | 8.2675057E−03 | 4.7991238E−04 |
| A10= | 1.0975465E−03 | −1.0642410E−03 |
| A12= | −1.3343523E−03 | 6.5776976E−04 |
| A14= | 4.6316283E−04 | −1.9686718E−04 |
| A16= | −9.4928269E−05 | 3.2354167E−05 |
| A18= | 1.2296338E−05 | −2.6443269E−06 |
| A20= | −9.8193699E−07 | 1.7562887E−08 |
| A22= | 4.4061851E−08 | 1.5422687E−08 |
| A24= | −8.5023728E−10 | −1.1868223E−09 |
| A26= | — | 2.9124807E−11 |

In the 7th embodiment, the equation of the aspheric surface profiles of the aforementioned lens elements is the same as the equation of the 1st embodiment. Also, the definitions of these parameters shown in Table 7C below are the same as those stated in the 1st embodiment, with corresponding values for the 7th embodiment; therefore, an explanation in this regard will not be provided again.

Moreover, these parameters can be calculated from Table 7A and Table 7B as the following values and satisfy the following conditions:

TABLE 7C
Values of Optical and Physical Parameters/Definitions

| | | | |
|---|---|---|---|
| f [mm] | 14.67 | CT1/ΣAT | 2.97 |
| Fno | 2.05 | T23/T45 | 10.83 |
| HFOV [deg.] | 11.4 | CT4/CT5 | 1.42 |
| DM2I/f | 0.61 | T56/CT6 | 0.06 |
| ImgH/f | 0.21 | V5 − V2 | 16.6 |
| CRA/HFOV | 1.32 | 0.5 × f/(\sqrt{YF1o² − YT1i²}) | 2.05 |
| f/ΣCT | 2.10 | YF1o [mm] | 5.26 |
| DM2R12/Dr7r12 | 2.60 | YT1o [mm] | 6.30 |
| \|f/f3\| + \|f/f4\| + \|f/f5\| | 1.47 | YT1i [mm] | 3.85 |
| \|f2/f4\| | 0.30 | YM1o [mm] | 5.90 |
| \|f5/f6\| | 5.89 | YM1i [mm] | 1.71 |
| \|R2/R12\| | 0.74 | YM2 [mm] | 2.88 |
| (R3 + R4)/(R3 − R4) | 0.41 | YT2 [mm] | 1.71 |
| \|R4/R5\| | 0.53 | YT1o/DM2R2 | 2.00 |
| \|R10/R11\| | 1.16 | YM2/YT2 | 1.68 |
| \|R11/R12\| | 0.39 | — | — |

### 8th Embodiment

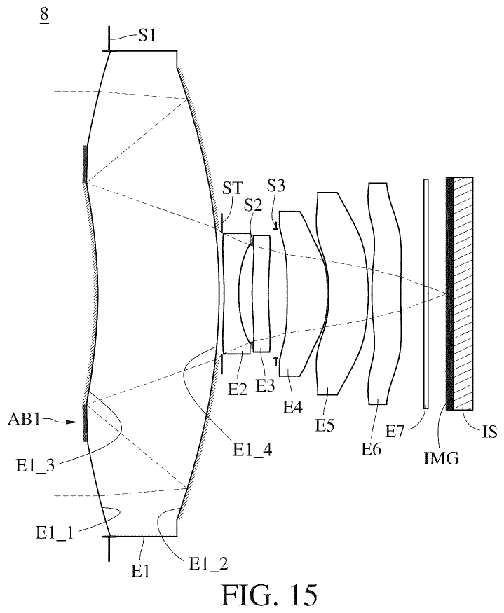

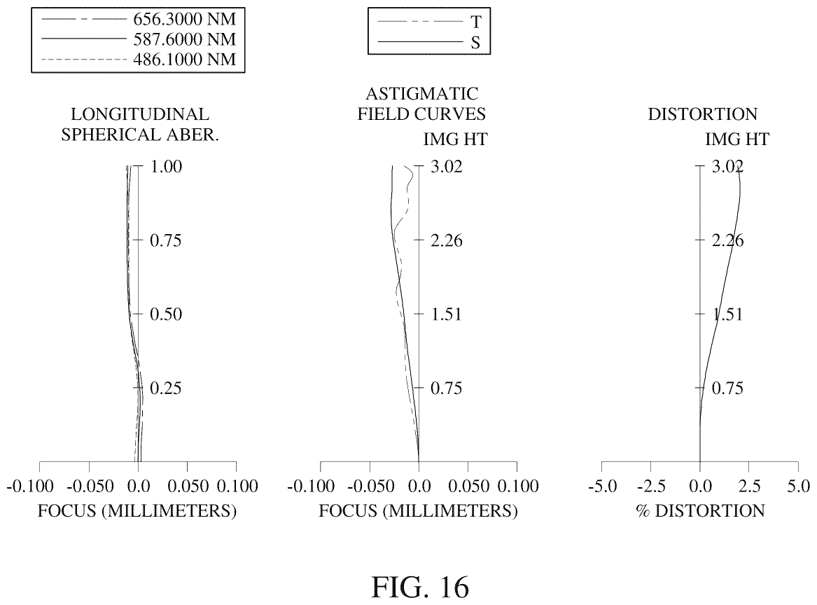

FIG. 15 is a schematic view of an image capturing unit according to the 8th embodiment of the present disclosure. FIG. 16 shows, in order from left to right, spherical aberration curves, astigmatic field curves and a distortion curve of the image capturing unit according to the 8th embodiment. In FIG. 15, the image capturing unit 8 includes the photography lens assembly (its reference numeral is omitted) of the present disclosure and an image sensor IS. The photography lens assembly includes, in order from an object side to an image side along an optical path, a stop S1, a first lens element E1, an aperture stop ST, a second lens element E2, a stop S2, a third lens element E3, a stop S3, a fourth lens element E4, a fifth lens element E5, a sixth lens element E6, a filter E7, and an image surface IMG. The photography lens assembly includes six lens elements (E1, E2, E3, E4, E5, and E6) with no additional lens element disposed between each of the adjacent six lens elements.

The first lens element E1 has a first refractive surface E1_1 facing toward the object side and being located in a peripheral area of an object-side surface (its reference numeral is omitted) of the first lens element E1, a first reflective surface E1_2 facing toward the object side and being located in a peripheral area of an image-side surface (its reference numeral is omitted) of the first lens element E1, a second reflective surface E1_3 facing toward the image side and being located in a central area of the object-side surface of the first lens element E1, and a second refractive surface E1_4 facing toward the image side and being located in a central area of the image-side surface of the first lens element E1. The second refractive surface E1_4 is convex in a paraxial region thereof. The first lens element E1 is made of plastic material and has the first refractive surface E1_1, the first reflective surface E1_2, the second reflective surface E1_3, and the second refractive surface E1_4 being all aspheric. Along a travelling sequence of the optical path, incident light enters the first lens element E1 through the first refractive surface E1_1, is subsequently reflected by the first reflective surface E1_2, further reflected by the second reflective surface E1_3, and finally exits the first lens element E1 through the second refractive surface E1_4. In this embodiment, the object-side surface of the first lens element E1 further has a light-blocking area AB1 located between the central area and the peripheral area thereof.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one critical point in an off-axis region thereof. The image-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of glass material and has the object-side surface and the image-side surface being both aspheric. The object-side surface of the fourth lens element E4 has one inflection point. The image-side surface of the fourth lens element E4 has two inflection points.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has four inflection points. The object-side surface of the fifth lens element E5 has one critical point in an off-axis region thereof.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has two inflection points. The object-side surface of the sixth lens element E6 has two critical points in an off-axis region thereof. The image-side surface of the sixth lens element E6 has one critical point in an off-axis region thereof.

The filter E7 is made of glass material and located between the sixth lens element E6 and the image surface IMG, and will not affect the focal length of the photography lens assembly. The image sensor IS is disposed on or near the image surface IMG of the photography lens assembly.

The detailed optical data of the 8th embodiment are shown in Table 8A and the aspheric surface data are shown in Table 8B below.

TABLE 8A
8th Embodiment
f = 14.58 mm, Fno = 2.04, HFOV = 11.5 deg.

| Surface | | Curvature | | | | | Abbe | Refractive/ | Focal |
|---|---|---|---|---|---|---|---|---|---|
| # | | Radius | | Thickness | Material | Index | # | Reflective | Length |
| 0 | Object | Infinity | | Infinity | | | | Refract | |
| 1 | Stop | Plano | | −0.920 | | | | Refract | |
| 2 | Lens 1 | 20.2717 | (ASP) | 3.772 | Plastic | 1.534 | 56.0 | Refract | — |
| | peripheral area | | | | | | | | |
| 3 | | −14.9144 | (ASP) | −3.150 | Plastic | 1.534 | 56.0 | Reflect | — |
| 4 | Lens 1 | −12.1523 | (ASP) | 3.150 | Plastic | 1.534 | 56.0 | Reflect | — |
| | central area | | | | | | | | |
| 5 | | −14.9144 | (ASP) | 0.069 | | | | Refract | |
| 6 | Ape. Stop | Plano | | 0.060 | | | | Refract | |
| 7 | Lens 2 | −9.1519 | (ASP) | 0.380 | Plastic | 1.587 | 28.3 | Refract | −4.59 |
| 8 | | 3.8850 | (ASP) | 0.350 | | | | Refract | |
| 9 | Stop | Plano | | −0.002 | | | | Refract | |
| 10 | Lens 3 | 6.9461 | (ASP) | 0.422 | Plastic | 1.661 | 20.3 | Refract | 54.04 |
| 11 | | 8.4161 | (ASP) | 0.192 | | | | Refract | |
| 12 | Stop | Plano | | 0.296 | | | | Refract | |
| 13 | Lens 4 | −38.4437 | (ASP) | 1.041 | Glass | 1.541 | 47.2 | Refract | 37.13 |
| 14 | | −13.3152 | (ASP) | 0.035 | | | | Refract | |
| 15 | Lens 5 | −8.6871 | (ASP) | 1.031 | Plastic | 1.545 | 56.1 | Refract | 17.79 |
| 16 | | −4.7732 | (ASP) | 0.091 | | | | Refract | |
| 17 | Lens 6 | 8.0105 | (ASP) | 0.748 | Plastic | 1.545 | 56.1 | Refract | 27.15 |
| 18 | | 16.8919 | (ASP) | 0.600 | | | | Refract | |

| | | | | | | | | |
|---|---|---|---|---|---|---|---|---|
| 19 | Filter | Plano | 0.110 | Glass | 1.517 | 64.2 | Refract | — |
| 20 | | Plano | 0.474 | | | | Refract | |
| 21 | Image | Plano | — | | | | Refract | |

Note:
Reference wavelength is 587.6 nm (d-line).
An effective radius of the stop S1 (Surface 1) is 6.307 mm.
An effective radius of the stop S2 (Surface 9) is 1.279 mm.
An effective radius of the stop S3 (Surface 12) is 1.680 mm.

TABLE 8B
Aspheric Coefficients

| Surface # | 2 | 3 | 4 | 5 |
|---|---|---|---|---|
| k= | −1.90313E+00 | −9.86979E−01 | −8.16572E+00 | −9.86979E−01 |
| A4= | −3.9779532E−05 | 4.2894302E−05 | 4.1488943E−04 | 4.2894302E−05 |
| A6= | 2.4192153E−06 | 6.9798524E−07 | −2.6695460E−05 | 6.9798524E−07 |
| A8= | −1.5718374E−07 | −6.1775424E−08 | 1.0569298E−06 | −6.1775424E−08 |
| A10= | 5.6770836E−09 | 2.7559381E−09 | −1.3154523E−08 | 2.7559381E−09 |
| A12= | −1.0573029E−10 | −6.5862806E−11 | — | −6.5862806E−11 |
| A14= | 9.6826063E−13 | 8.7863480E−13 | — | 8.7863480E−13 |
| A16= | — | −3.8062446E−15 | — | −3.8062446E−15 |
| Surface # | 7 | 8 | 10 | 11 |
| k= | 0.00000E+00 | 0.00000E+00 | 0.00000E+00 | 0.00000E+00 |
| A4= | 2.5498132E−02 | 2.2116369E−02 | −3.6824479E−02 | −2.8044236E−02 |
| A6= | 4.4362630E−03 | 1.2468658E−02 | 2.8197251E−02 | 2.1956847E−02 |
| A8= | −1.5244532E−02 | −3.2169953E−02 | −6.2231919E−02 | −3.6679976E−02 |
| A10= | 1.4670473E−02 | 7.0981303E−02 | 1.0454331E−01 | 4.4121151E−02 |
| A12= | −8.0007418E−03 | −1.1094365E−01 | −1.3101360E−01 | −3.8496764E−02 |
| A14= | 2.5756042E−03 | 1.1050168E−01 | 1.1197491E−01 | 2.2980172E−02 |
| A16= | −4.4710339E−04 | −6.6020945E−02 | −6.0860789E−02 | −8.7458582E−03 |
| A18= | 2.9517931E−05 | 2.1611081E−02 | 1.8847132E−02 | 1.9134918E−03 |
| A20= | 6.7977588E−07 | −2.9905976E−03 | −2.5296041E−03 | −1.8358710E−04 |
| Surface # | 13 | 14 | 15 | 16 |
| k= | 0.00000E+00 | 0.00000E+00 | 0.00000E+00 | 0.00000E+00 |
| A4= | −3.4001538E−02 | −2.4340698E−01 | −1.9578932E−01 | 9.7182277E−03 |
| A6= | 9.9900823E−03 | 1.9803306E−01 | 1.8695100E−01 | 5.3985131E−02 |
| A8= | −3.2015716E−03 | −1.2673643E−01 | −1.1300433E−01 | −9.0164112E−02 |
| A10= | −6.1083466E−03 | 7.6827320E−02 | 4.9687098E−02 | 6.3274107E−02 |
| A12= | 8.1040405E−03 | −4.0862416E−02 | −1.2528765E−02 | −2.6271865E−02 |
| A14= | −3.9154304E−03 | 1.6699557E−02 | 2.2305058E−04 | 7.0553378E−03 |
| A16= | 9.1466259E−04 | −4.4090467E−03 | 1.0000958E−03 | −1.2464791E−03 |
| A18= | −9.5016737E−05 | 5.0962534E−04 | −3.6522932E−04 | 1.4216964E−04 |
| A20= | 2.5144090E−06 | 6.4645790E−05 | 6.7907366E−05 | −9.9136979E−06 |
| A22= | — | −3.0732368E−05 | −7.3580425E−06 | 3.7505880E−07 |
| A24= | — | 4.0299635E−06 | 4.4233997E−07 | −5.6412145E−09 |
| A26= | — | −1.9168901E−07 | −1.1460600E−08 | — |

| Surface # | 17 | 18 |
|---|---|---|
| k= | 0.00000E+00 | 0.00000E+00 |
| A4= | −1.7487024E−02 | −2.4405725E−02 |
| A6= | 4.5133540E−02 | 1.1337697E−02 |
| A8= | −6.1947746E−02 | −5.7072176E−04 |
| A10= | 3.7529179E−02 | −7.3931561E−03 |
| A12= | −1.3665020E−02 | 5.9464082E−03 |
| A14= | 3.3168592E−03 | −2.3784646E−03 |
| A16= | −5.4940068E−04 | 5.8542664E−04 |
| A18= | 6.1145998E−05 | −9.3919718E−05 |
| A20= | −4.3586533E−06 | 9.8640837E−06 |
| A22= | 1.7934753E−07 | −6.5463093E−07 |
| A24= | −3.2353463E−09 | 2.4924047E−08 |
| A26= | — | −4.1510857E−10 |

In the 8th embodiment, the equation of the aspheric surface profiles of the aforementioned lens elements is the same as the equation of the 1st embodiment. Also, the definitions of these parameters shown in Table 8C below are the same as those stated in the 1st embodiment, with corresponding values for the 8th embodiment; therefore, an explanation in this regard will not be provided again.

Moreover, these parameters can be calculated from Table 8A and Table 8B as the following values and satisfy the following conditions:

TABLE 8C
Values of Optical and Physical Parameters/Definitions

| | | | |
|---|---|---|---|
| f [mm] | 14.58 | CT1/ΣAT | 2.89 |
| Fno | 2.04 | T23/T45 | 9.94 |
| HFOV [deg.] | 11.5 | CT4/CT5 | 1.01 |
| DM2I/f | 0.62 | T56/CT6 | 0.12 |
| ImgH/f | 0.21 | V5 − V2 | 27.8 |
| CRA/HFOV | 1.44 | 0.5 × f/(\sqrt{YF1o² − YT1i²}) | 2.04 |
| f/ΣCT | 2.15 | YF1o [mm] | 5.25 |
| DM2R12/Dr7r12 | 2.67 | YT1o [mm] | 6.30 |
| \|f/f3\| + \|f/f4\| + \|f/f5\| | 1.48 | YT1i [mm] | 3.85 |
| \|f2/f4\| | 0.12 | YM1o [mm] | 5.87 |
| \|f5/f6\| | 0.66 | YM1i [mm] | 1.71 |
| \|R2/R12\| | 0.88 | YM2 [mm] | 2.88 |
| (R3 + R4)/(R3 − R4) | 0.40 | YT2 [mm] | 1.71 |
| \|R4/R5\| | 0.56 | YT1o/DM2R2 | 2.00 |
| \|R10/R11\| | 0.60 | YM2/YT2 | 1.68 |
| \|R11/R12\| | 0.47 | — | — |

### 9th Embodiment

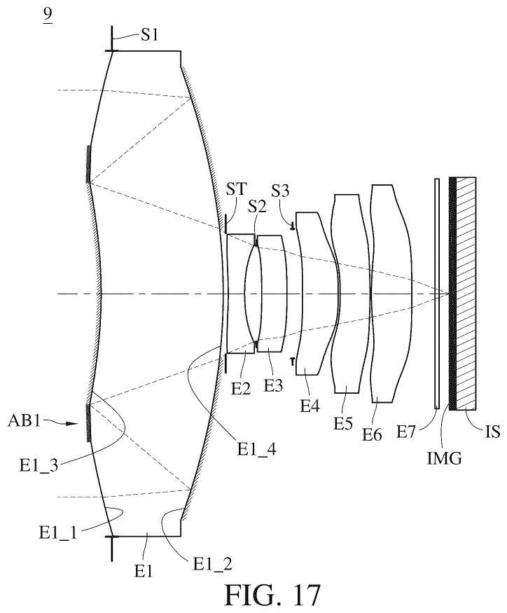

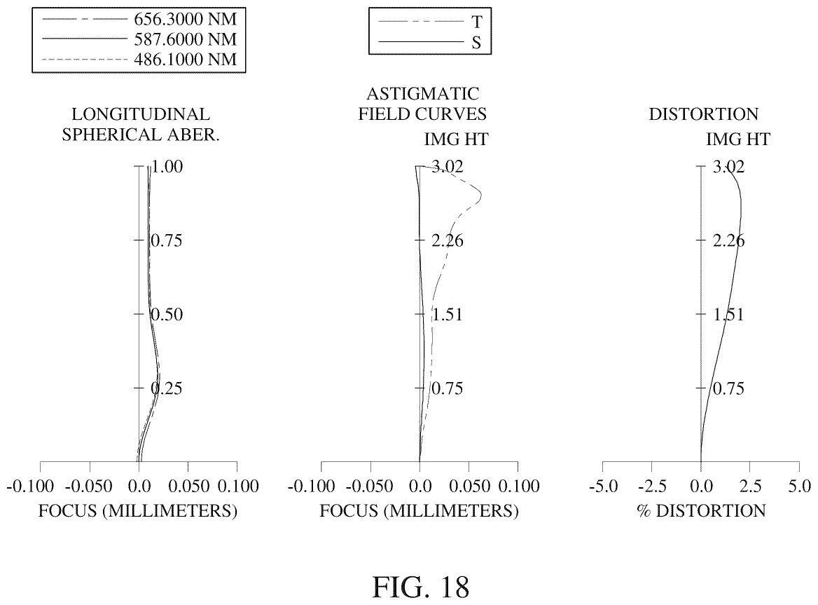

FIG. 17 is a schematic view of an image capturing unit according to the 9th embodiment of the present disclosure. FIG. 18 shows, in order from left to right, spherical aberration curves, astigmatic field curves and a distortion curve of the image capturing unit according to the 9th embodiment. In FIG. 17, the image capturing unit 9 includes the photography lens assembly (its reference numeral is omitted) of the present disclosure and an image sensor IS. The photography lens assembly includes, in order from an object side to an image side along an optical path, a stop S1, a first lens element E1, an aperture stop ST, a second lens element E2, a stop S2, a third lens element E3, a stop S3, a fourth lens element E4, a fifth lens element E5, a sixth lens element E6, a filter E7, and an image surface IMG. The photography lens assembly includes six lens elements (E1, E2, E3, E4, E5, and E6) with no additional lens element disposed between each of the adjacent six lens elements.

The first lens element E1 has a first refractive surface E1_1 facing toward the object side and being located in a peripheral area of an object-side surface (its reference numeral is omitted) of the first lens element E1, a first reflective surface E1_2 facing toward the object side and being located in a peripheral area of an image-side surface (its reference numeral is omitted) of the first lens element E1, a second reflective surface E1_3 facing toward the image side and being located in a central area of the object-side surface of the first lens element E1, and a second refractive surface E1_4 facing toward the image side and being located in a central area of the image-side surface of the first lens element E1. The second refractive surface E1_4 is convex in a paraxial region thereof. The first lens element E1 is made of plastic material and has the first refractive surface E1_1, the first reflective surface E1_2, the second reflective surface E1_3, and the second refractive surface E1_4 being all aspheric. Along a travelling sequence of the optical path, incident light enters the first lens element E1 through the first refractive surface E1_1, is subsequently reflected by the first reflective surface E1_2, further reflected by the second reflective surface E1_3, and finally exits the first lens element E1 through the second refractive surface E1_4. In this embodiment, the object-side surface of the first lens element E1 further has a light-blocking area AB1 located between the central area and the peripheral area thereof.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The image-side surface of the third lens element E3 has one inflection point.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has two inflection points.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has one inflection point. The object-side surface of the fifth lens element E5 has one critical point in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has four inflection points. The image-side surface of the sixth lens element E6 has two inflection points. The object-side surface of the sixth lens element E6 has two critical points in an off-axis region thereof.

The filter E7 is made of glass material and located between the sixth lens element E6 and the image surface IMG, and will not affect the focal length of the photography lens assembly. The image sensor IS is disposed on or near the image surface IMG of the photography lens assembly.

The detailed optical data of the 9th embodiment are shown in Table 9A and the aspheric surface data are shown in Table 9B below.

TABLE 9A
9th Embodiment
f = 14.65 mm, Fno = 2.03, HFOV = 11.5 deg.

| Surface | | Curvature | | | | | Abbe | Refractive/ | Focal |
|---|---|---|---|---|---|---|---|---|---|
| # | | Radius | | Thickness | Material | Index | # | Reflective | Length |
| 0 | Object | Infinity | | Infinity | | | | Refract | |
| 1 | Stop | Plano | | −0.900 | | | | Refract | |
| 2 | Lens 1 | 20.5390 | (ASP) | 3.794 | Plastic | 1.544 | 56.0 | Refract | — |
| | peripheral area | | | | | | | | |
| 3 | | −14.9431 | (ASP) | −3.172 | Plastic | 1.544 | 56.0 | Reflect | — |
| 4 | Lens 1 | −12.1291 | (ASP) | 3.172 | Plastic | 1.544 | 56.0 | Reflect | — |
| | central area | | | | | | | | |
| 5 | | −14.9431 | (ASP) | 0.063 | | | | Refract | |
| 6 | Ape. Stop | Plano | | 0.068 | | | | Refract | |
| 7 | Lens 2 | −9.1907 | (ASP) | 0.426 | Plastic | 1.587 | 28.3 | Refract | −5.13 |
| 8 | | 4.5541 | (ASP) | 0.304 | | | | Refract | |
| 9 | Stop | Plano | | 0.139 | | | | Refract | |
| 10 | Lens 3 | −20.9703 | (ASP) | 0.657 | Plastic | 1.657 | 21.3 | Refract | 89.01 |
| 11 | | −15.6250 | (ASP) | 0.144 | | | | Refract | |
| 12 | Stop | Plano | | 0.257 | | | | Refract | |
| 13 | Lens 4 | −133.0922 | (ASP) | 0.928 | Plastic | 1.535 | 55.9 | Refract | 393.35 |
| 14 | | −81.6991 | (ASP) | 0.051 | | | | Refract | |
| 15 | Lens 5 | −16.2207 | (ASP) | 0.778 | Plastic | 1.544 | 56.0 | Refract | 44.73 |
| 16 | | −9.8979 | (ASP) | 0.035 | | | | Refract | |
| 17 | Lens 6 | 8.8550 | (ASP) | 1.049 | Plastic | 1.545 | 56.1 | Refract | 14.35 |
| 18 | | −64.2568 | (ASP) | 0.600 | | | | Refract | |

| | | | | | | | | |
|---|---|---|---|---|---|---|---|---|
| 19 | Filter | Plano | 0.110 | Glass | 1.517 | 64.2 | Refract | — |
| 20 | | Plano | 0.267 | | | | Refract | |
| 21 | Image | Plano | — | | | | Refract | |

Note:
Reference wavelength is 587.6 nm (d-line).
An effective radius of the stop S1 (Surface 1) is 6.306 mm.
An effective radius of the stop S2 (Surface 9) is 1.259 mm.
An effective radius of the stop S3 (Surface 12) is 1.680 mm.

TABLE 9B
Aspheric Coefficients

| Surface # | 2 | 3 | 4 | 5 |
|---|---|---|---|---|
| k= | −1.89191E+00 | −9.57779E−01 | −7.97435E+00 | −9.57779E−01 |
| A4= | −1.6760027E−05 | 4.9071452E−05 | 4.1507513E−04 | 4.9071452E−05 |
| A6= | 1.5104192E−06 | 2.7559317E−07 | −3.0908192E−05 | 2.7559317E−07 |
| A8= | −1.2013882E−07 | −4.2229681E−08 | 1.6476910E−06 | −4.2229681E−08 |
| A10= | 3.8011651E−09 | 1.7104747E−09 | −3.5040373E−08 | 1.7104747E−09 |
| A12= | −6.4967374E−11 | −3.4334377E−11 | — | −3.4334377E−11 |
| A14= | 6.0878536E−13 | 3.9832303E−13 | — | 3.9832303E−13 |
| A16= | — | −1.1809031E−15 | — | −1.1809031E−15 |
| Surface # | 7 | 8 | 10 | 11 |
| k= | 0.00000E+00 | 0.00000E+00 | 0.00000E+00 | 0.00000E+00 |
| A4= | 3.1862179E−02 | 4.7814638E−02 | −2.2547537E−02 | −2.0072972E−02 |
| A6= | −1.0979637E−02 | −6.4278846E−02 | −1.0936398E−02 | 3.0958406E−04 |
| A8= | 3.0596534E−03 | 1.3811205E−01 | 4.8601213E−02 | 8.6368973E−03 |
| A10= | −2.4857589E−04 | −2.0610782E−01 | −1.2223894E−01 | −2.3067909E−02 |
| A12= | 3.0909258E−04 | 1.9759639E−01 | 1.7194223E−01 | 2.9929487E−02 |
| A14= | −5.3619914E−04 | −1.1946262E−01 | −1.4639446E−01 | −2.2205451E−02 |
| A16= | 3.0402074E−04 | 4.3259885E−02 | 7.4963264E−02 | 9.7867277E−03 |
| A18= | −7.6371220E−05 | −8.3213038E−03 | −2.1281291E−02 | −2.3762315E−03 |
| A20= | 7.3667681E−06 | 6.0529935E−04 | 2.5748263E−03 | 2.4554585E−04 |
| Surface # | 13 | 14 | 15 | 16 |
| k= | 0.00000E+00 | 0.00000E+00 | 0.00000E+00 | 0.00000E+00 |
| A4= | −3.7280886E−02 | −2.3859579E−01 | −1.9307215E−01 | 3.9864497E−02 |
| A6= | 2.6521612E−02 | 1.8055530E−01 | 1.7741073E−01 | −2.0149404E−02 |
| A8= | −3.4868594E−02 | −9.3827642E−02 | −9.6607860E−02 | −4.2394209E−03 |
| A10= | 3.0074928E−02 | 3.7749656E−02 | 3.6703335E−02 | 5.6977050E−03 |
| A12= | −1.7628180E−02 | −8.2280440E−03 | −6.8958883E−03 | −1.8143184E−03 |
| A14= | 7.6987890E−03 | −2.7993310E−03 | −1.1866136E−03 | 2.2602836E−04 |
| A16= | −2.2907737E−03 | 3.8732636E−03 | 1.1738287E−03 | 1.8654966E−05 |
| A18= | 3.9040576E−04 | −1.9530831E−03 | −3.6080736E−04 | −1.1316491E−05 |
| A20= | −2.7996550E−05 | 5.6322899E−04 | 6.2871737E−05 | 1.7706784E−06 |
| A22= | — | −9.5933019E−05 | −6.5943519E−06 | −1.2963056E−07 |
| A24= | — | 8.9728938E−06 | 3.8994270E−07 | 3.7579608E−09 |
| A26= | — | −3.5581580E−07 | −1.0037883E−08 | — |

| Surface # | 17 | 18 |
|---|---|---|
| k= | 0.00000E+00 | 0.00000E+00 |
| A4= | 2.0985534E−02 | −9.2887540E−03 |
| A6= | −4.0448554E−02 | −6.7586698E−03 |
| A8= | 2.4167767E−02 | 6.9295891E−03 |
| A10= | −1.2481867E−02 | −4.9990446E−03 |
| A12= | 5.0248785E−03 | 2.3274174E−03 |
| A14= | −1.3471692E−03 | −7.1592335E−04 |
| A16= | 2.3219706E−04 | 1.5304234E−04 |
| A18= | −2.5290726E−05 | −2.3311011E−05 |
| A20= | 1.6577983E−06 | 2.5207574E−06 |
| A22= | −5.7904968E−08 | −1.8537023E−07 |
| A24= | 7.7310082E−10 | 8.2921291E−09 |
| A26= | — | −1.6865894E−10 |

In the 9th embodiment, the equation of the aspheric surface profiles of the aforementioned lens elements is the same as the equation of the 1st embodiment. Also, the definitions of these parameters shown in Table 9C below are the same as those stated in the 1st embodiment, with corresponding values for the 9th embodiment; therefore, an explanation in this regard will not be provided again.

Moreover, these parameters can be calculated from Table 9A and Table 9B as the following values and satisfy the following conditions:

TABLE 9C
Values of Optical and Physical Parameters/Definitions

| | | | |
|---|---|---|---|
| f [mm] | 14.65 | CT1/ΣAT | 2.99 |
| Fno | 2.03 | T23/T45 | 8.69 |
| HFOV [deg.] | 11.5 | CT4/CT5 | 1.19 |
| DM2I/f | 0.62 | T56/CT6 | 0.03 |
| ImgH/f | 0.21 | V5 − V2 | 27.7 |
| CRA/HFOV | 1.31 | 0.5 × f/(\sqrt{YF1o² − YT1i²}) | 2.03 |
| f/ΣCT | 2.09 | YF1o [mm] | 5.28 |
| DM2R12/Dr7r12 | 2.84 | YT1o [mm] | 6.30 |
| \|f/f3\| + \|f/f4\| + \|f/f5\| | 0.53 | YT1i [mm] | 3.85 |
| \|f2/f4\| | 0.01 | YM1o [mm] | 5.89 |
| \|f5/f6\| | 3.12 | YM1i [mm] | 1.69 |
| \|R2/R12\| | 0.23 | YM2 [mm] | 2.88 |
| (R3 + R4)/(R3 − R4) | 0.34 | YT2 [mm] | 1.69 |
| \|R4/R5\| | 0.22 | YT1o/DM2R2 | 1.99 |
| \|R10/R11\| | 1.12 | YM2/YT2 | 1.71 |
| \|R11/R12\| | 0.14 | — | — |

### 10th Embodiment

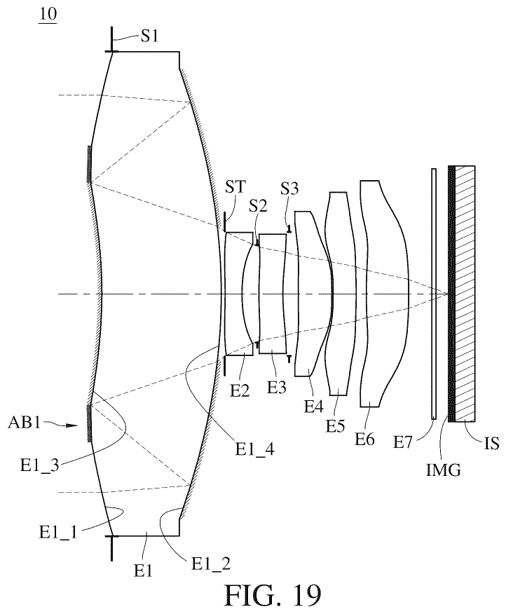

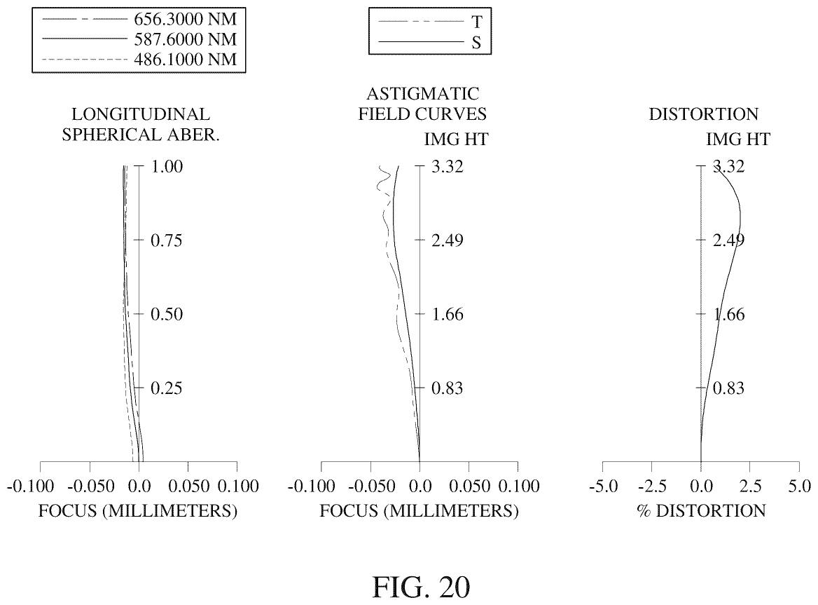

FIG. 19 is a schematic view of an image capturing unit according to the 10th embodiment of the present disclosure. FIG. 20 shows, in order from left to right, spherical aberration curves, astigmatic field curves and a distortion curve of the image capturing unit according to the 10th embodiment. In FIG. 19, the image capturing unit 10 includes the photography lens assembly (its reference numeral is omitted) of the present disclosure and an image sensor IS. The photography lens assembly includes, in order from an object side to an image side along an optical path, a stop S1, a first lens element E1, an aperture stop ST, a second lens element E2, a stop S2, a third lens element E3, a stop S3, a fourth lens element E4, a fifth lens element E5, a sixth lens element E6, a filter E7, and an image surface IMG. The photography lens assembly includes six lens elements (E1, E2, E3, E4, E5, and E6) with no additional lens element disposed between each of the adjacent six lens elements.

The first lens element E1 has a first refractive surface E1_1 facing toward the object side and being located in a peripheral area of an object-side surface (its reference numeral is omitted) of the first lens element E1, a first reflective surface E1_2 facing toward the object side and being located in a peripheral area of an image-side surface (its reference numeral is omitted) of the first lens element E1, a second reflective surface E1_3 facing toward the image side and being located in a central area of the object-side surface of the first lens element E1, and a second refractive surface E1_4 facing toward the image side and being located in a central area of the image-side surface of the first lens element E1. The second refractive surface E1_4 is convex in a paraxial region thereof. The first lens element E1 is made of plastic material and has the first refractive surface E1_1, the first reflective surface E1_2, the second reflective surface E1_3, and the second refractive surface E1_4 being all aspheric. Along a travelling sequence of the optical path, incident light enters the first lens element E1 through the first refractive surface E1_1, is subsequently reflected by the first reflective surface E1_2, further reflected by the second reflective surface E1_3, and finally exits the first lens element E1 through the second refractive surface E1_4. In this embodiment, the object-side surface of the first lens element E1 further has a light-blocking area AB1 located between the central area and the peripheral area thereof.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has two inflection points. The object-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has three inflection points. The image-side surface of the fourth lens element E4 has two inflection points. The object-side surface of the fourth lens element E4 has one critical point in an off-axis region thereof.

The fifth lens element E5 with positive refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has five inflection points. The object-side surface of the fifth lens element E5 has one critical point in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has three inflection points. The image-side surface of the sixth lens element E6 has two inflection points. The object-side surface of the sixth lens element E6 has two critical points in an off-axis region thereof.

The filter E7 is made of glass material and located between the sixth lens element E6 and the image surface IMG, and will not affect the focal length of the photography lens assembly. The image sensor IS is disposed on or near the image surface IMG of the photography lens assembly.

The detailed optical data of the 10th embodiment are shown in Table 10A and the aspheric surface data are shown in Table 10B below.

TABLE 10A
10th Embodiment
f = 14.64 mm, Fno = 2.14, HFOV = 12.7 deg.

| Surface | | Curvature | | | | | Abbe | Refractive/ | Focal |
|---|---|---|---|---|---|---|---|---|---|
| # | | Radius | | Thickness | Material | Index | # | Reflective | Length |
| 0 | Object | Infinity | | Infinity | | | | Refract | |
| 1 | Stop | Plano | | −0.880 | | | | Refract | |
| 2 | Lens 1 | 20.4552 | (ASP) | 3.722 | Plastic | 1.534 | 56.0 | Refract | — |
| | peripheral area | | | | | | | | |
| 3 | | −14.9213 | (ASP) | −3.100 | Plastic | 1.534 | 56.0 | Reflect | — |
| 4 | Lens 1 | −12.4022 | (ASP) | 3.100 | Plastic | 1.534 | 56.0 | Reflect | — |
| | central area | | | | | | | | |
| 5 | | −14.9213 | (ASP) | 0.087 | | | | Refract | |
| 6 | Ape. Stop | Plano | | 0.013 | | | | Refract | |
| 7 | Lens 2 | −14.0919 | (ASP) | 0.439 | Plastic | 1.567 | 37.4 | Refract | −5.73 |
| 8 | | 4.2636 | (ASP) | 0.391 | | | | Refract | |
| 9 | Stop | Plano | | 0.048 | | | | Refract | |
| 10 | Lens 3 | 9.5723 | (ASP) | 0.622 | Plastic | 1.697 | 16.3 | Refract | −23.16 |
| 11 | | 5.8493 | (ASP) | 0.163 | | | | Refract | |
| 12 | Stop | Plano | | 0.237 | | | | Refract | |
| 13 | Lens 4 | 22.4683 | (ASP) | 0.868 | Plastic | 1.545 | 56.1 | Refract | 39.51 |
| 14 | | −508.1807 | (ASP) | 0.035 | | | | Refract | |
| 15 | Lens 5 | −28.1844 | (ASP) | 0.599 | Plastic | 1.545 | 56.1 | Refract | 33.60 |
| 16 | | −11.1826 | (ASP) | 0.265 | | | | Refract | |
| 17 | Lens 6 | 14.4009 | (ASP) | 1.098 | Plastic | 1.587 | 28.3 | Refract | 13.15 |
| 18 | | −16.1819 | (ASP) | 0.600 | | | | Refract | |

| | | | | | | | | |
|---|---|---|---|---|---|---|---|---|
| 19 | Filter | Plano | 0.110 | Glass | 1.517 | 64.2 | Refract | — |
| 20 | | Plano | 0.323 | | | | Refract | |
| 21 | Image | Plano | — | | | | Refract | |

Note:
Reference wavelength is 587.6 nm (d-line).
An effective radius of the stop S1 (Surface 1) is 6.290 mm.
An effective radius of the stop S2 (Surface 9) is 1.267 mm.
An effective radius of the stop S3 (Surface 12) is 1.610 mm.

TABLE 10B
Aspheric Coefficients

| Surface # | 2 | 3 | 4 | 5 |
|---|---|---|---|---|
| k= | −2.34514E+00 | −1.01414E+00 | −8.03793E+00 | −1.01414E+00 |
| A4= | −1.6101410E−05 | 5.1102480E−05 | 4.0654246E−04 | 5.1102480E−05 |
| A6= | 1.2784578E−06 | 1.9521067E−07 | −2.7838835E−05 | 1.9521067E−07 |
| A8= | −1.3328725E−07 | −3.9282479E−08 | 1.3027067E−06 | −3.9282479E−08 |
| A10= | 5.1102016E−09 | 1.7528212E−09 | −1.2153642E−08 | 1.7528212E−09 |
| A12= | −1.1252749E−10 | −3.9134150E−11 | — | −3.9134150E−11 |
| A14= | 1.2155094E−12 | 4.6362663E−13 | — | 4.6362663E−13 |
| A16= | — | 1.3114967E−17 | — | 1.3114967E−17 |
| Surface # | 7 | 8 | 10 | 11 |
| k= | 0.00000E+00 | 0.00000E+00 | 0.00000E+00 | 0.00000E+00 |
| A4= | 2.9507988E−02 | 2.7578499E−02 | −3.0473721E−02 | −3.2162471E−02 |
| A6= | −2.8920225E−03 | 2.4829429E−02 | 7.9968168E−04 | 1.9001585E−02 |
| A8= | −6.6163548E−03 | −7.9875738E−02 | 6.7839521E−03 | −2.9119806E−02 |
| A10= | 7.7503320E−03 | 1.4318138E−01 | −1.9800383E−02 | 3.1765520E−02 |
| A12= | −4.7138919E−03 | −1.6825480E−01 | 2.4292628E−02 | −2.3599002E−02 |
| A14= | 1.7829957E−03 | 1.2949934E−01 | −1.5314463E−02 | 1.1845774E−02 |
| A16= | −4.2283050E−04 | −6.2474354E−02 | 4.5760470E−03 | −3.7642710E−03 |
| A18= | 5.8081327E−05 | 1.7094428E−02 | −2.8921920E−04 | 6.8130260E−04 |
| A20= | −3.5714275E−06 | −2.0293339E−03 | −9.9258962E−05 | −5.3674742E−05 |
| Surface # | 13 | 14 | 15 | 16 |
| k= | 0.00000E+00 | 0.00000E+00 | 0.00000E+00 | 0.00000E+00 |
| A4= | −3.5152734E−02 | −2.6838947E−01 | −2.0841449E−01 | 4.0184613E−02 |
| A6= | 2.9162336E−02 | 2.9244058E−01 | 2.6303418E−01 | 7.6560976E−04 |
| A8= | −3.3858835E−02 | −2.9650380E−01 | −2.6912462E−01 | −5.1870056E−02 |
| A10= | 2.6377914E−02 | 2.6492465E−01 | 2.1320387E−01 | 5.3303756E−02 |
| A12= | −1.5063106E−02 | −1.8396231E−01 | −1.1623076E−01 | −2.9361025E−02 |
| A14= | 6.4188846E−03 | 9.6193403E−02 | 4.3419863E−02 | 1.0394657E−02 |
| A16= | −1.8054293E−03 | −3.7146631E−02 | −1.1292337E−02 | −2.4504606E−03 |
| A18= | 2.8671576E−04 | 1.0294549E−02 | 2.0523505E−03 | 3.8095145E−04 |
| A20= | −1.9268936E−05 | −1.9686655E−03 | −2.5635908E−04 | −3.7429447E−05 |
| A22= | — | 2.4472060E−04 | 2.1003343E−05 | 2.1040331E−06 |
| A24= | — | −1.7694565E−05 | −1.0166601E−06 | −5.1546532E−08 |
| A26= | — | 5.6196821E−07 | 2.2025435E−08 | — |

| Surface # | 17 | 18 |
|---|---|---|
| k= | 0.00000E+00 | 0.00000E+00 |
| A4= | 9.4909938E−03 | −9.1618094E−03 |
| A6= | −1.2397023E−02 | −7.1249947E−04 |
| A8= | −5.1656801E−03 | −1.5201677E−03 |
| A10= | 7.1689601E−03 | 9.5248982E−04 |
| A12= | −3.8716294E−03 | −4.3587857E−04 |
| A14= | 1.3564999E−03 | 1.9429764E−04 |
| A16= | −3.1321710E−04 | −6.5802839E−05 |
| A18= | 4.6292552E−05 | 1.4991227E−05 |
| A20= | −4.1909375E−06 | −2.2053966E−06 |
| A22= | 2.1145743E−07 | 2.0035739E−07 |
| A24= | −4.5562046E−09 | −1.0204777E−08 |
| A26= | — | 2.2264263E−10 |

In the 10th embodiment, the equation of the aspheric surface profiles of the aforementioned lens elements is the same as the equation of the 1st embodiment. Also, the definitions of these parameters shown in Table 10C below are the same as those stated in the 1st embodiment, with corresponding values for the 10th embodiment; therefore, an explanation in this regard will not be provided again.

Moreover, these parameters can be calculated from Table 10A and Table 10B as the following values and satisfy the following conditions:

TABLE 10C
Values of Optical and Physical Parameters/Definitions

| | | | |
|---|---|---|---|
| f [mm] | 14.64 | CT1/ΣAT | 2.50 |
| Fno | 2.14 | T23/T45 | 12.54 |
| HFOV [deg.] | 12.7 | CT4/CT5 | 1.45 |
| DM2I/f | 0.61 | T56/CT6 | 0.24 |
| ImgH/f | 0.23 | V5 − V2 | 18.7 |
| CRA/HFOV | 1.44 | 0.5 × f/(\sqrt{YF1o² − YT1i²}) | 2.14 |
| f/ΣCT | 2.18 | YF1o [mm] | 5.15 |
| DM2R12/Dr7r12 | 2.78 | YT1o [mm] | 6.28 |
| \|f/f3\| + \|f/f4\| + \|f/f5\| | 1.44 | YT1i [mm] | 3.85 |
| \|f2/f4\| | 0.14 | YM1o [mm] | 5.85 |
| \|f5/f6\| | 2.56 | YM1i [mm] | 1.76 |
| \|R2/R12\| | 0.92 | YM2 [mm] | 2.88 |
| (R3 + R4)/(R3 − R4) | 0.54 | YT2 [mm] | 1.76 |
| \|R4/R5\| | 0.45 | YT1o/DM2R2 | 2.03 |
| \|R10/R11\| | 0.78 | YM2/YT2 | 1.64 |
| \|R11/R12\| | 0.89 | — | — |

### 11th Embodiment

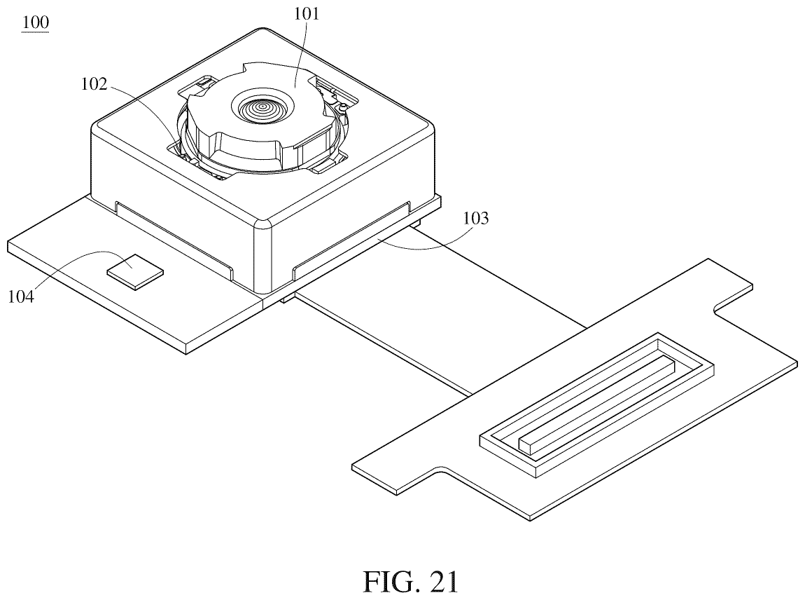

FIG. 21 is a perspective view of an image capturing unit according to the 11th embodiment of the present disclosure. In this embodiment, an image capturing unit 100 is a camera module including a lens unit 101, a driving device 102, an image sensor 103, and an image stabilizer 104. The lens unit 101 includes the photography lens assembly as disclosed in the 1st embodiment, a barrel, and a holder member (their reference numerals are omitted) for holding the photography lens assembly. However, the lens unit 101 may alternatively be provided with the photography lens 10 assembly as disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have an auto-focusing function, and the driving device 102 can utilize various driving configurations, such as voice coil motors (VCM), micro electro-mechanical systems (MEMS), piezoelectric systems, and shape memory alloys. The driving device 102 is favorable for obtaining a better imaging position for the lens unit 101 or the image sensor 103, so that a clear image of the imaged object can be captured by the lens unit 101 with different object distances. The image sensor 103 (for example, CMOS or CCD), which can feature high photosensitivity and low noise, is disposed on the image surface of the photography lens assembly to provide higher image quality.

The image stabilizer 104, such as an accelerometer, a gyro sensor and a Hall Effect sensor, is configured to work with the driving device 102 to provide optical image stabilization (OIS). The driving device 102 working with the image stabilizer 104 is favorable for compensating for pan and tilt of the lens unit 101 or the image sensor 103 to reduce blurring associated with motion during exposure. In some cases, the compensation can be provided by electronic image stabilization (EIS) with image processing software, thereby improving image quality while in dynamic or low-light scenarios.

### 12th Embodiment

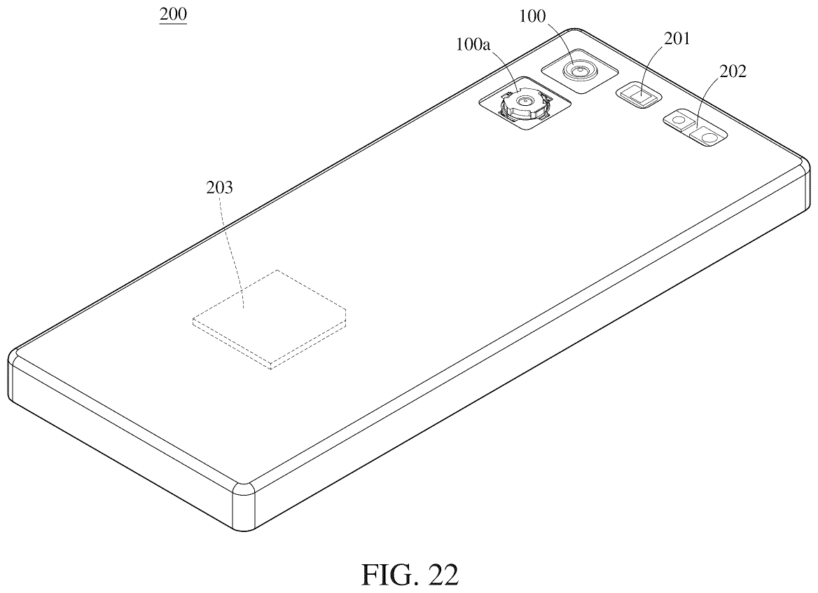

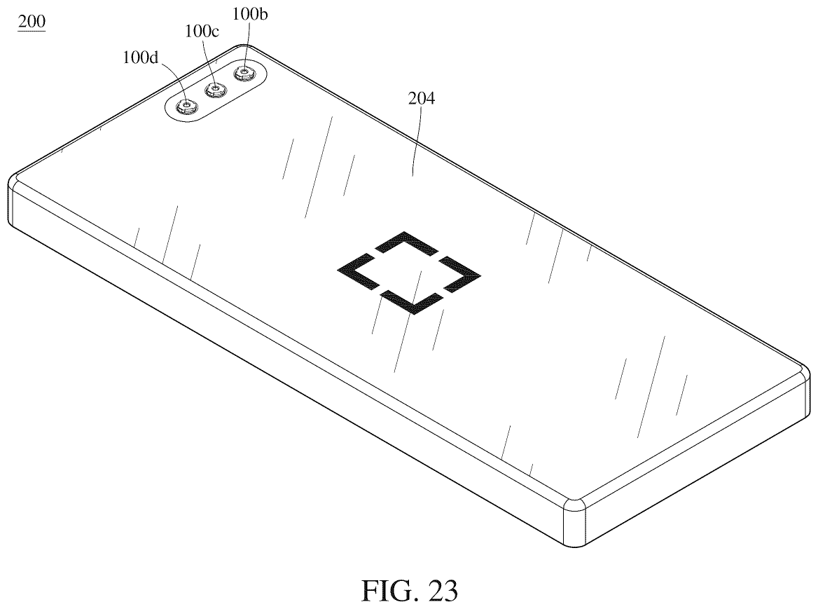

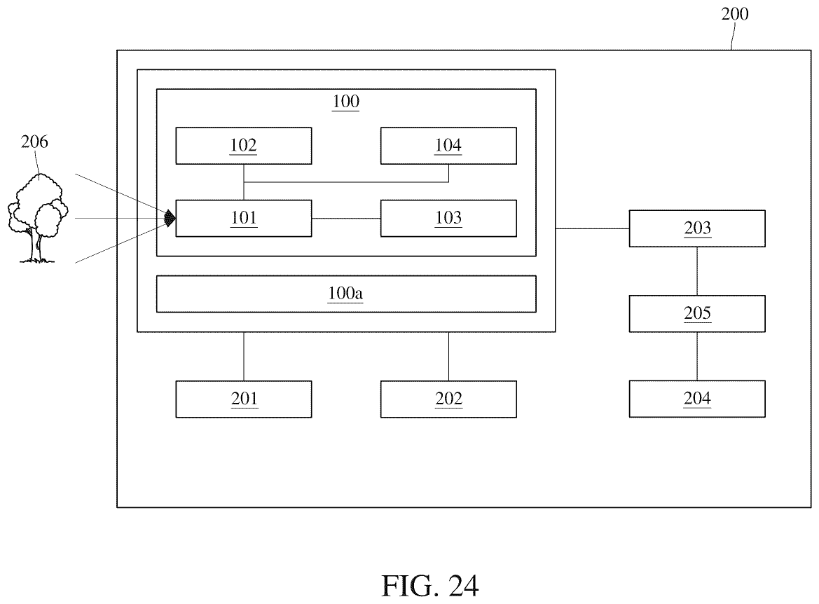

FIG. 22 is one perspective view of an electronic device according to the 12th embodiment of the present disclosure, FIG. 23 is another perspective view of the electronic device in FIG. 22, and FIG. 24 is a block diagram of the electronic device in FIG. 22.

In this embodiment, an electronic device 200 is a smartphone including the image capturing unit 100 as disclosed in the 11th embodiment, an image capturing unit 100a, an image capturing unit 100b, an image capturing unit 100c, an image capturing unit 100d, a flash module 201, a focus assist module 202, an image signal processor 203, a display module 204, and an image software processor 205. The image capturing unit 100 and the image capturing unit 100a are disposed on the same side of the electronic device 200, and each of the image capturing units 100 and 100a has a single focal point. The focus assist module 202 can be a laser rangefinder or a ToF (time of flight) module, but the present disclosure is not limited thereto. The image capturing unit 100b, image capturing unit 100c, the image capturing unit 100d, and the display module 204 are disposed on the opposite side of the electronic device 200, and the display module 204 can be a user interface, allowing the image capturing units 100b, 100c, and 100d to serve as front-facing cameras of the electronic device 200 for taking selfies, but the present disclosure is not limited thereto. Furthermore, each of the image capturing units 100a, 100b, 100c, and 100d can include the photography lens assembly of the present disclosure and can have a configuration similar to that of the image capturing unit 100. In detail, each of the image capturing units 100a, 100b, 100c, and 100d can include a lens unit, a driving device, an image sensor, and an image stabilizer. In addition, each lens unit of the image capturing units 100a, 100b, 100c, and 100d can include the photography lens assembly of the present disclosure, a barrel, and a holder member for holding the photography lens assembly.

The image capturing unit 100 is a telephoto image capturing unit, the image capturing unit 100a is a wide-angle image capturing unit, the image capturing unit 100b is a wide-angle image capturing unit, the image capturing unit 100c is an ultra-wide-angle image capturing unit, and the image capturing unit 100d is a ToF image capturing unit. In this embodiment, the image capturing units 100 and 100a have different fields of view, so that the electronic device 200 can have various magnification ratios so as to meet the requirement of optical zoom functionality. In addition, the image capturing unit 100d can determine depth information of the imaged object. In this embodiment, the electronic device 200 includes multiple image capturing units 100, 100a, 100b, 100c, and 100d, but the present disclosure is not limited to the number and arrangement of image capturing units.

When a user captures images of an object 206, the light rays converge in the image capturing unit 100 or the image capturing unit 100a to generate images, and the flash module 201 is activated for light supplement. The focus assist module 202 detects the object distance of the imaged object 206 to achieve fast auto focusing. The image signal processor 203 is configured to optimize the captured image to improve image quality. The light beam emitted from the focus assist module 202 can be either conventional infrared or laser. In addition, the light rays may converge in the image capturing unit 100b, 100c, or 100d to generate images. The display module 204 can include a touch screen, and the user is able to interact with the display module 204 and the image software processor 205 having multiple functions to capture images and complete image processing. Alternatively, the user may capture images via a physical button. The image processed by the image software processor 205 can be displayed on the display module 204.

### 13th Embodiment

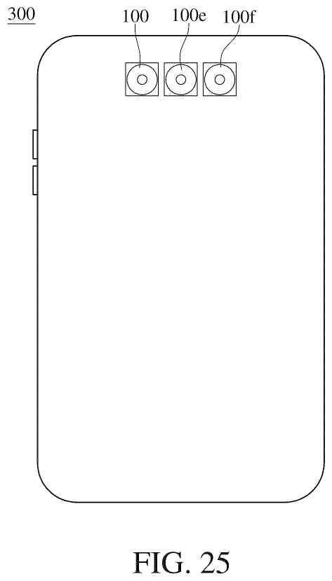

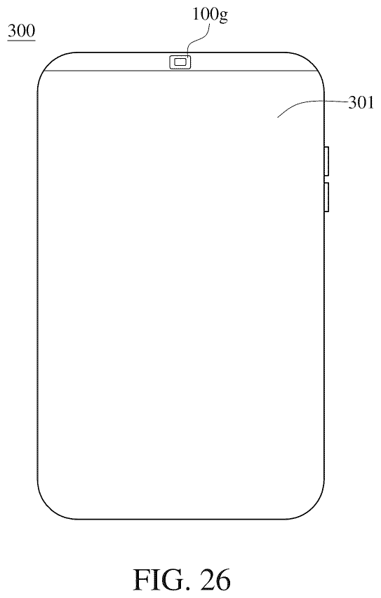

FIG. 25 is one schematic view of an electronic device according to the 13th embodiment of the present disclosure, and FIG. 26 is another schematic view of the electronic device in FIG. 25.

In this embodiment, an electronic device 300 is a smartphone including the image capturing unit 100 as disclosed in the 11th embodiment, an image capturing unit 100e, an image capturing unit 100f, an image capturing unit 100g, and a display module 301. As shown in FIG. 25, the image capturing unit 100, the image capturing unit 100e, and the image capturing unit 100f are disposed on the same side of the electronic device 300, and each of the image capturing units 100, 100e, and 100f has a single focal point. As shown in FIG. 26, the image capturing unit 100g and the display module 301 are disposed on the opposite side of the electronic device 300, allowing the image capturing unit 100g to serve as a front-facing camera of the electronic device 300 for taking selfies, but the present disclosure is not limited thereto. Furthermore, each of the image capturing units 100e, 100f, and 100g can include the photography lens assembly of the present disclosure and can have a configuration similar to that of the image capturing unit 100. In detail, each of the image capturing units 100e, 100f, and 100g can include a lens unit, a driving device, an image sensor, and an image stabilizer. In addition, each lens unit of the image capturing units 100e, 100f, and 100g can include the photography lens assembly of the present disclosure, a barrel, and a holder member for holding the photography lens assembly.

The image capturing unit 100 is a telephoto image capturing unit, the image capturing unit 100e is a wide-angle image capturing unit, the image capturing unit 100f is an ultra-wide-angle image capturing unit, and the image capturing unit 100g is a wide-angle image capturing unit. In this embodiment, the image capturing units 100, 100e, and 100f have different fields of view, so that the electronic device 300 can have various magnification ratios so as to meet the requirement of optical zoom functionality. Moreover, as shown in FIG. 26, the image capturing unit 100g can have a non-circular opening, and the barrel or lens elements in the image capturing unit 100g can have trimmed edges at their outermost positions so as to coordinate with the shape of the non-circular opening. Therefore, it is favorable for reducing the size of the image capturing unit 100g so as to increase the ratio of the area of the display module 301 relative to that of the electronic device 300, and reduce the thickness of the electronic device 300, thereby achieving compactness. In this embodiment, the electronic device 300 includes multiple image capturing units 100, 100e, 100f, and 100g, but the present disclosure is not limited to the number and arrangement of image capturing units.

### 14th Embodiment

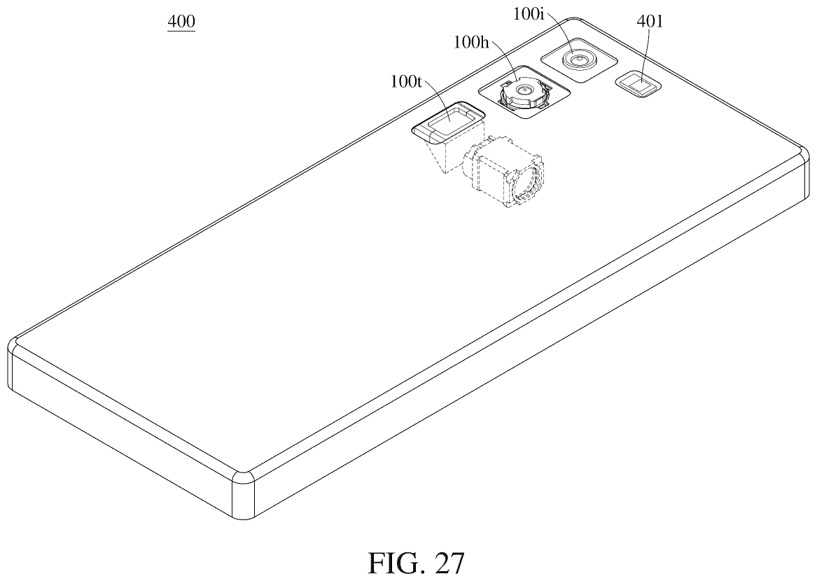

FIG. 27 is a perspective view of an electronic device according to the 14th embodiment of the present disclosure.

In this embodiment, an electronic device 400 is a smartphone including an image capturing unit 100t, an image capturing unit 100h, an image capturing unit 100i, a flash module 401, a focus assist module, an image signal processor, a display module, and an image software processor (not shown). The image capturing units 100t, 100h, and 100i are disposed on the same side of the electronic device 400, while the display module is disposed on the opposite side of the electronic device 400. The image capturing unit 100t can include the image capturing unit 100 as disclosed in the 11th embodiment. Furthermore, each of the image capturing units 100h and 100i can include the photography lens assembly of the present disclosure and can have a configuration similar to that of the image capturing unit 100, and the details in this regard will not be provided again.

The image capturing unit 100t is a telephoto image capturing unit, the image capturing unit 100h is a wide-angle image capturing unit, and the image capturing unit 100i is an ultra-wide-angle image capturing unit. In this embodiment, the image capturing units 100t, 100h, and 100i have different fields of view, so that the electronic device 400 can have various magnification ratios so as to meet the requirement of optical zoom functionality. In addition, the image capturing unit 100t can be a telephoto image capturing unit configured with a light path reflecting element, so that the total track length of the image capturing unit 100t can be unrestricted by the thickness of the electronic device 400. In this embodiment, the electronic device 400 includes multiple image capturing units 100t, 100h, and 100i, but the present disclosure is not limited to the number and arrangement of image capturing units. When a user captures images of an object, the light rays converge in the image capturing unit 100t, 100h, or 100i to generate images, and the flash module 401 is activated for light supplement. Further, the subsequent processes are performed in a manner similar to the abovementioned embodiments, and the details in this regard will not be provided again.

### 15th Embodiment

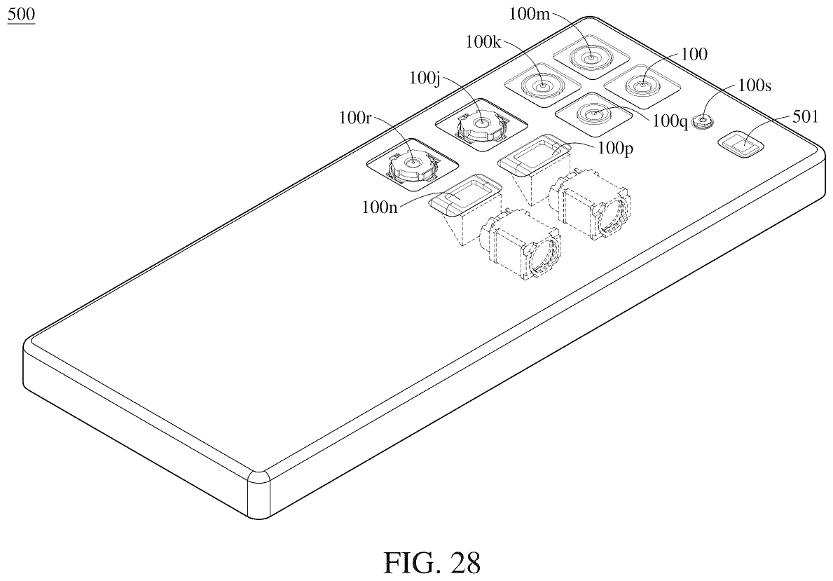

FIG. 28 is a perspective view of an electronic device according to the 14th embodiment of the present disclosure.

In this embodiment, an electronic device 500 is a smartphone including the image capturing unit 100 as disclosed in the 11th embodiment, an image capturing unit 100j, an image capturing unit 100k, an image capturing unit 100m, an image capturing unit 100n, an image capturing unit 100p, an image capturing unit 100q, an image capturing unit 100r, an image capturing unit 100s, a flash module 501, a focus assist module, an image signal processor, a display module, and an image software processor (not shown). The image capturing units 100, 100j, 100k, 100m, 100n, 100p, 100q, 100r, and 100s are disposed on the same side of the electronic device 500, while the display module is disposed on the opposite side of the electronic device 500. Furthermore, each of the image capturing units 100j, 100k, 100m, 100n, 100p, 100q, 100r, and 100s can include the photography lens assembly of the present disclosure and can have a configuration similar to that of the image capturing unit 100, and the details in this regard will not be provided again.

The image capturing unit 100 is a telephoto image capturing unit, the image capturing unit 100j is a wide-angle image capturing unit, the image capturing unit 100k is an ultra-wide-angle image capturing unit, the image capturing unit 100m is an ultra-wide-angle image capturing unit, the image capturing unit 100n is a telephoto image capturing unit, the image capturing unit 100p is a telephoto image capturing unit, the image capturing unit 100q is a telephoto image capturing unit, the image capturing unit 100r is a wide-angle image capturing unit, and the image capturing unit 100s is a ToF image capturing unit. In this embodiment, the image capturing units 100, 100j, 100k, 100m, 100n, 100p, 100q, and 100r have different fields of view, so that the electronic device 500 can have various magnification ratios so as to meet the requirement of optical zoom functionality. In addition, each of the image capturing unit 100n and the image capturing unit 100p can be a telephoto image capturing unit configured with a light path reflecting element, so that the total track lengths of the image capturing unit 100n and the image capturing unit 100p can be unrestricted by the thickness of the electronic device 500. Moreover, the image capturing unit 100s can determine depth information of the imaged object. In this embodiment, the electronic device 500 includes multiple image capturing units 100, 100j, 100k, 100m, 100n, 100p, 100q, 100r, and 100s, but the present disclosure is not limited to the number and arrangement of image capturing units. When a user captures images of an object, the light rays converge in the image capturing unit 100, 100j, 100k, 100m, 100n, 100p, 100q, 100r, or 100s to generate images, and the flash module 501 is activated for light supplement. Further, the subsequent processes are performed in a manner similar to the abovementioned embodiments, and the details in this regard will not be provided again.

The smartphones in the embodiments are only exemplary for showing the image capturing unit of the present disclosure installed in an electronic device, and the present disclosure is not limited thereto. The image capturing unit can optionally be applied to optical systems with a movable focus. Furthermore, the photography lens assembly of the image capturing unit features good capability in aberration corrections and high image quality, and can be applied to 3D (three-dimensional) image capturing applications, in products such as digital cameras, mobile devices, digital tablets, smart televisions, network surveillance devices, motion sensing game consoles, dashboard cameras, vehicle backup cameras, multi-camera devices, image recognition systems, robots, notebook computers, 3D video cameras, sports cameras, wearable devices, unmanned aerial vehicles, and other electronic imaging devices.

The foregoing description, for the purpose of explanation, has been described with reference to specific embodiments. It is to be noted that TABLES 1A-10C show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A photography lens assembly comprising six lens elements, the six lens elements being, in order from an object side to an image side along an optical path, a first lens element, a second lens element, a third lens element, a fourth lens element, a fifth lens element, and a sixth lens element, and each of the six lens elements having an object-side surface facing toward the object side and an image-side surface facing toward the image side;
wherein each of the object-side surface and the image-side surface of the first lens element comprises a central area and a peripheral area, the peripheral area of the object-side surface of the first lens element has a first refractive surface, the peripheral area of the image-side surface of the first lens element has a first reflective surface, the central area of the object-side surface of the first lens element has a second reflective surface, and the central area of the image-side surface of the first lens element has a second refractive surface; and
wherein the sixth lens element has positive refractive power.

2. The photography lens assembly of claim 1, wherein the second lens element has negative refractive power, and the second refractive surface is convex in a paraxial region thereof.

3. The photography lens assembly of claim 1, wherein an axial distance between the second reflective surface and an image surface is DM2I, a focal length of the photography lens assembly is f, and the following condition is satisfied:
$$0.5 < DM 2 I / f < 0.8 .$$

4. The photography lens assembly of claim 1, wherein a maximum image height of the photography lens assembly is ImgH, a focal length of the photography lens assembly is f, and the following condition is satisfied:
$$0.18 < ImgH / f < 0.28 .$$

5. The photography lens assembly of claim 1, wherein an axial distance between the second reflective surface and the image-side surface of the sixth lens element is DM2R12, an axial distance between the object-side surface of the fourth lens element and the image-side surface of the sixth lens element is Dr7r12, and the following condition is satisfied:
$$2. < DM 2 R 12 / Dr 7 r 12 < 3.5 .$$

6. The photography lens assembly of claim 1, wherein a curvature radius of the object-side surface of the second lens element is R3, a curvature radius of the image-side surface of the second lens element is R4, and the following condition is satisfied:
$$0. < ( R 3 + R 4 ) / ( R 3 - R 4 ) .$$

7. The photography lens assembly of claim 1, wherein a focal length of the photography lens assembly is f, a focal length of the third lens element is f3, a focal length of the fourth lens element is f4, a focal length of the fifth lens element is f5, and the following condition is satisfied:
$$0.3 < \vert f / f 3 \vert + \vert f / f 4 \vert + \vert f / f 5 \vert < 3. .$$

8. The photography lens assembly of claim 1, wherein a central thickness of the fourth lens element is CT4, a central thickness of the fifth lens element is CT5, and the following condition is satisfied:
$$0.7 < CT 4 / CT 5 < 2.50 .$$

9. The photography lens assembly of claim 1, wherein along a travelling sequence of the optical path, incident light enters the first lens element through the first refractive surface, is subsequently reflected by the first reflective surface, further reflected by the second reflective surface, and finally exits the first lens element through the second refractive surface.

10. The photography lens assembly of claim 1, wherein the object-side surface of the first lens element further has a light-blocking area located between the central area and the peripheral area thereof.

11. An image capturing unit comprising:
the photography lens assembly of claim 1; and
an image sensor disposed on an image surface of the photography lens assembly.

12. An electronic device comprising:
the image capturing unit of claim 11.

13. A photography lens assembly comprising six lens elements, the six lens elements being, in order from an object side to an image side along an optical path, a first lens element, a second lens element, a third lens element, a fourth lens element, a fifth lens element, and a sixth lens element, and each of the six lens elements having an object-side surface facing toward the object side and an image-side surface facing toward the image side;
wherein each of the object-side surface and the image-side surface of the first lens element comprises a central area and a peripheral area, the peripheral area of the object-side surface of the first lens element has a first refractive surface, the peripheral area of the image-side surface of the first lens element has a first reflective surface, the central area of the object-side surface of the first lens element has a second reflective surface, and the central area of the image-side surface of the first lens element has a second refractive surface;
wherein the second lens element has negative refractive power, and the image-side surface of the second lens element is concave in a paraxial region thereof; and
wherein a focal length of the fifth lens element is f5, a focal length of the sixth lens element is f6, a curvature radius of the image-side surface of the first lens element is R2, a curvature radius of the image-side surface of the sixth lens element is R12, and the following conditions are satisfied:
$$0. < \vert f 5 / f 6 \vert < 7. ; and \\ 0. < \vert R 2 / R 12 \vert < 1.6 .$$

14. The photography lens assembly of claim 13, wherein the sixth lens element has positive refractive power, and at least one of the object-side surface and the image-side surface of at least one of the second lens element, the third lens element, the fourth lens element, the fifth lens element, and the sixth lens element has at least one inflection point.

15. The photography lens assembly of claim 13, wherein the third lens element has positive refractive power, the fifth lens element has positive refractive power, and the image-side surface of the fifth lens element is convex in a paraxial region thereof.

16. The photography lens assembly of claim 13, wherein a focal length of the photography lens assembly is f, a sum of central thicknesses of all lens elements of the photography lens assembly is ΣCT, and the following condition is satisfied:
$$1. 50 < f / Σ CT < 2.5 .$$

17. The photography lens assembly of claim 13, wherein an axial distance between the fifth lens element and the sixth lens element is T56, a central thickness of the sixth lens element is CT6, and the following condition is satisfied:
$$0. < T 56 / CT 6 < 0.40 .$$

18. The photography lens assembly of claim 13, wherein a focal length of the photography lens assembly is f, a vertical distance between a central axis and an intersection point of a marginal ray of a center field of view of the photography lens assembly with the first refractive surface is YF1o, a minimum effective radius of the first refractive surface is YT1i, and the following condition is satisfied:
$$1. 80 < 0.5 \times f / ( \sqrt{YF 1 {o}^{2} - YT 1 {i}^{2}} ) < 2.90 .$$

19. The photography lens assembly of claim 13, wherein a curvature radius of the image-side surface of the fifth lens element is R10, a curvature radius of the object-side surface of the sixth lens element is R11, and the following condition is satisfied:
$$0. 00 < \vert R 10 / R 11 \vert < 1.5 .$$

20. The photography lens assembly of claim 13, wherein a maximum effective radius of the first refractive surface is YT1o, an axial distance between the second reflective surface and the second refractive surface is DM2R2, and the following condition is satisfied:
$$1. 50 < YT 1 o / DM 2 R 2 < 2.50 .$$

21. A photography lens assembly comprising six lens elements, the six lens elements being, in order from an object side to an image side along an optical path, a first lens element, a second lens element, a third lens element, a fourth lens element, a fifth lens element, and a sixth lens element, and each of the six lens elements having an object-side surface facing toward the object side and an image-side surface facing toward the image side;
wherein each of the object-side surface and the image-side surface of the first lens element comprises a central area and a peripheral area, the peripheral area of the object-side surface of the first lens element has a first refractive surface, the peripheral area of the image-side surface of the first lens element has a first reflective surface, the central area of the object-side surface of the first lens element has a second reflective surface, and the central area of the image-side surface of the first lens element has a second refractive surface;
wherein an Abbe number of the second lens element is V2, an Abbe number of the fifth lens element is V5, and the following condition is satisfied:
$$10. < V 5 - V 2 < 35.0 .$$

22. The photography lens assembly of claim 21, wherein the second lens element has negative refractive power, and the sixth lens element has positive refractive power.

23. The photography lens assembly of claim 21, wherein an axial distance between the second lens element and the third lens element is T23, an axial distance between the fourth lens element and the fifth lens element is T45, and the following condition is satisfied:
$$6.5 < T 23 / T 45 < 14.00 .$$

24. The photography lens assembly of claim 21, wherein a central thickness of the first lens element is CT1, a sum of axial distances between each of all adjacent lens elements of the photography lens assembly is ΣAT, and the following condition is satisfied:
$$1. 80 < CT 1 / Σ AT < 3.5 .$$

25. The photography lens assembly of claim 21, wherein a curvature radius of the image-side surface of the second lens element is R4, a curvature radius of the object-side surface of the third lens element is R5, and the following condition is satisfied:
$$0. < \vert R 4 / R 5 \vert < 0. 90 .$$

26. The photography lens assembly of claim 21, wherein a focal length of the second lens element is f2, a focal length of the fourth lens element is f4, and the following condition is satisfied:
$$0. \text{<\textbar} f 2 / f 4 \vert < 0.5 0 .$$

27. The photography lens assembly of claim 21, wherein a curvature radius of the object-side surface of the sixth lens element is R11, a curvature radius of the image-side surface of the sixth lens element is R12, and the following condition is satisfied:
$$0. < \vert R 11 / R 12 \vert < 2. 00 .$$

28. The photography lens assembly of claim 21, wherein a maximum effective radius of the second reflective surface is YM2, a maximum effective radius of the second refractive surface is YT2, an incident angle of a chief ray of a maximum field of view of the photography lens assembly on an image surface is CRA, half of the maximum field of view of the photography lens assembly is HFOV, and the following conditions are satisfied:
$$1. 55 < YM 2 / YT 2 < 1.8 ; and \\ 0.8 < CRA / HFOV < 1.8 .$$

29. The photography lens assembly of claim 21, wherein a focal length of the fifth lens element is f5, a focal length of the sixth lens element is f6, a curvature radius of the image-side surface of the first lens element is R2, a curvature radius of the image-side surface of the sixth lens element is R12, the Abbe number of the second lens element is V2, the Abbe number of the fifth lens element is V5, and at least one of the following conditions is satisfied:
$$0.23 \leq \vert f 5 / f 6 \vert \leq 6.02 ; \\ 0.23 \leq \vert R 2 / R 12 \vert \leq 1.34 ; and \\ 16.5 \leq V 5 - V 2 \leq 27.9 .$$
